(19) United States
(12) Patent Application Publication
(10) Pub. No.: US 2021/0161135 A1
(43) Pub. Date: Jun. 3, 2021

(54) WEED CONTROL FROM APPLICATIONS OF PYRIDINE CARBOXYLIC ACID HERBICIDES AND 4-HYDROXYPHENYL-PYRUVATE DIOXYGENASE (HPPD) INHIBITORS

(71) Applicant: Dow AgroSciences LLC, Indianapolis, IN (US)

(72) Inventors: Norbert M. Satchivi, Carmel, IN (US); Bryston L. Bangel, Mooresville, IN (US); Paul R. Schmitzer, Indianapolis, IN (US)

(73) Assignee: Dow AgroSciences LLC, Indianapolis, IN (US)

(21) Appl. No.: 17/045,204

(22) PCT Filed: Apr. 4, 2019
(86) PCT No.: PCT/US19/25699

§ 371 Date: Oct. 5, 2020

Related U.S. Application Data
(60) Provisional application No. 62/652,377, filed on Apr. 4, 2018.

(51) Int. Cl. A01N 43/40; A01N 43/56; A01N 43/80; A01N 41/10; A01N 37/34

(52) U.S. Cl. CPC A01N 43/40; A01N 43/56; A01N 37/34; A01N 41/10; A01N 43/80

(57) ABSTRACT

Disclosed herein are herbicidal compositions containing a herbicidally effective amount of (a) a pyridine carboxylic acid herbicide or an agriculturally acceptable N-oxide, salt, or ester thereof, and (b) a 4-hydroxyphenyl-pyruvate dioxygenase (HPPD) inhibitor or an agriculturally acceptable salt or ester thereof. Also disclosed herein are methods of controlling undesirable vegetation which comprise applying to vegetation or an area adjacent the vegetation or applying to soil or water to prevent the emergence or growth of vegetation (a) a pyridine carboxylic acid herbicide or an agriculturally acceptable N-oxide, salt, or ester thereof and (b) a 4-hydroxyphenyl-pyruvate dioxygenase (HPPD) inhibitor or an agriculturally acceptable salt or ester thereof, wherein (a) and (b) are each applied in an amount sufficient to provide a herbicidal effect.

### CROSS-REFERENCE TO RELATED APPLICATIONS

This application claims priority to U.S. Provisional Application Ser. No. 62/652,377, filed on Apr. 4, 2018, the entire disclosure of which is hereby expressly incorporated by reference.

### BACKGROUND

Many recurring problems in agriculture involve controlling growth of undesirable vegetation that can, for instance, inhibit crop growth. To help control undesirable vegetation, researchers have produced a variety of chemicals and chemical formulations effective in controlling such unwanted growth. However, a continuing need exists for new compositions and methods to control growth of undesirable vegetation.

### SUMMARY OF THE DISCLOSURE

Disclosed herein are herbicidal compositions containing a herbicidally effective amount of (a) a pyridine carboxylic acid herbicide or an agriculturally acceptable N-oxide, salt, or ester thereof, and (b) a 4-hydroxyphenyl-pyruvate dioxygenase (HPPD) inhibitor or an agriculturally acceptable salt or ester thereof. In some embodiments, the weight ratio of (a) to (b) can be from 1:8000 to 1000:1 (e.g., from 1:2000 to 250:1, from 1:500 to 60:1, from 1:125 to 15:1, or from 1:30 to 5:1).

The pyridine carboxylic acid herbicide can comprise a compound defined by Formula (I)

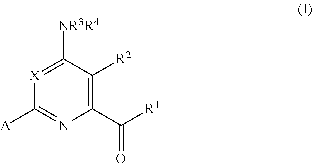

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is one of groups A1 to A36

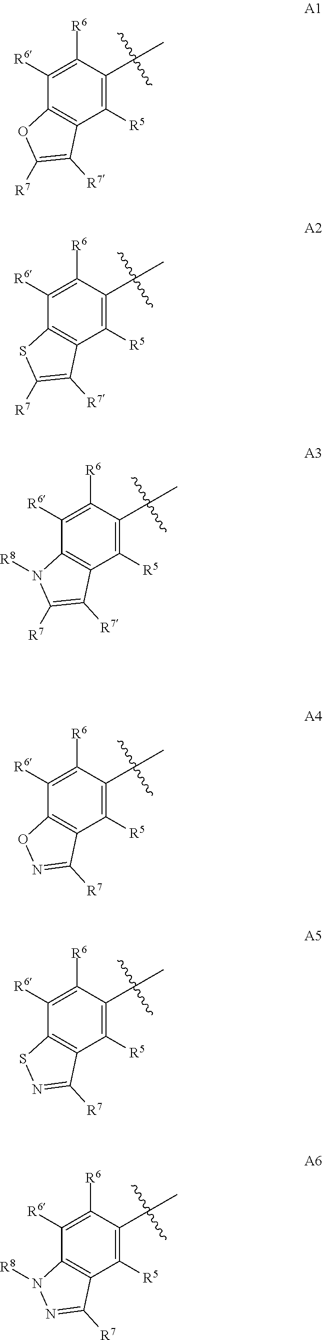

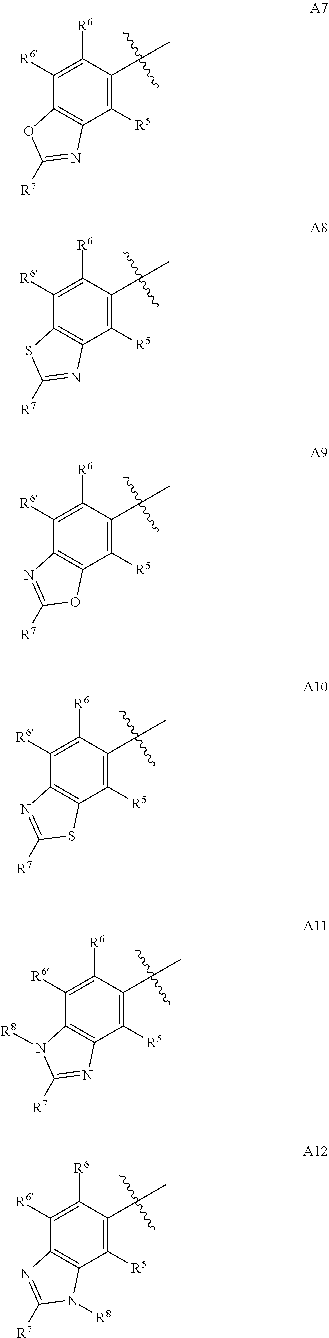

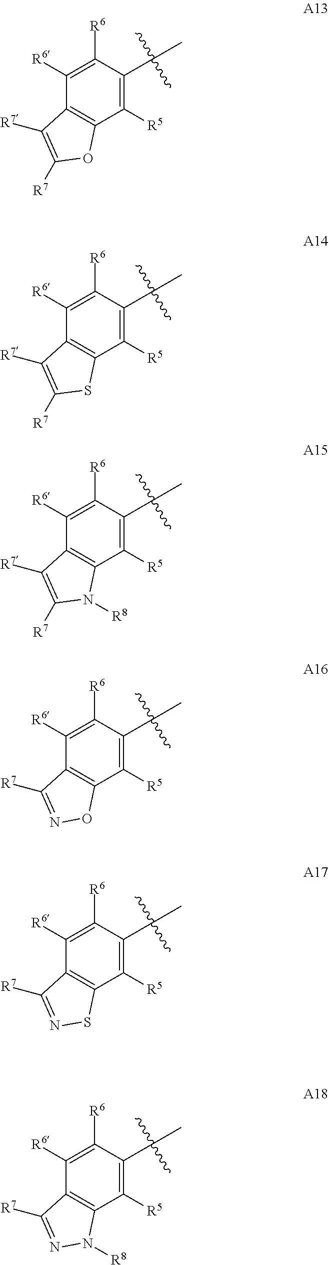

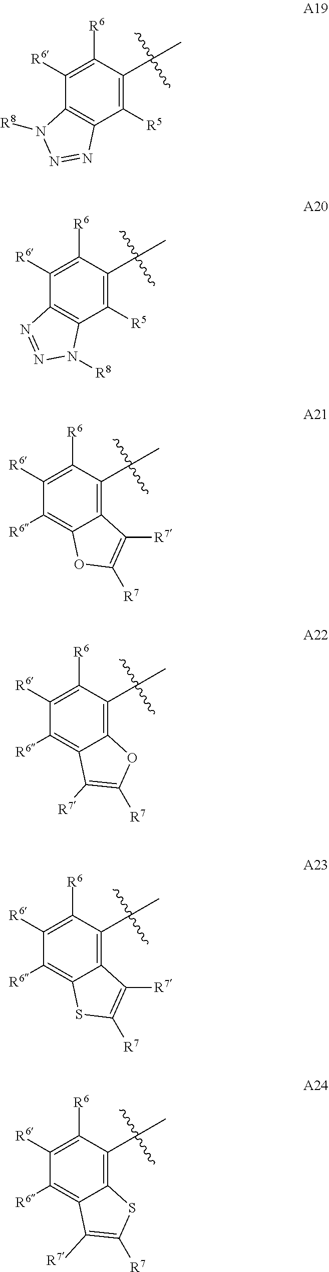

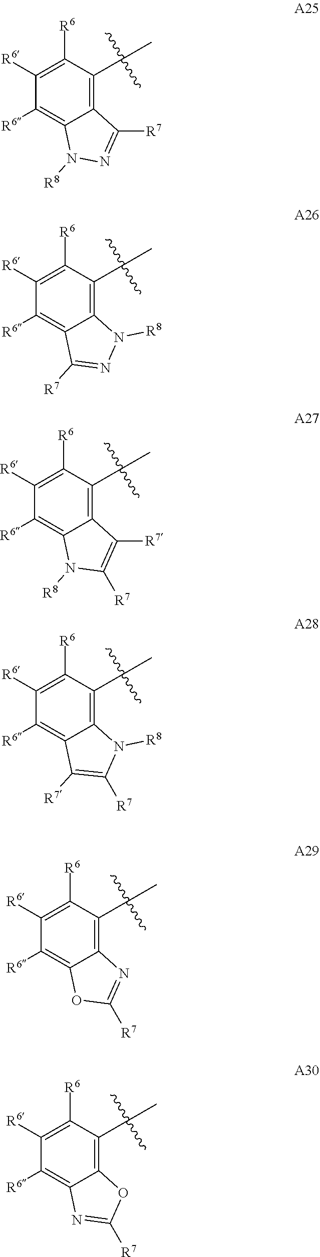

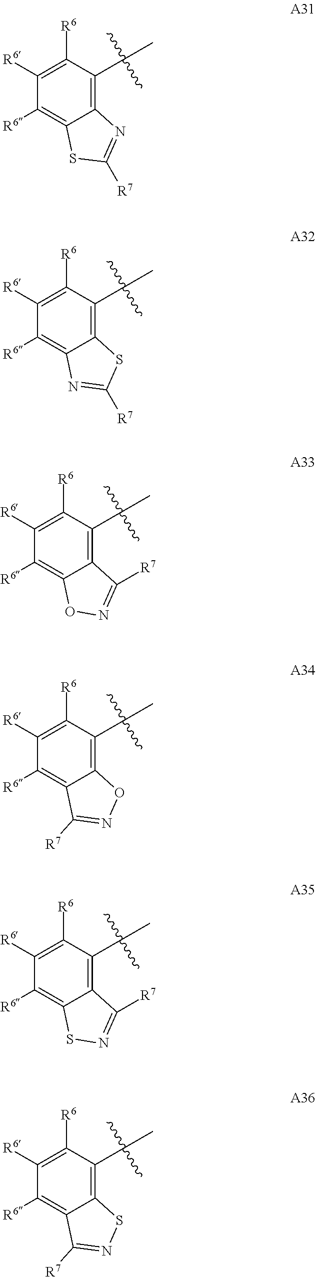

R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In certain embodiments, the pyridine carboxylic acid herbicide can comprise a compound defined by Formula (II):

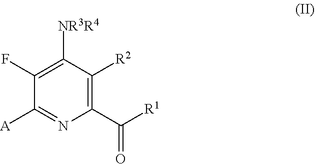

wherein

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments, R¹ is OR^{1′}, wherein R^{1′} is hydrogen, C₁-C₈ alkyl, or C₇-C₁₀ arylalkyl. In certain embodiments, R² is Cl, methoxy, vinyl, or 1-propenyl; R³ and R⁴ are hydrogen; A is A15; R⁵ is hydrogen or F; and R⁶ is hydrogen or F; and R^{6″} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide can comprise a compound defined by Formula (III):

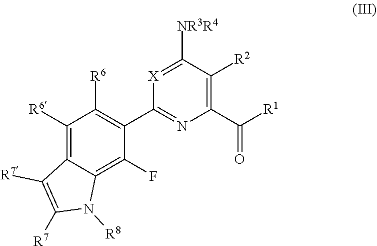

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments, X is N, CH or CF. In certain embodiments, X is CF, R¹ is OR^{1′}, wherein R^{1′} is hydrogen, C₁-C₈ alkyl, or C₇-C₁₀ arylalkyl; R² is Cl, methoxy, vinyl, or 1-propenyl; R³ and R⁴ are hydrogen; R⁶ is hydrogen or F; and R^{6′} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide can include 4-amino-3-chloro-5-fluoro-6-(7-fluoro-1H-indol-6-yl) picolinic acid or an agriculturally acceptable N-oxide, salt, or ester thereof.

In some embodiments, (b) can comprise an HPPD inhibitor. In certain embodiments, (b) can include benzobicyclon, benzofenap, bicyclopyrone, fenquinotrione, isoxachlortole, isoxaflutole, mesotrione, pyrasulfotole, pyrazolynate, pyrazoxyfen, sulcotrione, tembotrione, tefuryltrione, topramezone, or an agriculturally acceptable salt thereof of at least one of the aforementioned HPPD inhibitors, or combinations thereof.

The composition can further comprise an additional pesticide, a herbicidal safener, an agriculturally acceptable adjuvant or carrier, or a combination thereof. The composition can be provided as a herbicidal concentrate.

The present disclosure also relates to methods of controlling undesirable vegetation which comprise applying to vegetation or an area adjacent the vegetation or applying to soil or water to prevent the emergence or growth of vegetation a herbicidally effective amount of (a) a pyridine carboxylic acid herbicide or an agriculturally acceptable N-oxide, salt, or ester thereof and (b) a 4-hydroxyphenyl-pyruvate dioxygenase (HPPD) inhibitor or an agriculturally acceptable salt thereof. In some embodiments, (a) and (b) are applied simultaneously. In some embodiments, (a) and (b) are applied post-emergence to the undesirable vegetation.

In some embodiments, (a) can comprise a pyridine carboxylic acid herbicide described above. In certain embodiments, (a) can comprise 4-amino-3-chloro-5-fluoro-6-(7-fluoro-1H-indol-6-yl) picolinic acid or an agriculturally acceptable N-oxide, salt, or ester thereof. In some embodiments, (b) can comprise a 4-hydroxyphenyl-pyruvate dioxygenase (HPPD) inhibitor. In certain embodiments, (b) can include benzobicyclon, benzofenap, bicyclopyrone, fenquinotrione, isoxachlortole, isoxaflutole, mesotrione, pyrasulfotole, pyrazolynate, pyrazoxyfen, sulcotrione, tembotrione, tefuryltrione, topramezone, or an agriculturally acceptable salt thereof. In some cases, (a) can be applied in an amount of from 0.5 grams acid equivalent per hectare (g ae/ha) to 300 g ae/ha (e.g., from 5 g ae/ha to 40 g ae/ha) and (b) can be applied in an amount of from 1 gram active ingredient per hectare (g ai/ha) to 4000 g ai/ha (e.g., from 1 g ai/ha to 1000 g ai/ha). In some cases, (a) and (b) can be applied in a weight ratio of from 1:8000 to 1000:1 (e.g., from 1:2000 to 250:1, from 1:500 to 60:1, from 1:125 to 15:1, or from 1:30 to 5:1).

The description below sets forth details of one or more embodiments of the present disclosure. Other features, objects, and advantages will be apparent from the description and from the claims.

### DETAILED DESCRIPTION

The present disclosure relates to herbicidal compositions containing a herbicidally effective amount of (a) a pyridine carboxylic acid herbicide or an agriculturally acceptable N-oxide, salt, or ester thereof and (b) a 4-hydroxyphenyl-pyruvate dioxygenase (HPPD) inhibitor or an agriculturally acceptable salt thereof. The present disclosure also relates to methods for controlling undesirable vegetation.

### I. Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. The prefix Cₙ-Cₘ preceding a group or moiety indicates, in each case, the possible number of carbon atoms in the group or moiety that follows.

As used herein, the terms “herbicide” and “herbicidal active ingredient” refer to an active ingredient that kills, controls, or otherwise adversely modifies the growth of vegetation, particularly undesirable vegetation, such as weeds, when applied in an appropriate amount.

As used herein, a “herbicidally effective amount” refers to an amount of an active ingredient that causes a “herbicidal effect,” such as an adversely modifying effect including, for instance, a deviation from natural growth or development, killing, regulation, desiccation, growth inhibition, growth reduction, and retardation.

As used herein, applying a herbicide or herbicidal composition refers to delivering it directly to the targeted vegetation or to the locus thereof or to the area where control of undesired vegetation is desired. Methods of application include, but are not limited to pre-emergently contacting soil or water, post-emergently contacting the undesirable vegetation or area adjacent to the undesirable vegetation.

As used herein, the terms “crops” and “vegetation” can include, for instance, dormant seeds, germinant seeds, emerging seedlings, plants emerging from vegetative propagules, immature vegetation, and established vegetation.

As used herein, immature vegetation refers to small vegetative plants prior to reproductive stage, and mature vegetation refers to vegetative plants during and after the reproductive stage.

As used herein, unless otherwise specified, the term “acyl” refers to a group of formula —C(O)R, where R is hydrogen, alkyl (e.g., C₁-C₁₀ alkyl), haloalkyl (C₁-C₈ haloalkyl), alkenyl (C₂-C₈ alkenyl), haloalkenyl (e.g., C₂-C₈ haloalkenyl), alkynyl (e.g., C₂-C₈ alkynyl), alkoxy (C₁-C₈ alkoxy), haloalkoxy (C₁-C₈ alkoxy), aryl, or heteroaryl, arylalkyl (C₇-C₁₀ arylalkyl), as defined below, where “C(O)” or “CO” is short-hand notation for C═O. In some embodiments, the acyl group can be a C₁-C₆ acyl group (e.g., a formyl group, a C₁-C₅ alkylcarbonyl group, or a C₁-C₅ haloalkylcarbonyl group). In some embodiments, the acyl group can be a C₁-C₃ acyl group (e.g., a formyl group, a C₁-C₃ alkylcarbonyl group, or a C₁-C₃ haloalkylcarbonyl group).

As used herein, the term “alkyl” refers to saturated, straight-chained or branched saturated hydrocarbon moieties. Unless otherwise specified, C₁-C₂₀ (e.g., C₁-C₁₂, C₁-C₁₀, C₁₋C₈, C₁-C₆, C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, and 1-ethyl-2-methyl-propyl. Alkyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “haloalkyl” refers to straight-chained or branched alkyl groups, wherein these groups the hydrogen atoms may partially or entirely be substituted with halogen atoms. Unless otherwise specified, C₁-C₂₀ (e.g., C₁-C₁₂, C₁-C₁₀, C₁-C₈, C₁-C₆, C₁-C₄) alkyl groups are intended. Examples include chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, and 1,1,1-trifluoroprop-2-yl. Haloalkyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “alkenyl” refers to unsaturated, straight-chained, or branched hydrocarbon moieties containing a double bond. Unless otherwise specified, C₂-C₂₀ (e.g., C₂-C₁₂, C₂-C₁₀, C₂-C₈, C₂-C₆, C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Alkenyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

The term “haloalkenyl,” as used herein, refers to an alkenyl group, as defined above, which is substituted by one or more halogen atoms.

As used herein, the term “alkynyl” represents straight-chained or branched hydrocarbon moieties containing a triple bond. Unless otherwise specified, C₂-C₂₀ (e.g., C₂-C₁₂, C₂-C₁₀, C₂-C₈, C₂-C₆, C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “alkoxy” refers to a group of the formula R—O—, where R is unsubstituted or substituted alkyl as defined above. Unless otherwise specified, alkoxy groups wherein R is a C₁-C₂₀ (e.g., C₁-C₁₂, C₁-C₁₀, C₁-C₈, C₁-C₆, C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

As used herein, the term “haloalkoxy” refers to a group of the formula R—O—, where R is unsubstituted or substituted haloalkyl as defined above. Unless otherwise specified, haloalkoxy groups wherein R is a C₁-C₂₀ (e.g., C₁-C₁₂, C₁-C₁₀, C₁-C₈, C₁-C₆, C₁-C₄) alkyl group are intended. Examples include chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, and 1,1,1-trifluoroprop-2-oxy.

As used herein, the term “alkylthio” refers to a group of the formula R—S—, where R is unsubstituted or substituted alkyl as defined above. Unless otherwise specified, alkylthio groups wherein R is a C₁-C₂₀ (e.g., C₁-C₁₂, C₁-C₄) alkyl group are intended. Examples include methylthio, ethylthio, propylthio, 1-methylethylthio, butylthio, 1-methyl-propylthio, 2-methylpropylthio, 1,1-dimethylethylthio, pentylthio, 1-methylbutylthio, 2-methylbutylthio, 3-methylbutylthio, 2,2-di-methylpropylthio, 1-ethylpropylthio, hexylthio, 1,1-dimethylpropylthio, 1,2-dimethylpropylthio, 1-methylpentylthio, 2-methylpentylthio, 3-methyl-pentylthio, 4-methyl-pentylthio, 1,1-dimethylbutylthio, 1,2-dimethylbutylthio, 1,3-dimethylbutylthio, 2,2-dimethylbutylthio, 2,3-dimethylbutylthio, 3,3-dimethylbutylthio, 1-ethylbutylthio, 2-ethylbutylthio, 1,1,2-trimethylpropylthio, 1,2,2-trimethylpropylthio, 1-ethyl-1-methylpropylthio, and 1-ethyl-2-methylpropylthio.

As used herein, the term “haloalkylthio” refers to an alkylthio group as defined above wherein the carbon atoms are partially or entirely substituted with halogen atoms. Unless otherwise specified, haloalkylthio groups wherein R is a C₁-C₂₀ (e.g., C₁-C₁₂, C₁-C₁₀, C₁-C₈, C₁-C₆, C₁-C₄) alkyl group are intended. Examples include chloromethylthio, bromomethylthio, dichloromethylthio, trichloromethylthio, fluoromethylthio, difluoromethylthio, trifluoromethylthio, chlorofluoromethylthio, dichlorofluoro-methylthio, chlorodifluoromethylthio, 1-chloroethylthio, 1-bromoethylthio, 1-fluoroethylthio, 2-fluoroethylthio, 2,2-difluoroethylthio, 2,2,2-trifluoroethylthio, 2-chloro-2-fluoroethylthio, 2-chloro-2-difluoroethylthio, 2,2-dichloro-2-fluoroethylthio, 2,2,2-trichloroethylthio, pentafluoroethylthio, and 1,1,1-trifluoroprop-2-ylthio.

As used herein, the term “aryl,” as well as derivative terms such as aryloxy, refers to groups that include a monovalent aromatic carbocyclic group of from 6 to 14 carbon atoms. Aryl groups can include a single ring or multiple condensed rings. In some embodiments, aryl groups include C₆-C₁₀ aryl groups. Examples of aryl groups include, but are not limited to, phenyl, biphenyl, naphthyl, tetrahydronaphthyl, phenylcyclopropyl, and indanyl. In some embodiments, the aryl group can be a phenyl, indanyl or naphthyl group. The term “heteroaryl”, as well as derivative terms such as “heteroaryloxy”, refers to a 5- or 6-membered aromatic ring containing one or more heteroatoms, viz., N, O or S; these heteroaromatic rings may be fused to other aromatic systems. The aryl or heteroaryl substituents may be unsubstituted or substituted with one or more chemical moieties. Examples of suitable substituents include, for example, hydroxy, nitro, cyano, formyl, C₁-C₆ alkyl, C₂-C₆ alkenyl, C₂-C₆ alkynyl, C₁-C₆ alkoxy, C₁-C₆ haloalkyl, C₁-C₆ haloalkoxy, C₁-C₆ acyl, C₁-C₆ alkylthio, C₁-C₆ alkylsulfinyl, C₁-C₆ alkylsulfonyl, C₁-C₆ alkoxycarbonyl, C₁-C₆ carbamoyl, hydroxycarbonyl, C₁-C₆ alkylcarbonyl, aminocarbonyl, C₁-C₆ alkylaminocarbonyl, C₁-C₆ dialkylaminocarbonyl, provided that the substituents are sterically compatible and the rules of chemical bonding and strain energy are satisfied. Preferred substituents include halogen, C₁-C₂ alkyl and C₁-C₂ haloalkyl.

As used herein, the term “alkylcarbonyl” refers to an unsubstituted or substituted alkyl group bonded to a carbonyl group. C₁-C₃ alkylcarbonyl and C₁-C₃ haloalkylcarbonyl refer to groups wherein a C₁-C₃ unsubstituted or substituted alkyl or haloalkyl group is bonded to a carbonyl group (the group contains a total of 2 to 4 carbon atoms).

As used herein, the term “alkoxycarbonyl” refers to a group of the formula

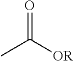

wherein R is unsubstituted or substituted alkyl.

As used herein, the term “arylalkyl” refers to an alkyl group substituted with an unsubstituted or substituted aryl group. C₇-C₁₀ arylalkyl refers to a group wherein the total number of carbon atoms in the group is 7 to 10, not including the carbon atoms present in any substituents of the aryl group.

As used herein, the term “alkylamino” refers to an amino group substituted with one or two unsubstituted or substituted alkyl groups, which may be the same or different.

As used herein, the term “haloalkylamino” refers to an alkylamino group wherein the alkyl carbon atoms are partially or entirely substituted with halogen atoms.

As used herein, C₁-C₆ alkylaminocarbonyl refers to a group of the formula RNHC(O)— wherein R is C₁-C₆ unsubstituted or substituted alkyl, and C₁-C₆ dialkylaminocarbonyl refers to a group of the formula R₂NC(O)— wherein each R is independently C₁-C₆ unsubstituted or substituted alkyl.

As used herein, the term “alkylcarbamyl” refers to a carbamyl group substituted on the nitrogen with an unsubstituted or substituted alkyl group.

As used herein, the term “alkylsulfonyl” refers to a group of the formula

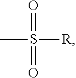

where R is unsubstituted or substituted alkyl.

As used herein, the term “carbamyl” (also referred to as carbamoyl and aminocarbonyl) refers to a group of the formula

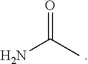

As used herein, the term “dialkylphosphonyl” refers to a group of the formula

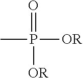

where R is independently unsubstituted or substituted alkyl in each occurrence.

As used herein, C₁-C₆ trialkylsilyl refers to a group of the formula —SiR₃ wherein each R is independently a C₁-C₆ unsubstituted or substituted alkyl group (the group contains a total of 3 to 18 carbon atoms).

As used herein, Me refers to a methyl group; OMe refers to a methoxy group; and i-Pr refers to an isopropyl group.

As used herein, the term “halogen” including derivative terms such as “halo” refers to fluorine, chlorine, bromine and iodine.

As used herein, agriculturally acceptable salts and esters refer to salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

Compounds described herein can include N-oxides. Pyridine N-oxides can be obtained by oxidation of the corresponding pyridines. Suitable oxidation methods are described, for example, in Houben-Weyl, Methoden der organischen Chemie [Methods in organic chemistry], expanded and subsequent volumes to the 4th edition, volume E 7b, p. 565 f

Pyridine Carboxylic Acid Herbicides

Compositions and methods of the present disclosure can include a pyridine carboxylic acid herbicide defined by Formula (I)

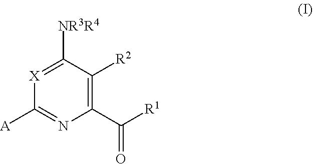

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷—CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is one of groups A1 to A36

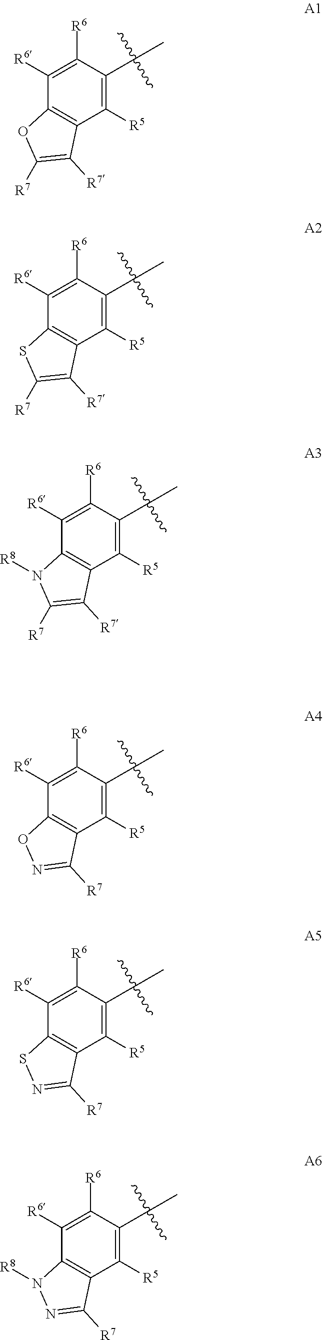

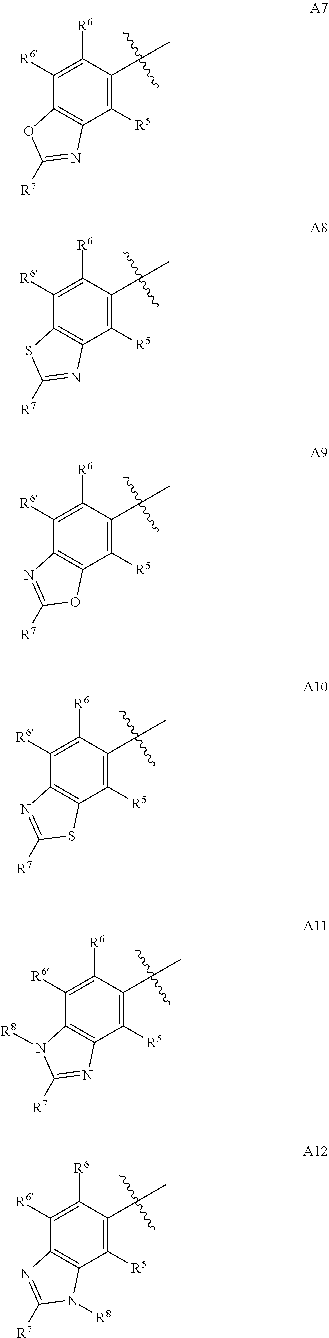

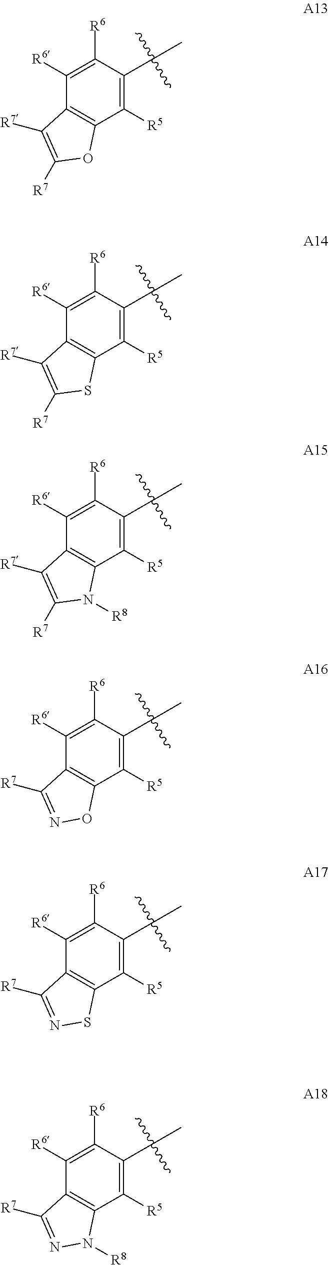

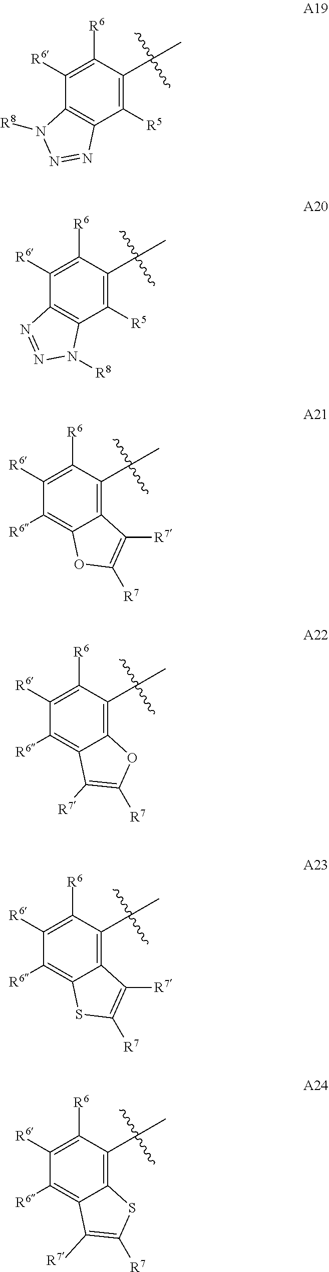

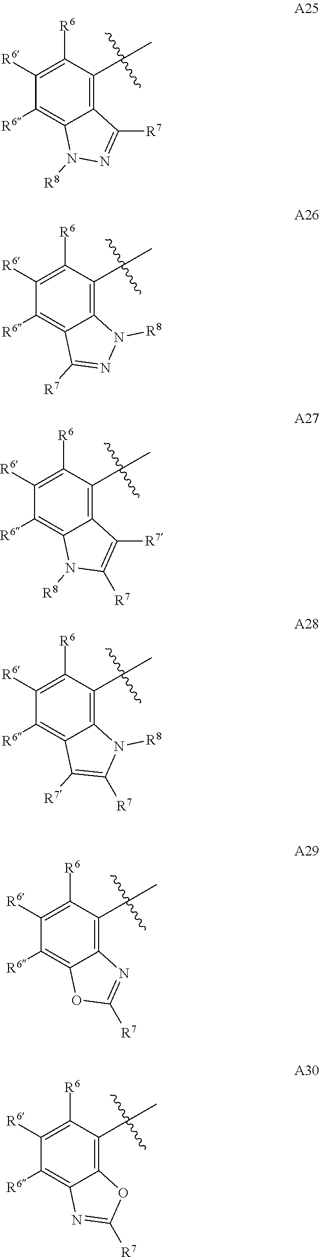

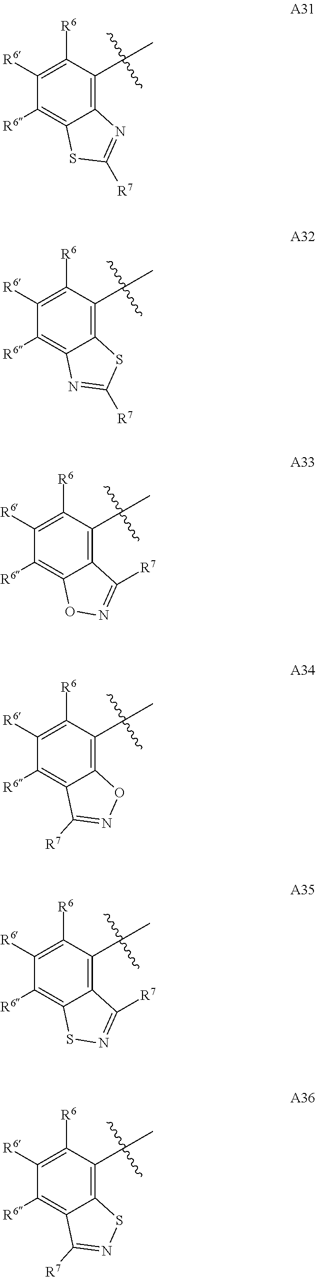

R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments, R¹ is OR^{1′}, wherein R^{1′} is hydrogen, C₁-C₈ alkyl, or C₇-C₁₀ arylalkyl. In some embodiments, R^{1′} is hydrogen or C₁-C₈ alkyl. In some embodiments, R^{1′} is hydrogen.

In some embodiments, R² is halogen, C₁-C₄ alkyl, C₁-C₄ haloalkyl, C₂-C₄ alkynyl, C₂-C₄-alkenyl, C₂-C₄ haloalkenyl, C₁-C₄-alkoxy, or C₁-C₄ haloalkoxy. In some embodiments, R² is halogen, C₂-C₄-alkenyl, C₂-C₄ haloalkenyl, or C₁-C₄-alkoxy. In some embodiments, R² is halogen. In some embodiments, R² is C₂-C₄-alkenyl or C₂-C₄ haloalkenyl. In some embodiments, R² is C₁-C₄ alkoxy. In some embodiments, R² is Cl, OMe, vinyl, or 1-propenyl. In some embodiments, R² is Cl. In some embodiments, R² is OMe. In some embodiments, R² is vinyl or 1-propenyl.

In some embodiments, R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy, or C₁-C₆ alkylamino. In some embodiments, R³ and R⁴ are independently hydrogen, C₁-C₆ alkyl, C₁-C₆ haloalkyl, C₃-C₆ alkenyl, C₃-C₆ haloalkenyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₁-C₆ alkoxy or C₁-C₆ alkylamino. In some embodiments, R³ and R⁴ are independently hydrogen, C₁-C₆ alkyl, C₁-C₆ haloalkyl, C₃-C₆ alkenyl, C₃-C₆ haloalkenyl, formyl, C₁-C₃ alkylcarbonyl, or C₁-C₃ haloalkylcarbonyl. In some embodiments, at least one of R³ and R⁴ are hydrogen. In some embodiments, R³ and R⁴ are both hydrogen.

In some embodiments, X is N, CH or CF. In some embodiments, X is N. In some embodiments, X is CH. In some embodiments, X is CF. In other embodiments, X is C—CH₃.

In some embodiments, A is A1, A2, A3, A4, A5, A6, A7, A8, A9, A10, A11, A12, A13, A14, A15, A16, A17, A18, A19, or A20. In other embodiments, A is one of A21, A22, A23, A24, A25, A26, A27, A28, A29, A30, A31, A32, A33, A34, A35, and A36.

In some embodiments, A is one of groups A1, A2, A3, A7, A8, A9, A10, A13, A14, and A15. In some embodiments, A is one of groups A1, A2, A3, A13, A14, and A15. In some embodiments, A is one of groups A13, A14, and A15. In some embodiments, A is A15.

In some embodiments, R⁵ is hydrogen, halogen, C₁-C₄ alkyl, C₁-C₄ haloalkyl, C₁-C₃ alkoxy, C₁-C₃ haloalkoxy, C₁-C₃ alkylthio, C₁-C₃ haloalkylthio, or amino. In some embodiments, R⁵ is hydrogen, halogen, C₁-C₄ alkyl, C₁-C₄ haloalkyl, C₁-C₃ alkoxy, C₁-C₃ haloalkoxy, or amino. In some embodiments, R⁵ is hydrogen, halogen, C₁-C₄ alkyl or C₁-C₄ alkoxy. In some embodiments, R⁵ is hydrogen or F. In some embodiments, R⁵ is hydrogen. In other embodiments, R⁵ is F.

In some embodiments, R⁶ is hydrogen, halogen, C₁-C₄ alkyl, C₁-C₄ haloalkyl, C₁-C₃ alkoxy, or C₁-C₃ haloalkoxy. In some embodiments, R⁶ is hydrogen or fluorine. In some embodiments, R⁶ is hydrogen. In some embodiments, R⁶ is fluorine.

In some embodiments, R^{6′} is hydrogen or halogen. In some embodiments, R^{6′} is hydrogen, F, or Cl. In some embodiments, R^{6′} is hydrogen or F. In some embodiments, R^{6′} is hydrogen.

In some embodiments, R^{6″} is hydrogen, halogen, C₁-C₄ alkyl, C₁-C₄ haloalkyl, cyclopropyl, C₂-C₄ alkynyl, CN, or NO₂. In some embodiments, R^{6″} is hydrogen. In some embodiments, R^{6″} is halogen. In some embodiments, R^{6″} is C₁-C₄ alkyl. In some embodiments, R^{6″} is C₁-C₄ haloalkyl. In some embodiments, R^{6″} is cyclopropyl. In some embodiments, R^{6″} is C₂-C₄ alkynyl. In some embodiments, R^{6″} is CN. In some embodiments, R^{6″} is NO₂.

In some embodiments:

X is N, CH, CF, CCl, or CBr;

R¹ is OR^{1′}, wherein R^{1′} is hydrogen or C₁-C₄ alkyl;

R² is chlorine;

R³ and R⁴ are hydrogen;

A is A1, A2, A3, A4, A5, A6, A7, A8, A9, A10, A11, A12, A13, A14, A15, A16, A17, A18, A19, or A20;

R⁵ is hydrogen, halogen, OH, amino, CN, C₁-C₃ alkyl, C₁-C₃ alkoxy, C₁-C₃ alkylamino, or cyclopropyl;

R⁶, R^{6′}, and R^{6″} are independently hydrogen, halogen, OH, NH₂, CN, C₁-C₃ alkyl, C₁-C₃ alkoxy, cyclopropyl, or vinyl;

R⁷ and R^{7′} are independently hydrogen, halogen, C₁-C₃ alkyl, C₁-C₃ alkoxy, C₁-C₃ alkylthio, cyclopropyl, or C₁-C₃ alkylamino, or phenyl; and

R⁸ is hydrogen, C₁-C₃ alkyl, phenyl, or C₁-C₃ alkylcarbonyl.

In some embodiments, R² is halogen, C₂-C₄-alkenyl, C₂-C₄ haloalkenyl, or C₁-C₄-alkoxy; R³ and R⁴ are both hydrogen; and X is N, CH, or CF.

In some embodiments, R² is halogen; R³ and R⁴ are both hydrogen; and X is N, CH, or CF.

In some embodiments, R² is C₂-C₄-alkenyl or C₂-C₄ haloalkenyl; R³ and R⁴ are both hydrogen; and X is N, CH, or CF.

In some embodiments, R² is C₁-C₄-alkoxy; R³ and R⁴ are both hydrogen; and X is N, CH, or CF.

In some embodiments, R² is halogen, C₂-C₄-alkenyl, C₂-C₄ haloalkenyl, or C₁-C₄-alkoxy; R³ and R⁴ are both hydrogen; X is N, CH, or CF; R⁵ is hydrogen or F; R⁶ is hydrogen or F; R^{6′} is hydrogen; R^{6″}, if applicable to the relevant A group, is hydrogen or halogen; and R⁷ and R^{7′}, if applicable to the relevant A group, are independently hydrogen or halogen.

In some embodiments, R² is halogen, C₁-C₄-alkoxy, or C₂-C₄-alkenyl; R³ and R⁴ are hydrogen; X is N, CH, or CF; and A is one of groups A1 to A20.

In some embodiments, R² is chlorine; R³ and R⁴ are hydrogen; X is N, CH, or CF; A is one of groups A1 to A20; R⁵ is hydrogen or F; R⁶ and R^{6′} are independently hydrogen or F; and R⁷ and R^{7′}, if applicable to the relevant A group, are independently hydrogen, halogen, C₁-C₄ alkyl, or C₁-C₄ haloalkyl.

In some embodiments, R² is chlorine, methoxy, vinyl, or 1-propenyl; R³ and R⁴ are hydrogen; and X is N, CH, or CF.

In some embodiments, R² is chlorine; R³ and R⁴ are hydrogen; and X is N, CH, or CF.

In some embodiments, R² is vinyl or 1-propenyl; R³ and R⁴ are hydrogen; and X is N, CH, or CF.

In some embodiments, R² is methoxy; R³ and R⁴ are hydrogen; and X is N, CH, or CF.

In some embodiments, R² is chlorine; R³ and R⁴ are hydrogen; and X is N.

In some embodiments, R² is chlorine; R³ and R⁴ are hydrogen; and X is CH.

In some embodiments, R² is chlorine; R³ and R⁴ are hydrogen; and X is CF.

In some embodiments, R² is chlorine; R³ and R⁴ are hydrogen; X is CF; A is one of A1, A2, A3, A7, A8, A9, A10, A13, A14, or A15; R⁵ is F; and R⁶ is H.

In some embodiments, R² is chlorine, methoxy, vinyl, or 1-propenyl; R³ and R⁴ are hydrogen; X is N, CH, or CF; and A is one of A21-A36.

In some embodiments, R² is chlorine, methoxy, vinyl, or 1-propenyl; R³ and R⁴ are hydrogen; X is CF; and A is one of

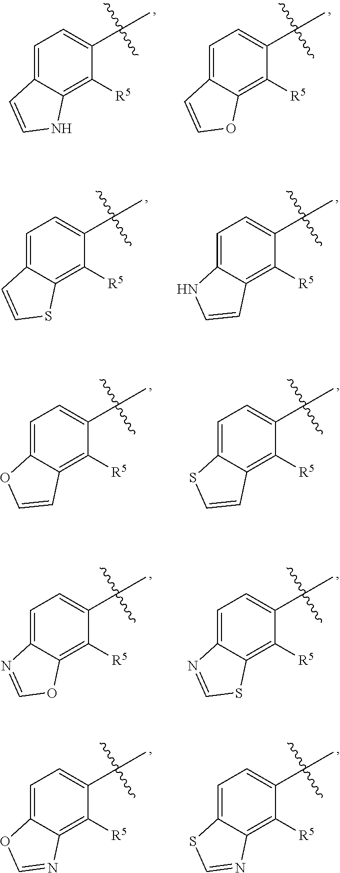

wherein R⁵ is hydrogen or F.

In some embodiments, R² is chlorine, methoxy, vinyl, or 1-propenyl; R³ and R⁴ are hydrogen; X is N, CH, or CF; and A is

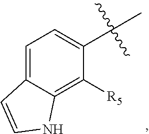

where R⁵ is hydrogen or F.

In some embodiments, R² is chlorine, methoxy, vinyl, or 1-propenyl; R³ and R⁴ are hydrogen; X is N, CH, or CF; and A is

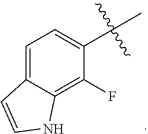 [SMILES: *c1ccc2cc[nH]c2c1F]

In some embodiments, R² is chlorine, methoxy, vinyl, or 1-propenyl; R³ and R⁴ are hydrogen; X is CF; and A is

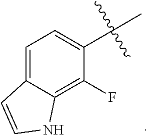 [SMILES: *c1ccc2cc[nH]c2c1F]

In some embodiments, the pyridine carboxylic acid herbicide is a compound defined by Formula (I)

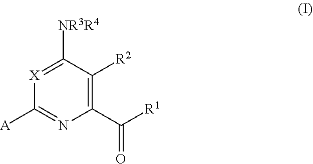

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″} wherein is hydrogen, C₁-C₃ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof,

with the proviso that the pyridine carboxylic acid herbicide is not a compound defined by Formula (I)

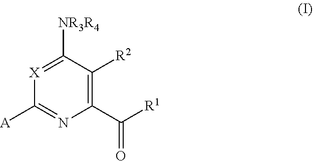

wherein

X is N, CH, CF, CCl, or CBr;

R¹ is OR^{1′}, wherein R^{1′} is hydrogen or C₁-C₄ alkyl;

R² is chlorine;

R³ and R⁴ are hydrogen;

A is A1, A2, A3, A4, A5, A6, A7, A8, A9, A10, A11, A12, A13, A14, A15, A16, A17, A18, A19, or A20;

R⁵ is hydrogen, halogen, OH, amino, CN, C₁-C₃ alkyl, C₁-C₃ alkoxy, C₁-C₃ alkylamino, or cyclopropyl;

R⁶, R^{6′}, and R^{6″} are independently hydrogen, halogen, OH, NH₂, CN, C₁-C₃ alkyl, C₁-C₃ alkoxy, cyclopropyl, or vinyl;

R⁷ and R^{7′} are independently hydrogen, halogen, C₁-C₃ alkyl, C₁-C₃ alkoxy, C₁-C₃ alkylthio, cyclopropyl, C₁-C₃ alkylamino, or phenyl; and

R⁸ is hydrogen, C₁-C₃ alkyl, phenyl, or C₁-C₃ alkylcarbonyl;

or an agriculturally acceptable N-oxide or salt thereof.

In some of these embodiments, R¹ is OR¹. In some of these embodiments, X is CF. In some of these embodiments, A is A15. In some of these embodiments, R⁵ is F.

In some embodiments:

X is CY, wherein Y is C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″} wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl;

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is F, Br, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, or A20;

R⁵ is C₁-C₄ alkyl, C₁-C₄ haloalkyl, halocyclopropyl, C₂-C₄ alkenyl, C₂-C₄ haloalkenyl, C₂-C₄ alkynyl, C₁-C₃ haloalkoxy, C₁-C₃ alkylthio, C₁-C₃ haloalkylthio, C₂-C₄ alkylamino, or C₂-C₄ haloalkylamino;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, or A20;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently C₁-C₄ alkyl, C₁-C₄ haloalkyl, halocyclopropyl, C₃-C₄ alkenyl, C₂-C₄ haloalkenyl, C₂-C₄ alkynyl, C₁-C₃ haloalkoxy, C₁-C₃ alkylthio, C₁-C₃ haloalkylthio, C₁-C₄ alkylamino or C₂-C₄ haloalkylamino, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, or A18;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently C₁-C₄ alkyl, C₁-C₄ haloalkyl, halocyclopropyl, C₂-C₄ alkenyl, C₂-C₄ haloalkenyl, C₂-C₄ alkynyl, C₁-C₃ haloalkoxy, C₁-C₃ haloalkylthio, amino, C₄ alkylamino, or C₂-C₄ haloalkylamino; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl.

In some of these embodiments, R¹ is OR¹. In some of these embodiments, X is CF. In some of these embodiments, A is A15. In some of these embodiments, R⁵ is F.

In some embodiments:

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio, or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A3, A6, A11, A12, A15, A18, A19, or A20;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is C₃-C₆ alkyl, C₁-C₆ haloalkyl, C₃-C₆ alkenyl, C₃-C₆ haloalkenyl, C₃-C₆ alkynyl, formyl, C₁-C₃ haloalkylcarbonyl, C₁-C₆ alkoxycarbonyl, C₁-C₆ alkylcarbamyl, C₁-C₆ alkylsulfonyl, or C₁-C₆ trialkylsilyl.

In some of these embodiments, R¹ is OR¹. In some of these embodiments, X is CF. In some of these embodiments, A is A15. In some of these embodiments, R⁵ is F.

In certain embodiments, the pyridine carboxylic acid herbicide is a compound defined by Formula (II):

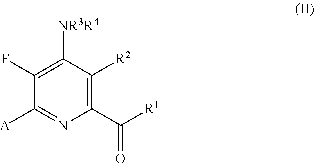

wherein

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;

R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments:

R¹ is OR^{1′}, wherein R^{1′} is hydrogen, C₁-C₈ alkyl, or C₇-C₁₀ arylalkyl;

R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio.

R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;

A is A1, A2, A3, A7, A8, A9, A10, A11, A12, A13, A14, A15, A21, A22, A23, A24, A27, A28, A29, A30, A31, or A32;

R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;

R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;

R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and

R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

In some embodiments, R¹ is OR^{1′}, wherein R^{1′} is hydrogen, C₁-C₈ alkyl, or C₇-C₁₀ arylalkyl.

In some embodiments, R² is halogen, C₂-C₄-alkenyl, C₂-C₄ haloalkenyl, or C₁-C₄-alkoxy. In certain embodiments, R² is Cl, methoxy, vinyl, or 1-propenyl. In some embodiments, R³ and R⁴ are hydrogen.

In some embodiments, A is A1, A2, A3, A7, A8, A9, A10, A13, A14, or A15. In certain embodiments, A is A1, A2, A3, A13, A14, or A15. In certain embodiments, A is A15.

In some embodiments, R⁵ is hydrogen or F. In certain embodiments, R⁵ is F. In certain embodiments, R⁵ is H.

In some embodiments, R⁶ is hydrogen or F. In certain embodiments, R⁶ is F. In certain embodiments, R⁶ is H. In some embodiments, R^{6″} is hydrogen, halogen, C₁-C₄ alkyl, C₁-C₄ haloalkyl, cyclopropyl, C₂-C₄ alkynyl, CN, or NO₂. In certain embodiments, R⁶, R^{6′}, and R^{6″} are all hydrogen.

In certain embodiments, R² is Cl, methoxy, vinyl, or 1-propenyl; R³ and R⁴ are hydrogen; A is A15; R⁵ is hydrogen or F; R⁶ is hydrogen or F; and R^{6″} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide is a compound defined by Formula (III):

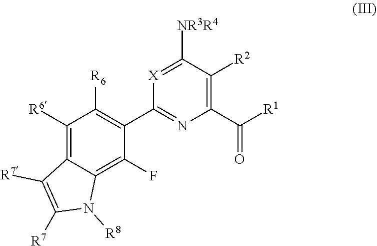

wherein

X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;

R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;

R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;

R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;

R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and

R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;

or an agriculturally acceptable N-oxide or salt thereof.

In some embodiments:

X is N, CH, CF, CCl, or CBr;

R¹ is OR^{1′}, wherein is hydrogen, C₁-C₈ alkyl, or C₇-C₁₀ arylalkyl;

R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;

R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;

R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;

R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and

R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

In some embodiments, X is N, CH or CF. In some embodiments, X is N. In some embodiments, X is CH. In some embodiments, X is CF. In other embodiments, X is C—CH₃.

In some embodiments, R² is halogen, C₂-C₄-alkenyl, C₂-C₄ haloalkenyl, or C₁-C₄-alkoxy. In certain embodiments, R² is Cl, methoxy, vinyl, or 1-propenyl. In some embodiments, R³ and R⁴ are hydrogen.

In some embodiments, R⁶ is hydrogen or F. In certain embodiments, R⁶ is F. In certain embodiments, R⁶ is H. In some embodiments, R^{6′} is hydrogen, halogen, C₁-C₄ alkyl, C₁-C₄ haloalkyl, cyclopropyl, C₂-C₄ alkynyl, CN, or NO₂. In certain embodiments, R⁶ and R^{6′} are both hydrogen.

In certain embodiments, R⁷ and R^{7′} are both hydrogen.

In certain embodiments, R⁶, R^{6′}, R⁷, and R^{7′} are all hydrogen.

In certain embodiments, X is CF, R¹ is OR^{1′}, wherein R^{1′} is hydrogen, C₁-C₈ alkyl, or C₇-C₁₀ arylalkyl; R² is Cl, methoxy, vinyl, or 1-propenyl; R³ and R⁴ are hydrogen; R⁶ is hydrogen or F; and R^{6′} is hydrogen, halogen, C₁-C₄ alkyl, C₁-C₄ haloalkyl, cyclopropyl, C₂-C₄ alkynyl, CN, or NO₂.

In certain embodiments, the pyridine carboxylic acid herbicide is one of Compounds 1-7, the structures of which are shown in the table below.

| Compound | |
|---|---|
| No. | Structure |
| 1 | 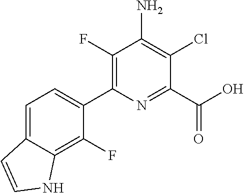 [SMILES: Nc1c(F)c(-c2ccc3cc[nH]c3c2F)nc(C(=O)O)c1Cl] |
| 2 | 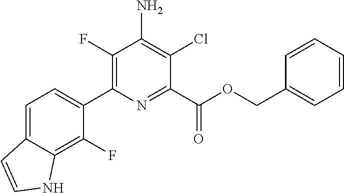 [SMILES: Nc1c(F)c(-c2ccc3cc[nH]c3c2F)nc(C(=O)OCc2ccccc2)c1Cl] |
| 3 | 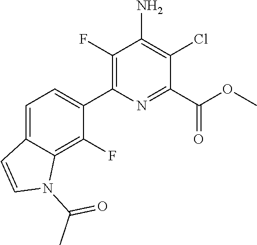 [SMILES: COC(=O)c1nc(-c2ccc3ccn(C(C)=O)c3c2F)c(F)c(N)c1Cl] |
| 4 | 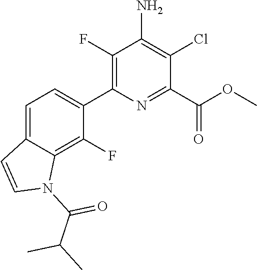 [SMILES: COC(=O)c1nc(-c2ccc3ccn(C(=O)C(C)C)c3c2F)c(F)c(N)c1Cl] |
| 5 | 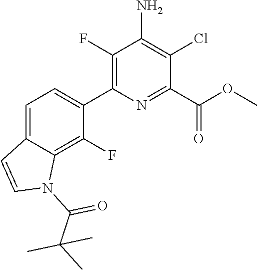 [SMILES: COC(=O)c1nc(-c2ccc3ccn(C(=O)C(C)(C)C)c3c2F)c(F)c(N)c1Cl] |
| 6 | 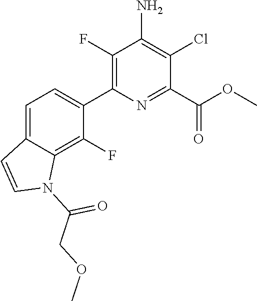 [SMILES: COCC(=O)n1ccc2ccc(-c3nc(C(=O)OC)c(Cl)c(N)c3F)c(F)c21] |
| 7 | 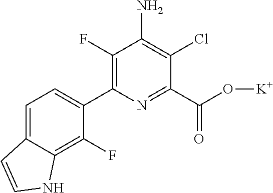 |

In certain embodiments, the pyridine carboxylic acid herbicide is 4-amino-3-chloro-5-fluoro-6-(7-fluoro-1H-indol-6-yl) picolinic acid or an agriculturally acceptable N-oxide, salt, or ester thereof.

In some embodiments, the pyridine carboxylic acid herbicide can be provided as an agriculturally acceptable salt. Exemplary agriculturally acceptable salts of the pyridine carboxylic acid herbicides include, but are not limited to, sodium salts, potassium salts, ammonium salts or substituted ammonium salts, in particular mono-, di- and tri-C₁-C₈ alkylammonium salts such as methyl ammonium, dimethylammonium and isopropylammonium, mono-, di- and tri-hydroxy-C₂-C₈-alkylammonium salts such as hydroxyethylammonium, di(hydroxyethyl)ammonium, tri(hydroxyethyl)ammonium, hydroxypropylammonium, di(hydroxypropyl)ammonium and tri(hydroxypropyl)ammonium salts, olamine salts, diglycolamine salts, choline salts, and quaternary ammonium salts such as those represented by the formula R⁹R¹⁰R¹¹R¹²N⁺ and wherein R⁹, R¹⁰, R¹¹ and R¹² (e.g., R⁹-R¹²) each independently can represent hydrogen, C₁-C₁₀ alkyl, C₂-C₈ alkenyl, C₂-C₈ alkynyl, C₁-C₈ alkoxy, C₁-C₈ alkylthio, or aryl groups, provided that R⁹-R¹² are sterically compatible.

In some embodiments, the pyridine carboxylic acid herbicide can be provided as an agriculturally acceptable ester. Suitable esters include, but are not limited to, C₁-C₈-alkyl esters and C₁-C₄-alkoxy-C₂-C₄-alkyl esters, such as methyl esters, ethyl esters, isopropyl, butyl, hexyl, heptyl, isoheptyl, isooctyl, 2-ethylhexyl, butoxyethyl esters, substituted or unsubstituted aryl esters, orthoesters, and substituted or unsubstituted arylalkyl esters. In some embodiments, the ester is a C₁-C₈ alkyl ester, wherein the C₁-C₈ alkyl group is optionally substituted with one or more moieties selected from the group of cyano, C₂-C₈ alkoxy, and C₂-C₈ alkylsulfonyl. For example, the ester is a methyl, —CH₂CN, —CH₂OCH₃, —CH₂OCH₂CH₂OCH₃, or —CH₂CH₂SO₂CH₃ ester.

In some embodiments, the ester is a substituted or unsubstituted benzyl ester. In some embodiments, the ester is a benzyl ester optionally substituted with one or more moieties selected from the group of halogen, C₁-C₂ alkyl, C₁-C₂ haloalkyl, and combinations thereof. In some embodiments, the ester is a methyl ester.

The pyridine carboxylic acid herbicide, or an agriculturally acceptable N-oxide, salt, or ester thereof, can be applied to vegetation or an area adjacent the vegetation or applied to soil or water to prevent the emergence or growth of vegetation in an amount sufficient to induce a herbicidal effect. In some embodiments, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of 0.5 grams acid equivalent per hectare (g ae/ha) or greater (e.g., 0.6 g ae/ha or greater, 0.7 g ae/ha or greater, 0.8 g ae/ha or greater, 0.9 g ae/ha or greater, 1 g ae/ha or greater, 1.1 g ae/ha or greater, 1.2 g ae/ha or greater, 1.3 g ae/ha or greater, 1.4 g ae/ha or greater, 1.5 g ae/ha or greater, 1.6 g ae/ha or greater, 1.7 g ae/ha or greater, 1.8 g ae/ha or greater, 1.9 g ae/ha or greater, 2 g ae/ha or greater, 2.25 g ae/ha or greater, 2.5 g ae/ha or greater, 2.75 g ae/ha or greater, 3 g ae/ha or greater, 4 g ae/ha or greater, 5 g ae/ha or greater, 6 g ae/ha or greater, 7 g ae/ha or greater, 8 g ae/ha or greater, 9 g ae/ha or greater, 10 g ae/ha or greater, 11 g ae/ha or greater, 12 g ae/ha or greater, 13 g ae/ha or greater, 14 g ae/ha or greater, 15 g ae/ha or greater, 16 g ae/ha or greater, 17 g ae/ha or greater, 18 g ae/ha or greater, 19 g ae/ha or greater, 20 g ae/ha or greater, 21 g ae/ha or greater, 22 g ae/ha or greater, 23 g ae/ha or greater, 24 g ae/ha or greater, 25 g ae/ha or greater, 26 g ae/ha or greater, 27 g ae/ha or greater, 28 g ae/ha or greater, 29 g ae/ha or greater, 30 g ae/ha or greater, 31 g ae/ha or greater, 32 g ae/ha or greater, 33 g ae/ha or greater, 34 g ae/ha or greater, 35 g ae/ha or greater, 36 g ae/ha or greater, 37 g ae/ha or greater, 38 g ae/ha or greater, 39 g ae/ha or greater, 40 g ae/ha or greater, 41 g ae/ha or greater, 42 g ae/ha or greater, 43 g ae/ha or greater, 44 g ae/ha or greater, 45 g ae/ha or greater, 46 g ae/ha or greater, 47 g ae/ha or greater, 48 g ae/ha or greater, 49 g ae/ha or greater, 50 g ae/ha or greater, 55 g ae/ha or greater, 60 g ae/ha or greater, 65 g ae/ha or greater, 70 g ae/ha or greater, 75 g ae/ha or greater, 80 g ae/ha or greater, 85 g ae/ha or greater, 90 g ae/ha or greater, 95 g ae/ha or greater, 100 g ae/ha or greater, 110 g ae/ha or greater, 120 g ae/ha or greater, 130 g ae/ha or greater, 140 g ae/ha or greater, 150 g ae/ha or greater, 160 g ae/ha or greater, 170 g ae/ha or greater, 180 g ae/ha or greater, 190 g ae/ha or greater, 200 g ae/ha or greater, 210 g ae/ha or greater, 220 g ae/ha or greater, 230 g ae/ha or greater, 240 g ae/ha or greater, 250 g ae/ha or greater, 260 g ae/ha or greater, 270 g ae/ha or greater, 280 g ae/ha or greater, or 290 g ae/ha or greater).

In some embodiments, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of 300 g ae/ha or less (e.g., 290 g ae/ha or less, 280 g ae/ha or less, 270 g ae/ha or less, 260 g ae/ha or less, 250 g ae/ha or less, 240 g ae/ha or less, 230 g ae/ha or less, 220 g ae/ha or less, 210 g ae/ha or less, 200 g ae/ha or less, 190 g ae/ha or less, 180 g ae/ha or less, 170 g ae/ha or less, 160 g ae/ha or less, 150 g ae/ha or less, 140 g ae/ha or less, 130 g ae/ha or less, 120 g ae/ha or less, 110 g ae/ha or less, 100 g ae/ha or less, 95 g ae/ha or less, 90 g ae/ha or less, 85 g ae/ha or less, 80 g ae/ha or less, 75 g ae/ha or less, 70 g ae/ha or less, 65 g ae/ha or less, 60 g ae/ha or less, 55 g ae/ha or less, 50 g ae/ha or less, 49 g ae/ha or less, 48 g ae/ha or less, 47 g ae/ha or less, 46 g ae/ha or less, 45 g ae/ha or less, 44 g ae/ha or less, 43 g ae/ha or less, 42 g ae/ha or less, 41 g ae/ha or less, 40 g ae/ha or less, 39 g ae/ha or less, 38 g ae/ha or less, 37 g ae/ha or less, 36 g ae/ha or less, 35 g ae/ha or less, 34 g ae/ha or less, 33 g ae/ha or less, 32 g ae/ha or less, 31 g ae/ha or less, 30 g ae/ha or less, 29 g ae/ha or less, 28 g ae/ha or less, 27 g ae/ha or less, 26 g ae/ha or less, 25 g ae/ha or less, 24 g ae/ha or less, 23 g ae/ha or less, 22 g ae/ha or less, 21 g ae/ha or less, 20 g ae/ha or less, 19 g ae/ha or less, 18 g ae/ha or less, 17 g ae/ha or less, 16 g ae/ha or less, 15 g ae/ha or less, 14 g ae/ha or less, 13 g ae/ha or less, 12 g ae/ha or less, 11 g ae/ha or less, 10 g ae/ha or less, 9 g ae/ha or less, 8 g ae/ha or less, 7 g ae/ha or less, 6 g ae/ha or less, 5 g ae/ha or less, 4 g ae/ha or less, 3 g ae/ha or less, 2.75 g ae/ha or less, 2.5 g ae/ha or less, 2.25 g ae/ha or less, 2 g ae/ha or less, 1.9 g ae/ha or less, 1.8 g ae/ha or less, 1.7 g ae/ha or less, 1.6 g ae/ha or less, 1.5 g ae/ha or less, 1.4 g ae/ha or less, 1.3 g ae/ha or less, 1.2 g ae/ha or less, 1.1 g ae/ha or less, 1 g ae/ha or less, 0.9 g ae/ha or less, 0.8 g ae/ha or less, 0.7 g ae/ha or less, or 0.6 g ae/ha or less).

The pyridine carboxylic acid herbicide or an agriculturally acceptable N-oxide, salt, or ester thereof can be applied to vegetation or an area adjacent the vegetation or applied to soil or water to prevent the emergence or growth of vegetation in an amount ranging from any of the minimum values described above to any of the maximum values described above. In some embodiments, the pyridine carboxylic acid herbicide, or an agriculturally acceptable N-oxide, salt, or ester thereof, is applied to vegetation or an area adjacent the vegetation or applied to soil or water to prevent the emergence or growth of vegetation in an amount of from 0.5-300 g ae/ha (e.g., from 0.5-5 g ae/ha, from 2.5-40 g ae/ha, from 0.5-40 g ae/ha, from 0.5-2.5 g ae/ha, from 2-150 g ae/ha, from 5-75 g ae/ha, from 5-40 g ae/ha, from 30-40 g ae/ha, or from 5-15 g ae/ha). In some embodiments, the pyridine carboxylic acid herbicide, or an agriculturally acceptable N-oxide, salt, or ester thereof, is applied in an amount from 30-40 g ae/ha. In some embodiments, the pyridine carboxylic acid herbicide, or an agriculturally acceptable N-oxide, salt, or ester thereof, is applied in an amount from 5-40 g ae/ha.

HPPD Inhibitors

In addition to the pyridine carboxylic acid herbicide or agriculturally acceptable N-oxide, salt or ester thereof, the compositions can include an inhibitor of 4-hydroxyphenylpyruvate dioxygenase (HPPD), an oxygenase enzyme involved in the creation of energy in plants and higher order eukaryotes. Examples of HPPD inhibitors include benzobicyclon, benzofenap, bicyclopyrone, fenquinotrione, isoxachlortole, isoxaflutole, mesotrione, pyrasulfotole, pyrazolynate, pyrazoxyfen, sulcotrione, tembotrione, tefuryltrione, topramezone, or an agriculturally acceptable salt thereof, and combinations thereof.

The HPPD inhibitor or agriculturally acceptable salt thereof can be applied to vegetation or an area adjacent to the vegetation or applied to soil or water to prevent the emergence or growth of vegetation in an amount sufficient to induce a herbicidal effect. In some embodiments, the HPPD inhibitor or agriculturally acceptable salt thereof is applied to vegetation or an area adjacent the vegetation or applied to soil or water to prevent the emergence or growth of vegetation in an amount of 1 grams active ingredient per hectare (g ai/ha) or more (e.g., 2 g ai/ha or more, 4 g ai/ha or more, 6 g ai/ha or more, 8 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 210 g ai/ha or more, 220 g ai/ha or more, 230 g ai/ha or more, 240 g ai/ha or more, 250 g ai/ha or more, 260 g ai/ha or more, 270 g ai/ha or more, 280 g ai/ha or more, 290 g ai/ha or more, 300 g ai/ha or more, 310 g ai/ha or more, 320 g ai/ha or more, 330 g ai/ha or more, 340 g ai/ha or more, 350 g ai/ha or more, 360 g ai/ha or more, 370 g ai/ha or more, 380 g ai/ha or more, 390 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, 600 g ai/ha or more, 625 g ai/ha or more, 650 g ai/ha or more, 675 g ai/ha or more, 700 g ai/ha or more, 725 g ai/ha or more, 750 g ai/ha or more, 775 g ai/ha or more, 800 g ai/ha or more, 825 g ai/ha or more, 850 g ai/ha or more, 875 g ai/ha or more, 900 g ai/ha or more, 925 g ai/ha or more, 950 g ai/ha or more, 975 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1550 g ai/ha or more, 1600 g ai/ha or more, 1650 g ai/ha or more, 1660 g ai/ha or more, 1670 g ai/ha or more, 1680 g ai/ha or more, 1690 g ai/ha or more, 1700 g ai/ha or more, 1750 g ai/ha or more, 1800 g ai/ha or more, 1850 g ai/ha or more, 1900 g ai/ha or more, 1950 g ai/ha or more, 2000 g ai/ha or more, 2500 g ai/ha or more, 3000 g ai/ha or more, 3500 g ai/ha or more, 4000 g ai/ha or more, or 4500 g ai/ha or more).

In some embodiments, the HPPD inhibitor or agriculturally acceptable salt or ester thereof is applied to vegetation or an area adjacent the vegetation or applied to soil or water to prevent the emergence or growth of vegetation in an amount of 4500 g ai/ha or less (e.g., 4000 g ai/ha or less, 3500 g ai/ha or less, 3000 g ai/ha or less, 2500 g ai/ha or less, 2000 g ai/ha or less, 1950 g ai/ha or less, 1900 g ai/ha or less, 1850 g ai/ha or less, 1800 g ai/ha or less, 1750 g ai/ha or less, 1700 g ai/ha or less, 1690 g ai/ha or less, 1680 g ai/ha or less, 1670 g ai/ha or less, 1660 g ai/ha or less, 1650 g ai/ha or less, 1600 g ai/ha or less, 1550 g ai/ha or less, 1500 g ai/ha or less, 1450 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 975 g ai/ha or less, 950 g ai/ha or less, 925 g ai/ha or less, 900 g ai/ha or less, 875 g ai/ha or less, 850 g ai/ha or less, 825 g ai/ha or less, 800 g ai/ha or less, 775 g ai/ha or less, 750 g ai/ha or less, 725 g ai/ha or less, 700 g ai/ha or less, 675 g ai/ha or less, 650 g ai/ha or less, 625 g ai/ha or less, 600 g ai/ha or less, 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 390 g ai/ha or less, 380 g ai/ha or less, 370 g ai/ha or less, 360 g ai/ha or less, 350 g ai/ha or less, 340 g ai/ha or less, 330 g ai/ha or less, 320 g ai/ha or less, 310 g ai/ha or less, 300 g ai/ha or less, 290 g ai/ha or less, 280 g ai/ha or less, 270 g ai/ha or less, 260 g ai/ha or less, 250 g ai/ha or less, 240 g ai/ha or less, 230 g ai/ha or less, 220 g ai/ha or less, 210 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3 g ai/ha or less, 2.5 g ai/ha or less, 2 g ai/ha or less, 1.5 g ai/ha or less, or 1 g ai/ha or less).

The HPPD inhibitor or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the HPPD inhibitor or agriculturally acceptable salt or ester thereof is applied to vegetation or an area adjacent the vegetation or applied to soil or water to prevent the emergence or growth of vegetation in an amount of 1-4500 g ai/ha (e.g., 1-4000 g ai/ha, 1-3000 g ai/ha, 1-2000 g ai/ha, 1-1000 g ai/ha, 1-500 g ai/ha, 1-250 g ai/ha, 1-200 g ai/ha, 1-100 g ai/ha, 1-50 g ai/ha, 5-45 g ai/ha, 10-40 g ai/ha, 15-35 g ai/ha, 25-1000 g ai/ha, 25-500 g ai/ha, 25-400 g ai/ha, 25-300 g ai/ha, 25-200 g ai/ha, 50-200 g ai/ha, 50-250 g ai/ha, 50-300 g ai/ha, 50-350 g ai/ha, 70-250 g ai/ha, 70-230 g ai/ha, 70-210 g ai/ha, 70-190 g ai/ha, 70-170 g ai/ha, 70-150 g ai/ha, 70-130 g ai/ha, 70-110 g ai/ha, 100-150 g ai/ha, 100-170 g ai/ha, 100-190 g ai/ha, 150-250 g ai/ha, 175-300 g ai/ha, 200-300 g ai/ha, 200-350 g ai/ha, 200-400 g ai/ha, 200-450 g ai/ha, 200-500 g ai/ha, 300-500 g ai/ha, 300-600 g ai/ha, 350-700 g ai/ha, 400-800 g ai/ha, 450-900 g ai/ha, 500-900 g ai/ha, 550-900 g ai/ha, 600-900 g ai/ha, or 650-1000 g ai/ha).

In certain embodiments, the herbicidal composition contains a herbicidally effective amount of (a) a pyridine carboxylic acid herbicide or an agriculturally acceptable N-oxide, salt, or ester thereof, and (b) benzobicyclon, benzofenap, bicyclopyrone, fenquinotrione, isoxachlortole, isoxaflutole, mesotrione, pyrasulfotole, pyrazolynate, pyrazoxyfen, sulcotrione, tembotrione, tefuryltrione, topramezone, or agriculturally acceptable salts, or combinations thereof

Benzobicyclon

Compositions and methods of the present disclosure can include benzobicyclon or an agriculturally acceptable salt thereof. Benzobicyclon, shown below, is 3-[2-chloro-4-(methylsulfonyl)benzoyl]-4-(phenylthio)bicyclo[3.2.1]oct-3-en-2-one. Its herbicidal activity is exemplified in Tomlin, C. D. S., Ed. The Pesticide Manual: A World Compendium, 15^{th} ed.; BCPC: Alton, 2009 (hereafter “The Pesticide Manual, Fifteenth Edition, 2009”). Exemplary uses of benzobicyclon include its use for control of annual and perennial paddy weeds in direct-seeded and transplanted rice, applied early pre- to early post-emergence, at 0.2-0.3 kilograms per hectare (kg/ha).

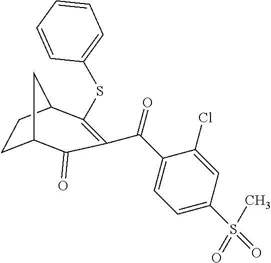 [SMILES: CS(=O)(=O)c1ccc(C(=O)C2=C(Sc3ccccc3)C3CCC(C3)C2=O)c(Cl)c1]

The benzobicyclon can be applied to vegetation or an area adjacent to the vegetation or applied to soil or water to prevent the emergence or growth of vegetation in an amount sufficient to induce a herbicidal effect. In some embodiments, the benzobicyclon is applied to vegetation or an area adjacent to the vegetation or applied to soil or water to prevent the emergence or growth of vegetation in an amount of 50 g ai/ha or more (e.g., 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, 300 g ai/ha or more, 320 g ai/ha or more, 340 g ai/ha or more, 360 g ai/ha or more, 380 g ai/ha or more, or 400 g ai/ha or more).

In some embodiments, the benzobicyclon or agriculturally acceptable salt thereof is applied to vegetation or an area adjacent the vegetation or applied to soil or water to prevent the emergence or growth of vegetation in an amount of 401 g ai/ha or less (e.g., 400 g ai/ha or less, 380 g ai/ha or less, 360 g ai/ha or less, 340 g ai/ha or less, 320 g ai/ha or less, 300 g ai/ha or less, 280 g ai/ha or less, 260 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, or 50 g ai/ha or less).

The benzobicyclon can be applied to vegetation or an area adjacent to the vegetation or applied to soil or water to prevent the emergence or growth of vegetation in an amount ranging from any of the minimum values described above to any of the maximum values described above. In some embodiments, the benzobicyclon is applied to vegetation or an area adjacent to the vegetation or applied to soil or water to prevent the emergence or growth of vegetation in an amount of 50-400 g ai/ha (e.g., 75-400 g ai/ha, 100-400 g ai/ha, 150-400 g ai/ha, 175-400 g ai/ha, 175-350 g ai/ha, 175-325 g ai/ha, 175-300 g ai/ha, or 200-300 g ai/ha).

Benzofenap

Compositions and methods of the present disclosure can include benzofenap or an agriculturally acceptable salt thereof. Benzofenap, as well as methods of preparing benzofenap, are known in the art. Benzofenap, shown below, is 2-[[4-(2,4-dichloro-3-methylbenzoyl)-1,3-dimethyl-1H-pyrazol-5-yl]oxy]-1-(4-methylphenyl)ethanone. Its herbicidal activity is exemplified in Tomlin, C. D. S., Ed. The Pesticide Manual: A World Compendium, 15^{th} ed.; BCPC: Alton, 2009 (hereafter “The Pesticide Manual, Fifteenth Edition, 2009”). Exemplary uses of benzofenap include its use for control of broadleaf weeds in rice, applied at 0.6-0.9 kg/ha.

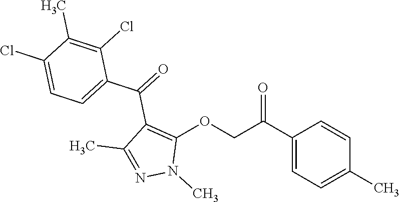 [SMILES: Cc1ccc(C(=O)COc2c(C(=O)c3ccc(Cl)c(C)c3Cl)c(C)nn2C)cc1]

The benzofenap or agriculturally acceptable salt thereof can be applied to vegetation or an area adjacent the vegetation or applied to soil or water to prevent the emergence or growth of vegetation in an amount sufficient to induce a herbicidal effect. In some embodiments, the benzofenap or an agriculturally acceptable salt thereof is applied to vegetation or an area adjacent the vegetation or applied to soil or water to prevent the emergence or growth of vegetation in an amount of of 299 g ai/ha or more (e.g., 300 g ai/ha or more, 320 g ai/ha or more, 340 g ai/ha or more, 360 g ai/ha or more, 380 g ai/ha or more, 400 g ai/ha or more, 450 g ai/ha or more, 500 g ai/ha or more, 550 g ai/ha or more, 600 g ai/ha or more, 625 g ai/ha or more, 650 g ai/ha or more, 675 g ai/ha or more, 700 g ai/ha or more, 725 g ai/ha or more, 750 g ai/ha or more, 775 g ai/ha or more, 800 g ai/ha or more, 825 g ai/ha or more, 850 g ai/ha or more, 875 g ai/ha or more, 900 g ai/ha or more, 925 g ai/ha or more, 950 g ai/ha or more, 975 g ai/ha or more, or 1000 g ai/ha or more).

In some embodiments, the benzofenap is applied to vegetation or an area adjacent the vegetation or applied to soil or water to prevent the emergence or growth of vegetation in an amount of of 1001 g ai/ha or less (e.g., 1000 g ai/ha or less, 975 g ai/ha or less, 950 g ai/ha or less, 925 g ai/ha or less, 900 g ai/ha or less, 875 g ai/ha or less, 850 g ai/ha or less, 825 g ai/ha or less, 800 g ai/ha or less, 775 g ai/ha or less, 750 g ai/ha or less, 725 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 475 g ai/ha or less, 450 g ai/ha or less, 425 g ai/ha or less, 400 g ai/ha or less, 380 g ai/ha or less, 360 g ai/ha or less, 340 g ai/ha or less, 320 g ai/ha or less, or 300 g ai/ha or less).

The benzofenap or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the benzofenap or an agriculturally acceptable salt thereof is applied to vegetation or an area adjacent the vegetation or applied to soil or water to prevent the emergence or growth of vegetation in an amount of 300-1000 g ai/ha (e.g., 350-1000 g ai/ha, 400-1000 g ai/ha, 450-1000 g ai/ha, 500-1000 g ai/ha, 550-1000 g ai/ha, 600-1000 g ai/ha, 600-950 g ai/ha, 600-900 g ai/ha, 650-1000 g ai/ha, 700-1000 g ai/ha, 750-1000 g ai/ha, 800-1000 g ai/ha, 800-950 g ai/ha, or 800-900 g ai/ha).

Bicyclopyrone

Compositions and methods of the present disclosure can include bicyclopyrone or an agriculturally acceptable salt thereof. Bicyclopyrone, shown below, is 4-hydroxy-3-[[2-[(2-methoxyethoxy)methyl]-6-(trifluoromethyl)-3-pyridinyl]carbonyl]bicyclo[3.2.1]oct-3-en-2-one. According to the online edition of The Pesticide Manual, bicyclopyrone is a herbicide for use in pre- and early post emergence applications in maize (ca. 50-200 g/ha) to control broad-leaved weeds such as Amaranthus palmeri (palmer amaranth), Ambrosia artemisiifolia (common ragweed), Ambrosia trifida (giant ragweed), Chenopodium album (common lambsquarters), Raphanus raphanistrum (wild radish), Stellaria media (common chickweed), Xanthium strumarium (common cocklebur) and grasses such as Eriochloa villosa (woolly cupgrass). It is under development for post-emergence use (37.5-50 g/ha) in cereals and pre- and early post-emergence use (up to 300 g/ha) in sugar cane.

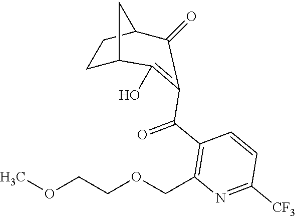 [SMILES: COCCOCc1nc(C(F)(F)F)ccc1C(=O)C1=C(O)C2CCC(C2)C1=O]

The bicyclopyrone or agriculturally acceptable salt thereof can be applied to vegetation or an area adjacent the vegetation or applied to soil or water to prevent the emergence or growth of vegetation in an amount sufficient to induce a herbicidal effect. In some embodiments, the bicyclopyrone or agriculturally acceptable salt thereof is applied to vegetation or an area adjacent the vegetation or applied to soil or water to prevent the emergence or growth of vegetation in an amount of 20 g ai/ha or more (e.g., 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, 300 g ai/ha or more, 320 g ai/ha or more, 340 g ai/ha or more, 360 g ai/ha or more, 380 g ai/ha or more, or 400 g ai/ha).

In some embodiments, the bicyclopyrone or agriculturally acceptable salt thereof is applied to vegetation or an area adjacent the vegetation or applied to soil or water to prevent the emergence or growth of vegetation in an amount of 401 g ai/ha or less (e.g., 400 g ai/ha or less, 380 g ai/ha or less, 360 g ai/ha or less, 340 g ai/ha or less, 320 g ai/ha or less, 300 g ai/ha or less, 280 g ai/ha or less, 260 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, or 20 g ai/ha or less).

The bicyclopyrone or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the bicyclopyrone or agriculturally acceptable salt thereof is applied to vegetation or an area adjacent the vegetation or applied to soil or water to prevent the emergence or growth of vegetation in an amount of 20-400 g ai/ha (e.g., 30-400 g ai/ha, 40-400 g ai/ha, 50-400 g ai/ha, 50-350 g ai/ha, 50-300 g ai/ha, 75-300 g ai/ha, 100-300 g ai/ha, 200-300 g ai/ha, 50-200 g ai/ha, 30-100 g ai/ha, 30-75 g ai/ha, 30-65 g ai/ha, or 30-55 g ai/ha).

Fenquinotrione

Fenquinotrione, shown below, is 2-[[8-chloro-3,4-dihydro-4-(4-methoxyphenyl)-3-oxo-2-quinoxalinyl]carbonyl]-1,3-cyclohexanedione. According to the online edition of The Pesticide Manual, fenquinotrione is a herbicide under development for use on rice (Kumiai).

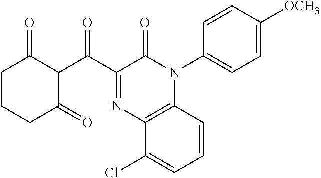 [SMILES: COc1ccc(-n2c(=O)c(C(=O)C3C(=O)CCCC3=O)nc3c(Cl)cccc32)cc1]

Isoxachlortole

Isoxachlortole, shown below, is [4-chloro-2-(methylsulfonyl)phenyl](5-cyclopropyl-4-isoxazolyl)methanone. According to the online edition of The Pesticide Manual, isoxachlortole is a herbicide that was evaluated by Rhône-Poulenc.

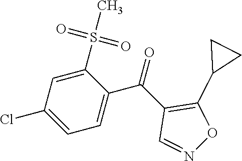 [SMILES: CS(=O)(=O)c1cc(Cl)ccc1C(=O)c1cnoc1C1CC1]

Isoxaflutole

Isoxaflutole, shown below, is (5-cyclopropyl-4-isoxazolyl)[2-(methylsulfonyl)-4-(trifluoromethyl)phenyl]methanone. Its herbicidal activity is exemplified in The Pesticide Manual. Exemplary uses of isoxaflutole include its use as a broad-spectrum grass and broadleaf weed control in maize and sugar cane, applied at 75-140 g/ha pre-emergence or pre-plant; the spectrum can be enhanced by mixture with other active ingredients.

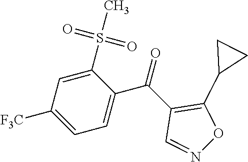 [SMILES: CS(=O)(=O)c1cc(C(F)(F)F)ccc1C(=O)c1cnoc1C1CC1]

In some embodiments, isoxaflutole can be provided as an agriculturally acceptable salt of isoxaflutole.

The isoxaflutole or agriculturally acceptable salt thereof can be applied to vegetation or an area adjacent the vegetation or applied to soil or water to prevent the emergence or growth of vegetation in an amount sufficient to induce a herbicidal effect. In some embodiments, the isoxaflutole or agriculturally acceptable salt thereof is applied to vegetation or an area adjacent the vegetation or applied to soil or water to prevent the emergence or growth of vegetation in an amount of 20 g ai/ha or more (e.g., 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, or 300 g ai/ha or more).

In some embodiments, the isoxaflutole or agriculturally acceptable salt thereof is applied to vegetation or an area adjacent the vegetation or applied to soil or water to prevent the emergence or growth of vegetation in an amount of 301 g ai/ha or less (e.g., 300 g ai/ha or less, 280 g ai/ha or less, 260 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, or 25 g ai/ha or less).

The isoxaflutole or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the isoxaflutole or agriculturally acceptable salt thereof is applied to vegetation or an area adjacent the vegetation or applied to soil or water to prevent the emergence or growth of vegetation in an amount of 25-300 g ai/ha (e.g., 30-300 g ai/ha, 40-300 g ai/ha, 50-300 g ai/ha, 60-300 g ai/ha, 70-300 g ai/ha, 70-275 g ai/ha, 75-250 g ai/ha, 75-225 g ai/ha, 75-200 g ai/ha, 75-175 g ai/ha, 75-150 g ai/ha, 75-125 g ai/ha, 75-100 g ai/ha, 100-300 g ai/ha, 150-300 g ai/ha, 200-300 g ai/ha, 50-200 g ai/ha, 25-100 g ai/ha, 25-75 g ai/ha, or 25-50 g ai/ha).

Mesotrione

Mesotrione, shown below, is 2-[4-(methylsulfonyl)-2-nitrobenzoyl]-1,3-cyclohexanedione. Its herbicidal activity is exemplified in The Pesticide Manual. Exemplary uses of mesotrione include its use pre-emergence (at 100-225 g/ha) and post-emergence (at 70-150 g/ha) to control of broadleaf weeds, such as Xanthium strumarium, Ambrosia trifida, Abutilon theophrasti, and Chenopodium, Amaranthus and Polygonum spp., and some grass weeds in maize.

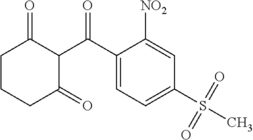 [SMILES: CS(=O)(=O)c1ccc(C(=O)C2C(=O)CCCC2=O)c([N+](=O)[O-])c1]

In some embodiments, mesotrione can be provided as an agriculturally acceptable salt of mesotrione.

The mesotrione or agriculturally acceptable salt thereof can be applied to vegetation or an area adjacent the vegetation or applied to soil or water to prevent the emergence or growth of vegetation in an amount sufficient to induce a herbicidal effect. In some embodiments, the mesotrione or agriculturally acceptable salt thereof is applied to vegetation or an area adjacent the vegetation or applied to soil or water to prevent the emergence or growth of vegetation in an amount of 20 g ai/ha or more (e.g., 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, or 300 g ai/ha or more).

In some embodiments, the mesotrione or agriculturally acceptable salt thereof is applied to vegetation or an area adjacent the vegetation or applied to soil or water to prevent the emergence or growth of vegetation in an amount of 301 g ai/ha or less (e.g., 300 g ai/ha or less, 280 g ai/ha or less, 260 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, or 25 g ai/ha or less).

The mesotrione or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the mesotrione or agriculturally acceptable salt thereof is applied to vegetation or an area adjacent the vegetation or applied to soil or water to prevent the emergence or growth of vegetation in an amount of 25-300 g ai/ha (e.g., 30-300 g ai/ha, 40-300 g ai/ha, 50-300 g ai/ha, 60-300 g ai/ha, 70-300 g ai/ha, 70-275 g ai/ha, 70-250 g ai/ha, 70-225 g ai/ha, 70-200 g ai/ha, 70-175 g ai/ha, 70-150 g ai/ha, 70-125 g ai/ha, 70-100 g ai/ha, 80-300 g ai/ha, 80-275 g ai/ha, 90-250 g ai/ha, 100-225 g ai/ha, 110-200 g ai/ha, 120-175 g ai/ha, 130-150 g ai/ha, 25-75 g ai/ha, or 25-50 g ai/ha).

Pyrasulfotole

Pyrasulfotole, shown below, is (5-hydroxy-1,3-dimethyl-1H-pyrazol-4-yl)[2-(methylsulfonyl)-4-(trifluoromethyl)phenyl]methanone. Its herbicidal activity is exemplified in The Pesticide Manual. Exemplary uses of pyrasulfotole include its use in mixtures with mefenpyr-diethyl and bromoxynil, bromoxynil and thiencarbazone-methyl, bromoxynil and fenoxaprop-p-ethyl or MCPA ester, for post-emergence control of broadleaf weeds in cereals, applied at a rate of 31-50 g/ha.

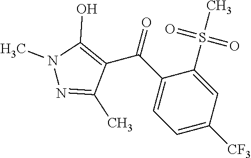 [SMILES: Cc1nn(C)c(O)c1C(=O)c1ccc(C(F)(F)F)cc1S(C)(=O)=O]

In some embodiments, pyrasulfotole can be provided as an agriculturally acceptable salt of pyrasulfotole.

The pyrasulfotole or agriculturally acceptable salt thereof can be applied to vegetation or an area adjacent the vegetation or applied to soil or water to prevent the emergence or growth of vegetation in an amount sufficient to induce a herbicidal effect. In some embodiments, the pyrasulfotole or agriculturally acceptable salt thereof is applied to vegetation or an area adjacent the vegetation or applied to soil or water to prevent the emergence or growth of vegetation in an amount of 1.9 g ai/ha or more (e.g., 2.5 g ai/ha or more, 3 g ai/ha or more, 3.25 g ai/ha or more, 3.5 g ai/ha or more, 3.75 g ai/ha or more, 4 g ai/ha or more, 4.5 g ai/ha or more, 5 g ai/ha or more, 6 g ai/ha or more, 7 g ai/ha or more, 8 g ai/ha or more, 9 g ai/ha or more, 9.5 g ai/ha or more, 10 g ai/ha or more, 10.5 g ai/ha or more, 11 g ai/ha or more, 11.5 g ai/ha or more, 12 g ai/ha or more, 12.5 g ai/ha or more, 13 g ai/ha or more, 13.5 g ai/ha or more, 14 g ai/ha or more, 14.5 g ai/ha or more, 15 g ai/ha or more, 15.25 g ai/ha or more, 15.5 g ai/ha or more, 15.75 g ai/ha or more, 16 g ai/ha or more, 16.25 g ai/ha or more, 16.5 g ai/ha or more, 16.75 g ai/ha or more, 17 g ai/ha or more, 17.25 g ai/ha or more, 17.5 g ai/ha or more, 17.75 g ai/ha or more, 18 g ai/ha or more, 18.25 g ai/ha or more, 18.5 g ai/ha or more, 19.5 g ai/ha or more, 20 g ai/ha or more, 22 g ai/ha or more, 24 g ai/ha or more, 26 g ai/ha or more, 28 g ai/ha or more, 30 g ai/ha or more, 33 g ai/ha or more, 36 g ai/ha or more, 39 g ai/ha or more, 42 g ai/ha or more, 45 g ai/ha or more, or 50 g ai/ha or more).

In some embodiments, the pyrasulfotole or agriculturally acceptable salt thereof is applied to vegetation or an area adjacent the vegetation or applied to soil or water to prevent the emergence or growth of vegetation in an amount of 51 g ai/ha or less (e.g., 50 g ai/ha or less, 45 g ai/ha or less, 42 g ai/ha or less, 40 g ai/ha or less, 38 g ai/ha or less, 35 g ai/ha or less, 32 g ai/ha or less, 30 g ai/ha or less, 28 g ai/ha or less, 26 g ai/ha or less, 24 g ai/ha or less, 22 g ai/ha or less, 20 g ai/ha or less, 19 g ai/ha or less, 18.5 g ai/ha or less, 18.25 g ai/ha or less, 18 g ai/ha or less, 17.75 g ai/ha or less, 17.5 g ai/ha or less, 17.25 g ai/ha or less, 17 g ai/ha or less, 16.75 g ai/ha or less, 16.5 g ai/ha or less, 16.25 g ai/ha or less, 16 g ai/ha or less, 15.75 g ai/ha or less, 15.5 g ai/ha or less, 15.25 g ai/ha or less, 15 g ai/ha or less, 14.5 g ai/ha or less, 14 g ai/ha or less, 13.5 g ai/ha or less, 13 g ai/ha or less, 12.5 g ai/ha or less, 12 g ai/ha or less, 11.5 g ai/ha or less, 11 g ai/ha or less, 10.5 g ai/ha or less, 10 g ai/ha or less, 9.5 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3.25 g ai/ha or less, 3 g ai/ha or less, or 2.5 g ai/ha or less).

The pyrasulfotole or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the pyrasulfotole or agriculturally acceptable salt thereof is applied to vegetation or an area adjacent the vegetation or applied to soil or water to prevent the emergence or growth of vegetation in an amount of 1.9-51 g ai/ha (e.g., 1.9-45 g ai/ha, 1.9-40 g ai/ha, 1.9-35 g ai/ha, 1.9-30 g ai/ha, 1.9-25 g ai/ha, 1.9-20 g ai/ha, 1.9-18.75 g ai/ha 2.5-18 g ai/ha, 2.5-17 g ai/ha, 2.75-16 g ai/ha, 2.75-18.75 g ai/ha, 3-18 g ai/ha, 3.25-17 g ai/ha, 3.25-16 g ai/ha, 3.5-18.75 g ai/ha, 3.5-18 g ai/ha, 3.5-17 g ai/ha, 3.5-16 g ai/ha, 3.5-15 g ai/ha, 3.5-14 g ai/ha, 20-51 g ai/ha, 25-51 g ai/ha, 30-51 g ai/ha, 35-51 g ai/ha, 40-51 g ai/ha, or 45-51 g ai/ha).

In some aspects, composition may include an HPPD inhibitor and a third herbicide. For example, in various aspects, compositions may include the compound defined by Formula (I), an HPPD inhibitor, and a third herbicide (e.g., bromoxynil). Thus, in some aspects, compositions may include the compound of Formula (I), pyransulfotole, and bromonxynil. In some aspects, the ratio of bromoxynil and pyransulfotole may be between about 10:1 to about 1:10, between about 7:1 to about 1:1, or between about 6:1 to about 5:1.

Pyrazolynate

Pyrazolynate, shown below, is (2,4-dichlorophenyl)[1,3-dimethyl-5-[[(4-methylphenyl)sulfonyl]oxy]-1H-pyrazol-4-yl]methanone. Its herbicidal activity is exemplified in The Pesticide Manual. Exemplary uses of pyrazolynate include its use to control grasses, sedges, Potamogeton distinctus, Sagittaria pygmaea, Sagittaria trifolia and Alisma canaliculatum in paddy rice, at 3-4 kg/ha.

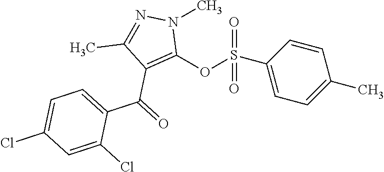 [SMILES: Cc1ccc(S(=O)(=O)Oc2c(C(=O)c3ccc(Cl)cc3Cl)c(C)nn2C)cc1]

The pyrazolynate can be applied to vegetation or an area adjacent the vegetation or applied to soil or water to prevent the emergence or growth of vegetation in an amount sufficient to induce a herbicidal effect. In some embodiments, the pyrazolynate is applied to vegetation or an area adjacent the vegetation or applied to soil or water to prevent the emergence or growth of vegetation in an amount of 200 g ai/ha or more (e.g., 300 g ai/ha or more, 400 g ai/ha or more, 500 g ai/ha or more, 600 g ai/ha or more, 700 g ai/ha or more, 800 g ai/ha or more, 900 g ai/ha or more, 1000 g ai/ha or more, 1200 g ai/ha or more, 1400 g ai/ha or more, 1600 g ai/ha or more, 1800 g ai/ha or more, 2000 g ai/ha or more, 2200 g ai/ha or more, 2400 g ai/ha or more, 2600 g ai/ha or more, 2800 g ai/ha or more, 3000 g ai/ha or more, 3200 g ai/ha or more, 3400 g ai/ha or more, 3600 g ai/ha or more, 3800 g ai/ha or more, 4000 g ai/ha or more, 4200 g ai/ha or more, or 4400 g ai/ha or more).

In some embodiments, the pyrazolynate is applied to vegetation or an area adjacent the vegetation or applied to soil or water to prevent the emergence or growth of vegetation in an amount of 4500 g ai/ha or less (e.g., 4400 g ai/ha or less, 4200 g ai/ha or less, 4000 g ai/ha or less, 3800 g ai/ha or less, 3600 g ai/ha or less, 3400 g ai/ha or less, 3200 g ai/ha or less, 3000 g ai/ha or less, 2800 g ai/ha or less, 2600 g ai/ha or less, 2400 g ai/ha or less, 2200 g ai/ha or less, 2000 g ai/ha or less, 1800 g ai/ha or less, 1600 g ai/ha or less, 1400 g ai/ha or less, 1200 g ai/ha or less, 1000 g ai/ha or less, 900 g ai/ha or less, 800 g ai/ha or less, 700 g ai/ha or less, 600 g ai/ha or less, 500 g ai/ha or less, 400 g ai/ha or less, 300 g ai/ha or less, or 200 g ai/ha or less).

The pyrazolynate can be applied to vegetation or an area adjacent the vegetation or applied to soil or water to prevent the emergence or growth of vegetation in an amount ranging from any of the minimum values described above to any of the maximum values described above. In some embodiments, the pyrazolynate is applied to vegetation or an area adjacent the vegetation or applied to soil or water to prevent the emergence or growth of vegetation in an amount of 200-4500 g ai/ha (e.g., 200-400 g ai/ha, 400-600 g ai/ha, 600-800 g ai/ha, 800-1000 g ai/ha, 1000-1500 g ai/ha, 1500-2000 g ai/ha, 2000-2500 g ai/ha, 2500-3000 g ai/ha, 3000-3500 g ai/ha, 3500-4000 g ai/ha, or 4000-4500 g ai/ha).

Pyrazoxyfen

Pyrazoxyfen, shown below, is 2-[[4-(2,4-dichlorobenzoyl)-1,3-dimethyl-1H-pyrazol-5-yl]oxy]-1-phenylethanone. Its herbicidal activity is exemplified in The Pesticide Manual. Exemplary uses of pyrazoxyfen include its use pre- or post-weed emergence, at 3 kg/ha, in transplanted paddy rice, to control annual and perennial weeds.

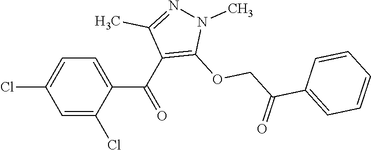 [SMILES: Cc1nn(C)c(OCC(=O)c2ccccc2)c1C(=O)c1ccc(Cl)cc1Cl]

The pyrazoxyfen can be applied to vegetation or an area adjacent the vegetation or applied to soil or water to prevent the emergence or growth of vegetation in an amount sufficient to induce a herbicidal effect. In some embodiments, the pyrazoxyfen is applied to vegetation or an area adjacent the vegetation or applied to soil or water to prevent the emergence or growth of vegetation in an amount of 200 g ai/ha or more (e.g., 300 g ai/ha or more, 400 g ai/ha or more, 500 g ai/ha or more, 600 g ai/ha or more, 700 g ai/ha or more, 800 g ai/ha or more, 900 g ai/ha or more, 1000 g ai/ha or more, 1200 g ai/ha or more, 1400 g ai/ha or more, 1600 g ai/ha or more, 1800 g ai/ha or more, 2000 g ai/ha or more, 2200 g ai/ha or more, 2400 g ai/ha or more, 2600 g ai/ha or more, 2800 g ai/ha or more, 3000 g ai/ha or more, 3200 g ai/ha or more, or 3400 g ai/ha or more).

In some embodiments, the pyrazoxyfen is applied to vegetation or an area adjacent the vegetation or applied to soil or water to prevent the emergence or growth of vegetation in an amount of 3500 g ai/ha or less (e.g., 3400 g ai/ha or less, 3200 g ai/ha or less, 3000 g ai/ha or less, 2800 g ai/ha or less, 2600 g ai/ha or less, 2400 g ai/ha or less, 2200 g ai/ha or less, 2000 g ai/ha or less, 1800 g ai/ha or less, 1600 g ai/ha or less, 1400 g ai/ha or less, 1200 g ai/ha or less, 1000 g ai/ha or less, 900 g ai/ha or less, 800 g ai/ha or less, 700 g ai/ha or less, 600 g ai/ha or less, 500 g ai/ha or less, 400 g ai/ha or less, 300 g ai/ha or less, or 200 g ai/ha or less).

The pyrazoxyfen can be applied to vegetation or an area adjacent the vegetation or applied to soil or water to prevent the emergence or growth of vegetation in an amount ranging from any of the minimum values described above to any of the maximum values described above. In some embodiments, the pyrazoxyfen is applied to vegetation or an area adjacent the vegetation or applied to soil or water to prevent the emergence or growth of vegetation in an amount of 200-3500 g ai/ha (e.g., 200-400 g ai/ha, 400-600 g ai/ha, 600-800 g ai/ha, 800-1000 g ai/ha, 1000-1500 g ai/ha, 1500-2000 g ai/ha, 2000-2500 g ai/ha, 2500-3000 g ai/ha, or 3000-3500 g ai/ha).

Sulcotrione

Sulcotrione, shown below, is 2-[2-chloro-4-(methylsulfonyl)benzoyl]-1,3-cyclohexanedione. Its herbicidal activity is exemplified in The Pesticide Manual. Exemplary uses of sulcotrione include its use to control broadleaf weeds and grasses post-emergence in maize, at up to 450 g/ha, and in sugar cane, at 200-300 g/ha.

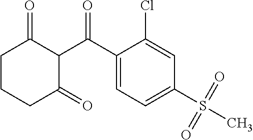 [SMILES: CS(=O)(=O)c1ccc(C(=O)C2C(=O)CCCC2=O)c(Cl)c1]

In some embodiments, sulcotrione can be provided as an agriculturally acceptable salt of sulcotrione.

The sulcotrione or agriculturally acceptable salt thereof can be applied to vegetation or an area adjacent the vegetation or applied to soil or water to prevent the emergence or growth of vegetation in an amount sufficient to induce a herbicidal effect. In some embodiments, the sulcotrione or agriculturally acceptable salt thereof is applied to vegetation or an area adjacent the vegetation or applied to soil or water to prevent the emergence or growth of vegetation in an amount of 50 g ai/ha or more (e.g., 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, 200 g ai/ha or more, 220 g ai/ha or more, 240 g ai/ha or more, 260 g ai/ha or more, 280 g ai/ha or more, 300 g ai/ha or more, 320 g ai/ha or more, 340 g ai/ha or more, 360 g ai/ha or more, 380 g ai/ha or more, 400 g ai/ha or more, 420 g ai/ha or more, 440 g ai/ha or more, 460 g ai/ha or more, 480 g ai/ha or more, 500 g ai/ha or more, 520 g ai/ha or more, 540 g ai/ha or more, 560 g ai/ha or more, 580 g ai/ha or more, or 600 g ai/ha or more).

In some embodiments, the sulcotrione or agriculturally acceptable salt thereof is applied to vegetation or an area adjacent the vegetation or applied to soil or water to prevent the emergence or growth of vegetation in an amount of 600 g ai/ha or less (e.g., 580 g ai/ha or less, 560 g ai/ha or less, 540 g ai/ha or less, 520 g ai/ha or less, 500 g ai/ha or less, 480 g ai/ha or less, 460 g ai/ha or less, 440 g ai/ha or less, 420 g ai/ha or less, 400 g ai/ha or less, 380 g ai/ha or less, 360 g ai/ha or less, 340 g ai/ha or less, 320 g ai/ha or less, 300 g ai/ha or less, 280 g ai/ha or less, 260 g ai/ha or less, 240 g ai/ha or less, 220 g ai/ha or less, 200 g ai/ha or less, 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, or 50 g ai/ha or less).

The sulcotrione or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the sulcotrione or agriculturally acceptable salt thereof is applied to vegetation or an area adjacent the vegetation or applied to soil or water to prevent the emergence or growth of vegetation in an amount of 50-600 g ai/ha (e.g., 100-600 g ai/ha, 150-600 g ai/ha, 200-600 g ai/ha, 300-600 g ai/ha, 400-600 g ai/ha, 300-500 g ai/ha, 250-500 g ai/ha, 250-450 g ai/ha, 275-450 g ai/ha, 300-450 g ai/ha, 325-450 g ai/ha, 350-450 g ai/ha, 375-450 g ai/ha, 400-450 g ai/ha, 50-400 g ai/ha, 100-400 g ai/ha, 150-400 g ai/ha, 175-400 g ai/ha, 175-350 g ai/ha, 175-325 g ai/ha, 175-300 g ai/ha, 200-300 g ai/ha, 225-300 g ai/ha, 250-300 g ai/ha, or 275-300 g ai/ha,).

Tembotrione

Tembotrione, shown below, is 2-[2-chloro-4-(methylsulfonyl)-3-[(2,2,2-trifluoroethoxy)methyl]benzoyl]-1,3-cyclohexanedione. Its herbicidal activity is exemplified in The Pesticide Manual. Exemplary uses of tembotrione include its use for post-emergence control a wide range of dicotyledonous and monocotyledonous weed species in maize, with a maximum dose rate per season of 100 g/ha, applied either as one single dose or two sequential, partial doses.

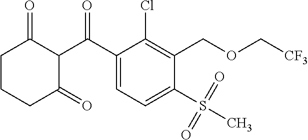 [SMILES: CS(=O)(=O)c1ccc(C(=O)C2C(=O)CCCC2=O)c(Cl)c1COCC(F)(F)F]

In some embodiments, tembotrione can be provided as an agriculturally acceptable salt of tembotrione.

The tembotrione or agriculturally acceptable salt thereof can be applied to vegetation or an area adjacent the vegetation or applied to soil or water to prevent the emergence or growth of vegetation in an amount sufficient to induce a herbicidal effect. In some embodiments, the tembotrione or agriculturally acceptable salt thereof is applied to vegetation or an area adjacent the vegetation or applied to soil or water to prevent the emergence or growth of vegetation in an amount of 1 g ai/ha or more (e.g., 2 g ai/ha or more, 4 g ai/ha or more, 6 g ai/ha or more, 8 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, or 200 g ai/ha or more.

In some embodiments, the tembotrione or agriculturally acceptable salt thereof is applied to vegetation or an area adjacent the vegetation or applied to soil or water to prevent the emergence or growth of vegetation in an amount of 200 g ai/ha or less (e.g., 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3 g ai/ha or less, 2.5 g ai/ha or less, 2 g ai/ha or less, 1.5 g ai/ha or less, or 1 g ai/ha or less).

The tembotrione or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the tembotrione or agriculturally acceptable salt thereof is applied to vegetation or an area adjacent the vegetation or applied to soil or water to prevent the emergence or growth of vegetation in an amount of 1-200 g ai/ha (e.g., 1-175 g ai/ha, 1-150 g ai/ha, 1-100 g ai/ha, 1-75 g ai/ha, 1-50 g ai/ha, 1-25 g ai/ha, 1-15 g ai/ha, 1-10 g ai/ha, 5-20 g ai/ha, 10-30 g ai/ha, 20-40 g ai/ha, 30-50 g ai/ha, 40-60 g ai/ha, 50-70 g ai/ha, 60-80 g ai/ha, 70-90 g ai/ha, 80-100 g ai/ha, 90-110 g ai/ha, 100-120 g ai/ha, 110-130 g ai/ha, 120-140 g ai/ha, or 130-150 g ai/ha).

Tefuryltrione

Tefuryltrione, shown below, is 2-[2-chloro-4-(methylsulfonyl)-3-[[(tetrahydro-2-furanyl)methoxy]methyl]benzoyl]-1,3-cyclohexanedione. Its herbicidal activity is exemplified in The Pesticide Manual. Exemplary uses of tefuryltrione include its use for post-emergence control a wide range of dicotyledonous and monocotyledonous weed species in maize, with a maximum dose rate per season of 100 g/ha, applied either as one single dose or two sequential, partial doses.

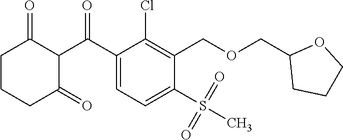 [SMILES: CS(=O)(=O)c1ccc(C(=O)C2C(=O)CCCC2=O)c(Cl)c1COCC1CCCO1]

In some embodiments, tefuryltrione can be provided as an agriculturally acceptable salt of tefuryltrione.

The tefuryltrione or agriculturally acceptable salt thereof can be applied to vegetation or an area adjacent the vegetation or applied to soil or water to prevent the emergence or growth of vegetation in an amount sufficient to induce a herbicidal effect. In some embodiments, the tefuryltrione or agriculturally acceptable salt thereof is applied to vegetation or an area adjacent the vegetation or applied to soil or water to prevent the emergence or growth of vegetation in an amount of 1 g ai/ha or more (e.g., 2 g ai/ha or more, 4 g ai/ha or more, 6 g ai/ha or more, 8 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 130 g ai/ha or more, 140 g ai/ha or more, 150 g ai/ha or more, 160 g ai/ha or more, 170 g ai/ha or more, 180 g ai/ha or more, 190 g ai/ha or more, or 200 g ai/ha or more.

In some embodiments, the tefuryltrione or agriculturally acceptable salt thereof is applied to vegetation or an area adjacent the vegetation or applied to soil or water to prevent the emergence or growth of vegetation in an amount of 200 g ai/ha or less (e.g., 190 g ai/ha or less, 180 g ai/ha or less, 170 g ai/ha or less, 160 g ai/ha or less, 150 g ai/ha or less, 140 g ai/ha or less, 130 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3 g ai/ha or less, 2.5 g ai/ha or less, 2 g ai/ha or less, 1.5 g ai/ha or less, or 1 g ai/ha or less).

The tefuryltrione or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the tefuryltrione or agriculturally acceptable salt thereof is applied to vegetation or an area adjacent the vegetation or applied to soil or water to prevent the emergence or growth of vegetation in an amount of 1-200 g ai/ha (e.g., 1-175 g ai/ha, 1-150 g ai/ha, 1-100 g ai/ha, 1-75 g ai/ha, 1-50 g ai/ha, 1-25 g ai/ha, 1-15 g ai/ha, 1-10 g ai/ha, 5-20 g ai/ha, 10-30 g ai/ha, 20-40 g ai/ha, 30-50 g ai/ha, 40-60 g ai/ha, 50-70 g ai/ha, 60-80 g ai/ha, 70-90 g ai/ha, 80-100 g ai/ha, 90-110 g ai/ha, 100-120 g ai/ha, 110-130 g ai/ha, 120-140 g ai/ha, or 130-150 g ai/ha).

Topramezone

Topramezone, shown below, is [3-(4,5-dihydro-3-isoxazolyl)-2-methyl-4-(methylsulfonyl)phenyl](5-hydroxy-1-methyl-1H-pyrazol-4-yl)methanone. Its herbicidal activity is exemplified in The Pesticide Manual. Exemplary uses of topramezone include its use for post-emergence weed control in maize.

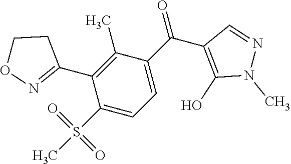 [SMILES: Cc1c(C(=O)c2cnn(C)c2O)ccc(S(C)(=O)=O)c1C1=NOCC1]

In some embodiments, topramezone can be provided as an agriculturally acceptable salt of topramezone.

The topramezone or agriculturally acceptable salt thereof can be applied to vegetation or an area adjacent the vegetation or applied to soil or water to prevent the emergence or growth of vegetation in an amount sufficient to induce a herbicidal effect. In some embodiments, the topramezone or agriculturally acceptable salt thereof is applied to vegetation or an area adjacent the vegetation or applied to soil or water to prevent the emergence or growth of vegetation in an amount of 1 g ai/ha or more (e.g., 2 g ai/ha or more, 4 g ai/ha or more, 6 g ai/ha or more, 8 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, or 100 g ai/ha or more).

In some embodiments, the topramezone or agriculturally acceptable salt thereof is applied to vegetation or an area adjacent the vegetation or applied to soil or water to prevent the emergence or growth of vegetation in an amount of 100 g ai/ha or less (e.g., 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7 g ai/ha or less, 6 g ai/ha or less, 5 g ai/ha or less, 4.5 g ai/ha or less, 4 g ai/ha or less, 3.5 g ai/ha or less, 3 g ai/ha or less, 2.5 g ai/ha or less, 2 g ai/ha or less, 1.5 g ai/ha or less, or 1 g ai/ha or less).

The topramezone or an agriculturally acceptable salt thereof can be applied to vegetation or an area adjacent the vegetation or applied to soil or water to prevent the emergence or growth of vegetation in an amount ranging from any of the minimum values described above to any of the maximum values described above. In some embodiments, the topramezone or agriculturally acceptable salt thereof is applied to vegetation or an area adjacent the vegetation or applied to soil or water to prevent the emergence or growth of vegetation in an amount of 1-100 g ai/ha (e.g., 1-90 g ai/ha, 1-80 g ai/ha, 1-70 g ai/ha, 1-60 g ai/ha, 1-50 g ai/ha, 1-25 g ai/ha, 1-15 g ai/ha, 1-10 g ai/ha, 5-20 g ai/ha, 10-25 g ai/ha, 15-25 g ai/ha, 20-30 g ai/ha, 20-40 g ai/ha, 30-50 g ai/ha, 40-60 g ai/ha, 50-70 g ai/ha, 60-80 g ai/ha, 70-90 g ai/ha, 80-100 g ai/ha, or 90-100 g ai/ha).

### II. Compositions

A. Herbicidal Mixtures or Combinations

The (a) pyridine carboxylic acid herbicide or an agriculturally acceptable N-oxide, salt, or ester thereof is mixed with or applied in combination with (b) an HPPD inhibitor or an agriculturally acceptable salt or ester thereof (a) and (b) can be provided in an amount sufficient to induce a herbicidal effect. In some embodiments, (a) and (b) are used in an amount sufficient to induce an unexpected herbicidal effect while still showing good crop compatibility (for example their use in crops does not result in significant increased damage to crops when compared to the individual application of the herbicidal compounds (a) or (b)). In some embodiments, (a) and (b) can be provided together to furnish a herbicidal effect that is more than the additive effect of (a) and (b) when used separately. In some embodiments, the damage or injury to the undesired vegetation caused by the compositions and methods disclosed herein is evaluated using a scale from 0% to 100%, when compared with the untreated control vegetation, wherein 0% indicates no damage to the undesired vegetation and 100% indicates complete destruction of the undesired vegetation.

In some embodiments, the joint action of a pyridine carboxylic acid herbicide or an agriculturally acceptable N-oxide, salt, or ester thereof and an HPPD inhibitor or an agriculturally acceptable salt or ester thereof results in enhanced activity against undesired vegetation even at application rates below those typically used for the pesticide to have a herbicidal effect on its own. In some embodiments, the compositions and methods disclosed herein can, based on the individual components, be used at lower application rates to achieve a herbicidal effect comparable to the effect produced by the individual components at normal application rates. In some embodiments, the compositions and methods disclosed herein provide an accelerated action on undesired vegetation (such as they may effect damaging of undesired vegetation more quickly compared with application of the individual herbicides).

In some embodiments, the observed effect for undesired vegetation is at least 1%, at least 2%, at least 3%, at least 4%, at least 5%, at least 10%, at least 15%, at least 20%, or at least 25% greater than the effect (E) calculated according to the Colby method (e.g., an observed effect of 96% would be 4% greater than an calculated effect (E) of 92%). In some embodiments, for undesired vegetation, the difference (D_{O}) between 100% and the observed effect is at least 5%, at least 10%, at least 15%, at least 20%, at least 25%, at least 30%, at least 35%, at least 40%, at least 45%, or at least 50% less than the difference (D_{E}) between 100% and the effect (E) calculated according to the Colby equation (e.g., an observed effect of 96% would produce a D_{O} of 4%, a calculated effect (E) of 92% would produce a D_{E} of 8%, and D_{O} would be 50% less than or half of D_{E}).

In some embodiments, the weight ratio of (a) a pyridine carboxylic acid herbicide or an agriculturally acceptable N-oxide, salt, or ester thereof (in g ae/ha) to (b) an HPPD inhibitor or an agriculturally acceptable salt or ester thereof (in g ai/ha) is 1:8000 or more (e.g., 1:7000 or more, 1:6000 or more, 1:5000 or more, 1:4000 or more, 1:3000 or more, 1:2000 or more, 1:1800 or more, 1:1600 or more, 1:1400 or more, 1:1200 or more, 1:1000 or more, 1:900 or more, 1:800 or more, 1:700 or more, 1:600 or more, 1:500 or more, 1:400 or more, 1:300 or more, 1:200 or more, 1:100 or more, 1:90 or more, 1:80 or more, 1:70 or more, 1:60 or more, 1:50 or more, 1:40 or more, 1:30 or more, 1:20 or more, 1:10 or more, 1:9 or more, 1:8 or more, 1:7 or more, 1:6 or more, 1:5 or more, 1:4 or more, 1:3 or more, 1:2 or more, 1:1.9 or more, 1:1.8 or more, 1:1.7 or more, 1:1.6 or more, 1:1.5 or more, 1:1.4 or more, 1:1.3 or more, 1:1.2 or more, 1:1.1 or more, 1:1 or more, 1.1:1 or more, 1.2:1 or more, 1.3:1 or more, 1.4:1 or more, 1.5:1 or more, 1.6:1 or more, 1.7:1 or more, 1.8:1 or more, 1.9:1 or more, 2:1 or more, 3:1 or more, 4:1 or more, 5:1 or more, 6:1 or more, 7:1 or more, 8:1 or more, 9:1 or more, 10:1 or more, 20:1 or more, 30:1 or more, 40:1 or more, 50:1 or more, 60:1 or more, 70:1 or more, 80:1 or more, 90:1 or more, 100:1 or more, 200:1 or more, 300:1 or more, 400:1 or more, 500:1 or more, 600:1 or more, 700:1 or more, 800:1 or more, 900:1 or more, or 1000:1 or more).

In some embodiments, the weight ratio of (a) a pyridine carboxylic acid herbicide or an agriculturally acceptable N-oxide, salt, or ester thereof (in g ae/ha) to (b) an HPPD inhibitor or an agriculturally acceptable salt or ester thereof (in g ai/ha) is 1000:1 or less (e.g., 900:1 or less, 800:1 or less, 700:1 or less, 600:1 or less, 500:1 or less, 400:1 or less, 300:1 or less, 250:1 or less, 200:1 or less, 100:1 or less, 90:1 or less, 80:1 or less, 70:1 or less, 60:1 or less, 50:1 or less, 40:1 or less, 30:1 or less, 20:1 or less, 15:1 or less, 10:1 or less, 9:1 or less, 8:1 or less, 7:1 or less, 6:1 or less, 5:1 or less, 4:1 or less, 3:1 or less, 2:1 or less, 1.9:1 or less, 1.8:1 or less, 1.7:1 or less, 1.6:1 or less, 1.5:1 or less, 1.4:1 or less, 1.3:1 or less, 1.2:1 or less, 1.1:1 or less, 1:1 or less, 1:1.1 or less, 1:1.2 or less, 1:1.3 or less, 1:1.4 or less, 1:1.5 or less, 1:1.6 or less, 1:1.7 or less, 1:1.8 or less, 1:1.9 or less, 1:2 or less, 1:3 or less, 1:4 or less, 1:5 or less, 1:6 or less, 1:7 or less, 1:8 or less, 1:9 or less, 1:10 or less, 1:20 or less, 1:30 or less, 1:40 or less, 1:50 or less, 1:60 or less, 1:70 or less, 1:80 or less, 1:90 or less, 1:100 or less, 1:200 or less, 1:300 or less, 1:400 or less, 1:500 or less, 1:600 or less, 1:700 or less, 1:800 or less, 1:900 or less, 1:1000 or less, 1:1200 or less, 1:1400 or less, 1:1600 or less, 1:1800 or less, 1:2000 or less, 1:3000 or less, 1:4000 or less, 1:5000 or less, 1:6000 or less, 1:7000 or less, or 1:8000 or less).

The weight ratio of (a) a pyridine carboxylic acid herbicide or an agriculturally acceptable N-oxide, salt, or ester thereof (in g ae/ha) to (b) an HPPD inhibitor or an agriculturally acceptable salt or ester thereof (in g ai/ha) can range from any of the minimum ratios described above to any of the maximum values described above. In some embodiments, the weight ratio of (a) a pyridine carboxylic acid herbicide or an agriculturally acceptable N-oxide, salt, or ester thereof (in g ae/ha) to (b) an HPPD inhibitor or an agriculturally acceptable salt or ester thereof (in g ai/ha) is from 1:8000 to 1000:1 (e.g., from 1:6000 to 1000:1, from 1:5000 to 1000:1, from 1:4000 to 800:1, from 1:3000 to 600:1, from 1:2500 to 400:1, from 1:2000 to 250:1, from 1:1000 to 125:1, 1:800 to 100:1, from 1:500 to 60:1, from 1:400 to 200:1, from 1:200 to 100:1, from 1:125 to 15:1, from 1:100 to 100:1, from 1:50 to 50:1, from 1:40 to 40:1, from 1:30 to 30:1, from 1:20 to 20:1, from 1:10 to 10:1, 1:1000 to 20:1, from 1:900 to 10:1, from 1:900 to 50:1, from 1:800 to 40:1, from 1:700 to 30:1, from 1:600 to 20:1, from 1:500 to 15:1, from 1:400 to 10:1, from 1:300 to 9:1, from 1:200 to 8:1, from 1:100 to 7:1, from 1:50 to 6:1, from 1:40 to 5:1, from 1:30 to 5:1, from 1:30 to 4:1, from 1:20 to 3:1, from 1:10 to 2:1, from 1:5 to 5:1, from 1:4 to 4:1, from 1:3 to 3:1, or from 1:2 to 2:1).

In some embodiments, the active ingredients in the compositions disclosed herein consist of (a) a pyridine carboxylic acid herbicide or an agriculturally acceptable N-oxide, salt, or ester thereof and (b) an HPPD inhibitor or an agriculturally acceptable salt or ester thereof.

B. Formulations

The present disclosure also relates to formulations of the compositions and methods disclosed herein. In some embodiments, the formulation can be in the form of a single package formulation including both (a) a pyridine carboxylic acid herbicide or an agriculturally acceptable N-oxide, salt, or ester thereof, and (b) an HPPD inhibitor or an agriculturally acceptable salt or ester thereof. In some embodiments, the formulation can be in the form of a single package formulation including both (a) and (b) and further including at least one additive. In some embodiments, the formulation can be in the form of a two-package formulation, wherein one package contains (a) and optionally at least one additive while the other package contains (b) and optionally at least one additive. In some embodiments of the two-package formulation, the formulation including (a) and optionally at least one additive and the formulation including (b) and optionally at least one additive are mixed before application and then applied simultaneously. In some embodiments, the mixing is performed as a tank mix (e.g., the formulations are mixed immediately before or upon dilution with water). In some embodiments, the formulation including (a) and the formulation including (b) are not mixed but are applied sequentially (in succession), for example, immediately or within 1 hour, within 2 hours, within 4 hours, within 8 hours, within 16 hours, within 24 hours, within 2 days, or within 3 days, of each other.

In some embodiments, the formulation of (a) and (b) is present in suspended, emulsified, or dissolved form. Exemplary formulations include, but are not limited to, aqueous solutions, powders, suspensions, also highly-concentrated aqueous, oily or other suspensions or dispersions, aqueous emulsions, aqueous microemulsions, aqueous suspo-emulsions, oil dispersions, self-emulsifying formulations, pastes, dusts, and materials for spreading or granules.

In some embodiments, (a) a pyridine carboxylic acid herbicide or an agriculturally acceptable N-oxide, salt, or ester thereof and/or (b) an HPPD inhibitor or an agriculturally acceptable salt or ester thereof is an aqueous solution that can be diluted before use. In some embodiments, (a) and/or (b) is provided as a high-strength formulation such as a concentrate. In some embodiments, the concentrate is stable and retains potency during storage and shipping. In some embodiments, the concentrate is a clear, homogeneous liquid that is stable at temperatures of 54° C. or greater. In some embodiments, the concentrate does not exhibit any precipitation of solids at temperatures of −10° C. or higher. In some embodiments, the concentrate does not exhibit separation, precipitation, or crystallization of any components at low temperatures. For example, the concentrate remains a clear solution at temperatures below 0° C. (e.g., below −5° C., below −10° C., below −15° C.). In some embodiments, the concentrate exhibits a viscosity of less than 50 centipoise (50 megapascals), even at temperatures as low as 5° C.

The compositions and methods disclosed herein can also be mixed with or applied with an additive. In some embodiments, the additive can be diluted in water or can be concentrated. In some embodiments, the additive is added sequentially. In some embodiments, the additive is added simultaneously. In some embodiments, the additive is premixed with the pyridine carboxylic acid herbicide or agriculturally acceptable N-oxide, salt, or ester thereof. In some embodiments, the additive is premixed with the HPPD inhibitor or agriculturally acceptable salt or ester thereof.

C. Other Actives

In some embodiments, the additive is an additional pesticide. For example, the compositions described herein can be applied in conjunction with one or more additional herbicides to control undesirable vegetation. The composition can be formulated with the one or more additional herbicides, tank mixed with the one or more additional herbicides, or applied sequentially with the one or more additional herbicides. Exemplary additional herbicides include, but are not limited to: 4-CPA, 4-CPB, 4-CPP, 2,4-D, 2,4-D choline salt, 2,4-D esters and amines, 2,4-DB, 3,4-DA, 3,4-DB, 2,4-DEB, 2,4-DEP, 3,4-DP, 2,3,6-TBA, 2,4,5-T, 2,4,5-TB, acetochlor, acifluorfen, aclonifen, acrolein, alachlor, allidochlor, alloxydim, allyl alcohol, alorac, ametridione, ametryn, amibuzin, amicarbazone, aminocyclopyrachlor, 4-aminopicolinic acid based herbicides, such as halauxifen, halauxifen-methyl, 4-amino-3-chloro-6-(4-chloro-2-fluoro-3-methoxyphenyl)-5-fluoro-2-pyridinecarboxylic acid, benzyl 4-amino-3-chloro-6-(4-chloro-2-fluoro-3-methoxyphenyl)-5-fluoro-2-pyridinecarboxylate, and those described in U.S. Pat. Nos. 7,314,849 and 7,432,227 to Balko, et al., aminopyralid, amiprofos-methyl, amitrole, ammonium sulfamate, anilofos, anisuron, asulam, atraton, atrazine, azafenidin, aziprotryne, barban, BCPC, beflubutamid, benazolin, bencarbazone, benfluralin, benfuresate, bensulide, benthiocarb, bentazon-sodium, benzadox, benzfendizone, benzipram, benzobicyclon, benzofenap, benzofluor, benzoylprop, benzthiazuron, bicyclopyrone, bifenox, bilanafos, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole, chlorprocarb, carfentrazone-ethyl, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlornitrofen, chloropon, chlorotoluron, chloroxuron, chloroxynil, chlorpropham, chlorthal, chlorthiamid, cinidon-ethyl, cinmethylin, cisanilide, clacyfos, clethodim, cliodinate, clodinafop-propargyl, clofop, clomazone, clomeprop, cloprop, cloproxydim, clopyralid, CMA, copper sulfate, CPMF, CPPC, credazine, cresol, cumyluron, cyanatryn, cyanazine, cycloate, cycloxydim, cycluron, cyhalofop-butyl, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop-methyl, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethbenzamide, ethidimuron, ethiolate, ethobenzamid, etobenzamid, ethofumesate, ethoxyfen, etinofen, etnipromid, etobenzanid, EXD, fenasulam, fenoprop, fenoxaprop, fenoxaprop-P-ethyl, fenoxaprop-P-ethyl+isoxadifen-ethyl, fenoxasulfone, fenquinotrione, fenteracol, fenthiaprop, fentrazamide, fenuron, ferrous sulfate, flamprop, flamprop-M, fluazifop, fluazifop-P-butyl, fluazolate, fluchloralin, flufenacet, flufenican, flufenpyr-ethyl, flumezin, flumiclorac-pentyl, flumioxazin, flumipropyn, fluometuron, fluorodifen, fluoroglycofen, fluoromidine, fluoronitrofen, fluothiuron, flupoxam, flupropacil, flupropanate, fluridone, flurochloridone, fluroxypyr, fluroxypyr-meptyl, flurtamone, fluthiacet, fomesafen, fosamine, fumiclorac, furyloxyfen, glufosinate, glufosinate-ammonium, glufosinate-P-ammonium, glyphosate salts and esters, halosafen, haloxydine, hexachloroacetone, hexaflurate, hexazinone, indanofan, indaziflam, iodobonil, iodomethane, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA esters and amines, MCPA-thioethyl, MCPB, mecoprop, mecoprop-P, medinoterb, mefenacet, mefluidide, mesoprazine, mesotrione, metam, metamifop, metamitron, metazachlor, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metoxuron, metribuzin, molinate, monalide, monisouron, monochloroacetic acid, monolinuron, monuron, morfamquat, MSMA, naproanilide, napropamide, napropamide-M, naptalam, neburon, nipyraclofen, nitralin, nitrofen, nitrofluorfen, norflurazon, noruron, OCH, orbencarb, ortho-dichlorobenzene, oryzalin, oxadiargyl, oxadiazon, oxapyrazon, oxaziclomefone, oxyfluorfen, paraflufen-ethyl, parafluron, paraquat, pebulate, pelargonic acid, pendimethalin, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, procyazine, prodiamine, profluazol, profluralin, profoxydim, proglinazine, prohexadione-calcium, prometon, prometryn, pronamide, propachlor, propanil, propaquizafop, propazine, propham, propisochlor, propyzamide, prosulfalin, prosulfocarb, proxan, prynachlor, pydanon, pyraclonil, pyraflufen-ethyl, pyrasulfotole, pyrazogyl, pyrazolynate, pyrazoxyfen, pyributicarb, pyriclor, pyridafol, pyridate, quinclorac, quinmerac, quinoclamine, quinonamid, quizalofop, quizalofop-P-ethyl, rhodethanil, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfosate, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiameturon, thiazafluron, thiazopyr, thidiazimin, thidiazuron, thiobencarb, tiafenacil, tiocarbazil, tioclorim, tolpyralate, topramezone, tralkoxydim, tri-allate, triafamone, triaziflam, tricamba, triclopyr choline salt, triclopyr esters and amines, tridiphane, trietazine, trifluralin, trifop, trifopsime, trihydroxytriazine, trimeturon, tripropindan, tritac, vernolate, xylachlor and salts, esters, optically active isomers, and mixtures thereof.

In some embodiments, the additional pesticide or an agriculturally acceptable salt or ester thereof is provided in a premixed formulation with (a), (b), or combinations thereof. In some embodiments, the pyridine carboxylic acid herbicide or an agriculturally acceptable N-oxide, salt, or ester thereof is provided in a premixed formulation with an additional pesticide. In some embodiments, the HPPD inhibitor or an agriculturally acceptable salt or ester thereof is provided in a premixed formulation with an additional pesticide. In some embodiments, the benzobicyclon, the benzofenap, the bicyclopyrone, the fenquinotrione, the isoxachlortole, the isoxaflutole, the mesotrione, the pyrasulfotole, the pyrazolynate, the pyrazoxyfen, the sulcotrione, the tembotrione, the tefuryltrione, or the topramezone, or an agriculturally acceptable salt or ester thereof, is provided in a premixed formulation with an additional pesticide.

D. Adjuvants/Carriers/Colorants/Adhesives

In some embodiments, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, safeners, adhesives (for instance, for use in seed formulations), surfactants, protective colloids, emulsifiers, tackifiers, and mixtures thereof.

Exemplary agriculturally acceptable adjuvants include, but are not limited to, crop oil concentrate (mineral oil (85%)+emulsifiers (15%)) or less, nonylphenol ethoxylate or less, benzylcocoalkyldimethyl quaternary ammonium salt or less, blend of petroleum hydrocarbon, alkyl esters, organic acid, and anionic surfactant or less, C₉-C₁₁ alkylpolyglycoside or less, phosphate alcohol ethoxylate or less, natural primary alcohol (C₁₂-C₁₆) ethoxylate or less, di-sec-butylphenol EO-PO block copolymer or less, polysiloxane-methyl cap or less, nonylphenol ethoxylate+urea ammonium nitrate or less, emulsified methylated seed oil or less, tridecyl alcohol (synthetic) ethoxylate (8 EO) or less, tallow amine ethoxylate (15 EO) or less, and PEG(400) dioleate-99.

In some embodiments, the additive is a safener, which is an organic compound leading to better crop plant compatibility when applied with a herbicide. In some embodiments, the safener itself is herbicidally active. In some embodiments, the safener acts as an antidote or antagonist in the crop plants and can reduce or prevent damage to the crop plants. Exemplary safeners include, but are not limited to, AD-67 (MON 4660), benoxacor, benthiocarb, brassinolide, cloquintocet (mexyl), cyometrinil, cyprosulfamide, daimuron, dichlormid, dicyclonon, dietholate, dimepiperate, disulfoton, fenchlorazole, fenchlorazole-ethyl, fenclorim, flurazole, fluxofenim, furilazole, harpin proteins, isoxadifen-ethyl, jiecaowan, jiecaoxi, mefenpyr, mefenpyr-diethyl, mephenate, naphthalic anhydride, 2,2,5-trimethyl-3-(dichloroacetyl)-1,3-oxazolidine, 4-(dichloroacetyl)-1-oxa-4-azaspiro [4.5]decane, oxabetrinil, R29148, and N-phenyl-sulfonylbenzoic acid amides, as well as thereof agriculturally acceptable salts and, provided they have a carboxyl group, their agriculturally acceptable derivatives. In some embodiments, the safener can be cloquintocet or an ester or salt or ester thereof, such as cloquintocet (mexyl). In some embodiments, the safener can be dichlormid. In some embodiments, the safener is employed in rice, cereal, corn, or maize. For example, dichlormid or cloquintocet can be used to antagonize harmful effects of the compositions on rice, row crops, and cereals.

Exemplary surfactants (e.g., wetting agents, tackifiers, dispersants, emulsifiers) include, but are not limited to, the alkali metal salts, alkaline earth metal salts and ammonium salts of aromatic sulfonic acids, for example lignosulfonic acids, phenolsulfonic acids, naphthalenesulfonic acids, and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalene sulfonic acids with phenol and formaldehyde, polyoxyethylene octylphenol ether, ethoxylated isooctyl-, octyl- or nonylphenol, alkylphenyl or tributylphenyl polyglycol ether, alkyl aryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denatured proteins, polysaccharides (e.g., methylcellulose), hydrophobically modified starches, polyvinyl alcohol, polycarboxylates, polyalkoxylates, polyvinyl amine, polyethyleneimine, polyvinylpyrrolidone and copolymers thereof.

Exemplary thickeners include, but are not limited to, polysaccharides, such as xanthan gum, and organic and inorganic sheet minerals, and mixtures thereof.

Exemplary antifoam agents include, but are not limited to, silicone emulsions, long-chain alcohols, fatty acids, salts of fatty acids, organofluorine compounds, and mixtures thereof.

Exemplary antimicrobial agents include, but are not limited to, bactericides based on dichlorophen and benzyl alcohol hemiformal, and isothiazolinone derivates, such as alkylisothiazolinones and benzisothiazolinones, and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

In some embodiments, the additive includes a carrier. In some embodiments, the additive includes a liquid or solid carrier. In some embodiments, the additive includes an organic or inorganic carrier. Exemplary liquid carriers include, but are not limited to, petroleum fractions or hydrocarbons such as mineral oil, aromatic solvents, paraffinic oils, and the like or less, vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like or less, esters of the above vegetable oils or less, esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like or less, esters of mono, di and polycarboxylic acids and the like, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like, and water as well as mixtures thereof. Exemplary solid carriers include, but are not limited to, silicas, silica gels, silicates, talc, kaolin, limestone, lime, chalk, bole, loess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

In some embodiments, emulsions, pastes or oil dispersions can be prepared by homogenizing (a) and (b) in water by means of wetting agent, tackifier, dispersant or emulsifier. In some embodiments, concentrates suitable for dilution with water are prepared, containing (a), (b), a wetting agent, a tackifier, and a dispersant or emulsifier.

In some embodiments, powders or materials for spreading and dusts can be prepared by mixing or concomitant grinding of (a) and (b) and optionally a safener with a solid carrier.

In some embodiments, granules (e.g., coated granules, impregnated granules and homogeneous granules) can be prepared by binding the (a) and (b) to solid carriers.

The formulations disclosed herein provide a herbicidally effective amount of (a) and (b). In some embodiments, the concentrations of (a) and (b) in the formulations can be varied. In some embodiments, the formulations contain from 1% to 95% (e.g., from 5% to 95%, from 10% to 80%, from 20% to 70%, from 30% to 50%) by total weight of (a) and (b). In formulations designed to be employed as concentrates, (a) and (b) can be present in a concentration of from 0.1 to 98 weight percent (0.5 to 90 weight percent), based on the total weight of the formulation. Concentrates can be diluted with an inert carrier, such as water, prior to application. The diluted formulations applied to undesired vegetation or the locus of undesired vegetation can contain from 0.0006 to 8.0 weight percent of (a) and (b) (e.g., from 0.001 to 5.0 weight percent), based on the total weight of the diluted formulation.

In some embodiments, (a) and (b), independently, can be employed in a purity of from 90% to 100% (e.g., from 95% to 100%) according to nuclear magnetic resonance (NMR) spectrometry. In some embodiments, the concentrations of (a), (b), and additional pesticides in the formulations can be varied. In some embodiments, the formulations contain from 1% to 95% (e.g., from 5% to 95%, from 10% to 80%, from 20% to 70%, from 30% to 50%) by total weight of (a), (b), and additional pesticides. In some embodiments, (a), (b), and additional pesticides, independently, can be employed in a purity of from 90% to 100% (e.g., from 95% to 100%) according to NMR spectrometry.

### III. Methods of Use

A. Methods of Application

The compositions disclosed herein can be applied in any known technique for applying herbicides. Exemplary application techniques include, but are not limited to, spraying, atomizing, dusting, spreading, or direct application into water (in-water). The method of application can vary depending on the intended purpose. In some embodiments, the method of application can be chosen to ensure the finest possible distribution of the compositions disclosed herein.

In some embodiments, a method of controlling undesirable vegetation which includes contacting the vegetation or the locus thereof with or applying to the soil or water to prevent the emergence or growth of vegetation any of the compositions is disclosed herein.

The compositions disclosed herein can be applied pre-emergence (before the emergence of undesirable vegetation) or post-emergence (during and/or after emergence of the undesirable vegetation). If desired, the compositions can be applied as an in-water application. In some embodiments, the pyridine carboxylic acid herbicide or or an agriculturally acceptable N-oxide, salt, or ester thereof and the HPPD inhibitor are applied simultaneously. In some embodiments, (a) and (b) can be provided together to furnish a herbicidal effect that is more than the additive effect of (a) and (b) when used separately.

When the compositions are used in crops, the compositions can be applied after seeding and before or after the emergence of the crop plants. In some embodiments, the compositions disclosed herein show good crop tolerance even when the crop has already emerged and can be applied during or after the emergence of the crop plants. In some embodiments, when the compositions are used in crops, the compositions can be applied before seeding of the crop plants.

In some embodiments, the compositions disclosed herein are applied to vegetation or an area adjacent the vegetation or applied to soil or water to prevent the emergence or growth of vegetation by spraying (e.g., foliar spraying). In some embodiments, the spraying techniques use, for example, water as carrier and spray liquor rates of from 10 liters per hectare (L/ha) to 2000 L/ha (e.g., from 50 L/ha to 1000 L/ha or from 100 to 500 L/ha). In some embodiments, the compositions disclosed herein are applied by the low-volume or the ultra-low-volume method. In some embodiments, wherein the compositions disclosed herein are less well tolerated by certain crop plants, the compositions can be applied with the aid of the spray apparatus in such a way that they come into little contact, if any, with the leaves of the sensitive crop plants while reaching the leaves of undesirable vegetation that grows underneath or the bare soil (e.g., post-directed or lay-by). In some embodiments, the compositions disclosed herein can be applied as dry formulations (e.g., granules, WDGs, etc.) into water.

In some embodiments, herbicidal activity is exhibited by the compounds of the mixture when they are applied directly to the plant or to the locus of the plant at any stage of growth or before planting or emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of chemical applied. In some embodiments, these and other factors can be adjusted to promote non-selective or selective herbicidal action. In some cases, the compositions are applied to relatively immature undesirable vegetation.

The compositions and methods disclosed herein can be used to control undesired vegetation in a variety of crop and non-crop applications. In some embodiments, the compositions and methods disclosed herein can be used for controlling undesired vegetation in crops. Exemplary crops include, but are not limited to, wheat, barley, triticale, rye, teff, oats, maize, cotton, soybeans, sorghum, millet, rice, sugarcane and range land (e.g., pasture grasses). In some embodiments, the undesirable vegetation is controlled in a row crop (e.g., maize, sorghum, soybean, cotton, or oilseed rape/canola). In some embodiments, the compositions and methods disclosed herein can be used for controlling undesired vegetation in wheat, barley, oats, rye, triticale, maize, sorgum, millet, or genetically modified wheat, barley, maize or oats.

The compositions and methods disclosed herein can be used for controlling undesired vegetation in non-crop areas. Exemplary non-crop areas include, but are not limited to, turfgrass, pastures, grasslands, fallow land, rights-of-way, aquatic settings, tree and vine, wildlife management areas, or rangeland. In some embodiments, the compositions and methods disclosed herein can be used in industrial vegetation management (IVM) or for utility, pipeline, roadside, and railroad rights-of-way applications. In some embodiments, the compositions and methods disclosed herein can also be used in forestry (e.g., for site preparation or for combating undesirable vegetation in plantation forests). In some embodiments, the compositions and methods disclosed herein can be used to control undesirable vegetation in conservation reserve program lands (CRP), trees, vines, grasslands, and grasses grown for seeds. In some embodiments, the compositions and methods disclosed herein can be used on lawns (e.g., residential, industrial, and institutional), golf courses, parks, cemeteries, athletic fields, and sod farms.

The compositions and methods disclosed herein can also be used in crop plants that are resistant to, for instance, herbicides, pathogens, and/or insects. In some embodiments, the compositions and methods disclosed herein can be used in crop plants that are resistant to one or more herbicides because of genetic engineering or breeding. In some embodiments, the compositions and methods disclosed herein can be used in crop plants that are resistant to one or more pathogens such as plant pathogenous fungi owing to genetic engineering or breeding. In some embodiments, the compositions and methods disclosed herein can be used in crop plants that are resistant to attack by insects owing to genetic engineering or breeding. Exemplary resistant crops include, but are not limited to, crops that are resistant to photosystem II inhibitors, or crop plants that, owing to introduction of the gene for Bacillus thuringiensis (or Bt) toxin by genetic modification, are resistant to attack by certain insects. In some embodiments, the compositions and methods described herein also can be used in conjunction with glyphosate, glufosinate, dicamba, phenoxy auxins, pyridyloxy auxins, aryloxyphenoxypropionates, acetyl CoA carboxylase (ACCase) inhibitors, 4-hydroxyphenyl-pyruvate dioxygenase (HPPD) inhibitors, protoporphyrinogen oxidase (PPO) inhibitors, triazines, and bromoxynil to control vegetation in crops tolerant to glyphosate, glufosinate, dicamba, phenoxy auxins, pyridyloxy auxins, aryloxyphenoxypropionates, acetyl CoA carboxylase (ACCase) inhibitors, 4-hydroxyphenyl-pyruvate dioxygenase (HPPD) inhibitors, protoporphyrinogen oxidase (PPO) inhibitors, triazines, bromoxynil, or combinations thereof. In some embodiments, the undesirable vegetation is controlled in glyphosate, glufosinate, dicamba, phenoxy auxins, pyridyloxy auxins, aryloxyphenoxypropionates, acetyl CoA carboxylase (ACCase) inhibitors, 4-hydroxyphenyl-pyruvate dioxygenase (HPPD) inhibitors, protoporphyrinogen oxidase (PPO) inhibitors, triazines, and bromoxynil tolerant crops possessing single, multiple or stacked traits conferring tolerance to single or multiple chemistries and/or multiple modes of action. In some embodiments, the undesirable vegetation can be controlled in a crop that is ACCase-tolerant. The combination of (a), (b), and a complementary herbicide or salt or ester thereof can be used in combination with herbicides that are selective for the crop being treated and which complement the spectrum of weeds controlled by these compounds at the application rate employed. In some embodiments, the compositions described herein and other complementary herbicides are applied at the same time, either as a combination formulation or as a tank mix, or as sequential applications.

The compositions and methods may be used in controlling undesirable vegetation in crops possessing agronomic stress tolerance (including but not limited to drought, cold, heat, salt, water, nutrient, fertility, pH), pest tolerance (including but not limited to insects, fungi and pathogens) and crop improvement traits (including but not limited to yield; protein, carbohydrate, or oil content; protein, carbohydrate, or oil composition; plant stature and plant architecture).

In some embodiments, the compositions disclosed herein can be used for controlling undesirable vegetation including grasses, broadleaf weeds, sedge weeds, and combinations thereof. In some embodiments, the compositions disclosed herein can be used for controlling undesirable vegetation including, but not limited to, Polygonum species such as wild buckwheat (Polygonum convolvolus), Amaranthus species such as pigweed (Amaranthus retroflexus), Chenopodium species such as common lambsquarters (Chenopodium album L.), Sida species such as prickly sida (Sida spinosa L.), Ambrosia species such as common ragweed (Ambrosia artemisiifolia), Cyperus species such as nutsedge (Cyperus esculentus), Setaria species such as giant foxtail (Setaria faberi), Sorghum species, Acanthospermum species, Anthemis species, Atriplex species, Brassica species, Cirsium species, Convolvulus species, Conyza species, such as horseweed (Conyza canadensis), Cassia species, Commelina species, Datura species, Euphorbia species, Geranium species, Galinsoga species, Ipomea species such as morning-glory, Lamium species, Malva species, Matricaria species, Persicaria species, Prosopis species, Rumex species, Sisymbrium species, Solanum species, Trifolium species, Xanthium species, Veronica species, Viola species such as wild pansy (Viola tricolor), common chickweed (Stellaria media), velvetleaf (Abutilon theophrasti), hemp sesbania (Sesbania exaltata Cory), Anoda cristata, Bidens pilosa, Brassica kaber, shepherd's purse (Capsella bursa-pastoris), cornflower (Centaurea cyanus or Cyanus segetum), Galeopsis tetrahit, cleavers Galium aparine), Helianthus annuus, Desmodium tortuosum, kochia (Kochia scoparia), Medicago arabica, Mercurialis annua, Myosotis arvensis, common poppy (Papaver rhoeas), Raphanus raphanistrum, Russian thistle (Salsola kali), wild mustard (Sinapis arvensis), Sonchus arvensis, Thlaspi arvense, Tagetes minuta, Richardia brasiliensis, Plantago major, Plantago lanceolata, bird's-eye speedwell (Veronica persica) and speedwell.

In certain embodiments, the undesirable vegetation includes velvetleaf (Abutilon theophrasti, ABUTH), pigweed (Amaranthus retrollexus, AMARE), wild oat (Avena fatua, AVEFA), winter rape (Brassica napus, BRSNW), turnip (Brassica rapa, BRSRR), common lambsquarters (Chenopodium album L., CHEAL), thistle (Cirsium arvense CIRAR, barnyardgrass (Echinochloa crus-galli, ECHCG), poinsettia (Euphorbia heterophylla, EPHHL), soybean (Glycine max, GLXMA), sunflower (Helianthus annuus, HELAN), ivyleaf morningglory (Ipomoea hederacea, IPOHE), kochia (Kochia scoparia, KCHSC), wild buckwheat (Polygonum convolvulus, POLCO), giant foxtail (Setaria faberi, SETFA), grain sorghum (Sorghum vulgare, SORVU), common chickweed (Stellaria media, STEME), wild pansy (Viola tricolor, VIOTR), or a combination thereof.

The herbicidal compositions described herein can be used to control herbicide resistant or tolerant weeds. The methods employing the compositions described herein may also be employed to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinyl(oxy/thio)benzoates, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxypropionates, cyclohexanediones, phenylpyrazolines), synthetic auxins (e.g., benzoic acids, phenoxycarboxylic acids, pyridine carboxylic acids, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bialafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidindiones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes-of-action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, biotypes with resistance or tolerance to multiple chemical classes, biotypes with resistance or tolerance to multiple herbicide modes-of-action, and biotypes with multiple resistance or tolerance mechanisms (e.g., target site resistance or metabolic resistance).

By way of non-limiting illustration, examples of certain embodiments of the present disclosure are given below.

### EXAMPLES

### Example 1. Herbicidal Activity and Effect on Crop Injury on Winter Wheat of Compounds of Formula I and HPPD Herbicides in Greenhouse Trials

### Methodology—Evaluation of Postemergence Herbicidal Activity in Crops

Seeds of the desired test plant species were planted in Sun Gro MetroMix® 306 planting mixture, which typically has a pH of 6.0 to 6.8 and an organic matter content of about 30 percent, in plastic pots with a surface area of 103.2 square centimeters (cm²). When required to ensure good germination and healthy plants, a fungicide treatment and/or other chemical or physical treatment was applied. The plants were grown for 7-36 days (d) in a greenhouse with an approximate 14-hour (h) photoperiod which was maintained at about 23° C. during the day and 22° C. during the night. Nutrients and water were added on a regular basis and supplemental lighting was provided with overhead metal halide 1000-Watt lamps as necessary. The plants were employed for testing when they reached the second or third true leaf stage.

The compound of Formula (1):

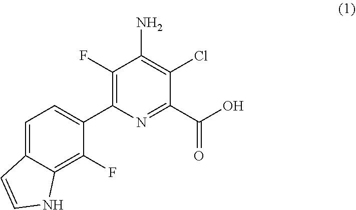 [SMILES: Nc1c(F)c(-c2ccc3cc[nH]c3c2F)nc(C(=O)O)c1Cl]

was used with various HPPD inhibitors in herbicide evaluations.

An emulsifiable concentrate (EC) formulation containing Compound 1 at 100 gai/L was prepared by combining Compound 1 with 1-butyl-2-pyrrolidinone (Tamisolve NxG; 360.5 g/L), benzyl acetate (544.6 g/L) and Agnique MBL 520L surfactant (52.9 g/L). If Compound 1 did not dissolve readily, the mixture was warmed and/or sonicated. The concentrated stock solutions were diluted with an aqueous mixture of 1.5% v/v of Agri-dex crop oil concentrate to provide the appropriate application rates. Compound requirements are based upon a 12 milliliter (mL) application volume at a rate of 187 liters per hectare (L/ha). Spray solutions of the experimental compound mixtures were prepared by adding the stock solutions to the appropriate amount of dilution solution to form a 12 mL spray solution in two-way combinations. Formulated compounds were applied to the plant material with an overhead Mandel track sprayer equipped with 8002E nozzles calibrated to deliver 187 L/ha over an application area of 0.503 square meters (m²) at a spray height of 18 inches (43 centimeters (cm)) above average plant canopy. Control plants were sprayed in the same manner with the solvent blank. Application rates for component (a) are in g ai/ha, and application rates for component (b) are in g ai/ha.

The treated plants and control plants were placed in a greenhouse as described above and watered by sub-irrigation to prevent wash-off of the test compounds. After 20-22 d, the condition of the test plants as compared with that of the control plants was determined visually and scored on a scale of 0 to 100 percent where 0 corresponds to no injury and 100 corresponds to complete kill. The condition of the test plants was compared with that of the control plants as determined visually and scored on a scale of 0 to 100 percent, where 0 corresponds to no injury and 100 corresponds to complete kill. The Colby method was used to determine the herbicidal effects expected from the mixtures.

Compound 1 (formulated as an EC) was combined with isoxaflutole and the efficacy of the herbicidal composition on velvetleaf (Abutilon theophrasti, ABUTH), wild oat (Avena fatua, AVEFA), winter rape (Brassica napus, BRSNW), thistle (Cirsium arvense CIRAR), poinsettia (Euphorbia heterophylla, EPHHL), wild buckwheat (Polygonum convolvulus, POLCO), grain sorghum (Sorghum vulgare, SORVU), common chickweed (Stellaria media, STEME), wild pansy (Viola tricolor, VIOTR), pigweed (Amaranthus retrollexus, AMARE), common lambsquarters (Chenopodium album L., CHEAL), soybean (Glycine max, GLXMA), sunflower (Helianthus annuus, HELAN), giant foxtail (Setaria faberi, SETFA) spring rape (Brassica napus, BRSNN), large crabgrass (Digitaria sanguinalis, DIGSA), barnyardgrass (Echinochloa crus-galli, ECHCG), ivyleaf morningglory (Ipomoea hederacea, IPOHE), kochia (Kochia scoparia, KCHSC), rice (Oryza sativa, ORYSA), winter wheat (Triticum aestivum, TRZAW), and maize (Zea mays, ZEAMX) were evaluated. The results are summarized in Table 1 and include data averaged from two trials.

TABLE 1
Effect (% visual injury) of compound
1 and isoxaflutole on weeds/crops.

| | | Compound 1 (g ai/ha) | | | | |
|---|---|---|---|---|---|---|
| | | 5 | 10 | 0 | 5 | 10 |
| | | Isoxaflutole (g ai/ha) | | | | |
| Application Rate | | 0 | 0 | 35 | 35 | 35 |
| ABUTH | Obs | 50 | 55 | 45 | 80 | 87 |
| | Exp | | | | 73 | 75 |
| AVEFA | Obs | 0 | 0 | 60 | 60 | 65 |
| | Exp | | | | 60 | 60 |
| BRSNW | Obs | 40 | 45 | 60 | 80 | 85 |
| | Exp | | | | 76 | 78 |
| CIRAR | Obs | 50 | 60 | 75 | 100 | 97 |
| | Exp | | | | 88 | 90 |
| EPHHL | Obs | 86 | 99 | 43 | 100 | 100 |
| | Exp | | | | 92 | 99 |
| POLCO | Obs | 53 | 58 | 10 | 78 | 73 |
| | Exp | | | | 57 | 62 |
| SORVU | Obs | 0 | 50 | 0 | 85 | 93 |
| | Exp | | | | 0 | 50 |
| STEME | Obs | 70 | 70 | 10 | 95 | 100 |
| | Exp | | | | 73 | 73 |
| VIOTR | Obs | 8 | 13 | 45 | 45 | 60 |
| | Exp | | | | 49 | 52 |
| AMARE | Obs | 75 | 97 | 95 | 100 | 100 |
| | Exp | | | | 99 | 100 |
| CHEAL | Obs | 90 | 98 | 99 | 100 | 100 |
| | Exp | | | | 100 | 100 |
| GLXMA | Obs | 95 | 100 | 75 | 100 | 100 |
| | Exp | | | | 99 | 100 |
| HELAN | Obs | 90 | 90 | 90 | 95 | 100 |
| | Exp | | | | 99 | 99 |
| SETFA | Obs | 30 | 63 | 97 | 100 | 100 |
| | Exp | | | | 98 | 99 |
| BRSNN | Obs | 50 | 80 | 85 | 85 | 97 |
| | Exp | | | | 93 | 97 |
| DIGSA | Obs | 0 | 10 | 50 | 20 | 20 |
| | Exp | | | | 50 | 55 |
| ECHCG | Obs | 20 | 60 | 25 | 30 | 50 |
| | Exp | | | | 40 | 70 |
| IPOHE | Obs | 10 | 10 | 70 | 30 | 30 |
| | Exp | | | | 73 | 73 |
| KCHSC | Obs | 63 | 68 | 90 | 93 | 95 |
| | Exp | | | | 96 | 97 |
| ORYSA | Obs | 0 | 10 | 30 | 25 | 35 |
| | Exp | | | | 30 | 37 |
| TRZAW | Obs | 0 | 0 | 15 | 20 | 30 |
| | Exp | | | | 15 | 15 |
| ZEAMX | Obs | 0 | 0 | 0 | 10 | 20 |
| | Exp | | | | 0 | 0 |

g ai/ha = grams active ingredient per hectare
ABUTH = Abutilon theophrasti (velvetleaf)
AVEFA = Avena fatua (giant foxtail)
BRSNW = Brassica napus (winter rape)
CIRAR = Cirsium arvense (thistle)
EPHHL = Euphorbia heterophylla (poinsettia)
POLCO = Polygonum convolvulus (wild buckwheat)
SORVU = Sorghum vulgare (grain sorghum)
STEME = Stellaria media (chickweed)
VIOTR = Viola tricolor (wild pansy)
AMARE = Amaranthus retroflexus (pigweed)
CHEAL = Chenopodium album L. (common lambsquarters)
GLXMA = Glycine max (soybean)
HELAN = Helianthus annuus (sunflower)
SETFA = Setaria faberi (giant foxtail)
BRSNN = Brassica napus (spring rape)
DIGSA = Digitaria sanguinalis (large crabgrass)
ECHCG = Echinochloa crus-galli (barnyardgrass)
IPOHE = Ipomoea hederacea (ivyleaf morningglory)
KCHSC = Kochia scoparia (kochia)
ORYSA = Oryza sativa (rice)
TRZAW = Triticum aestivum (winter wheat)

Compound 1 (formulated as an EC) was combined with mesotrione and the efficacy of the herbicidal composition on velvetleaf (Abutilon theophrasti, ABUTH), pigweed (Amaranthus retroflexus, AMARE), winter rape (Brassica napus, BRSNW), barnyardgrass (Echinochloa crus-galli, ECHCG), poinsettia (Euphorbia heterophylla, EPHHL), ivyleaf morningglory (Ipomoea hederacea, IPOHE), wild buckwheat (Polygonum convolvulus, POLCO), common chickweed (Stellaria media, STEME), wild pansy (Viola tricolor, VIOTR), common lambsquarters (Chenopodium album L., CHEAL), thistle (Cirsium arvense CIRAR), soybean (Glycine max, GLXMA), sunflower (Helianthus annuus, HELAN), spring rape (Brassica napus, BRSNN), large crabgrass (Digitaria sanguinalis, DIGSA), kochia (Kochia scoparia, KCHSC), giant foxtail (Setaria faberi, SETFA), grain sorghum (Sorghum vulgare, SORVU), and maize (Zea mays, ZEAMX) was evaluated. The results are summarized in Table 2 and include data averaged from two trials.

TABLE 2
Effect (% visual injury) of compound
1 and mesotrione on weeds/crops.

| | | Compound 1 (g ai/ha) | | | | |
|---|---|---|---|---|---|---|
| | | 5 | 10 | 0 | 5 | 10 |
| | | Mesotrione (g ai/ha) | | | | |
| Application Rate | | 0 | 0 | 35 | 35 | 35 |
| ABUTH | Obs | 50 | 55 | 88 | 98 | 98 |
| | Exp | | | | 94 | 94 |
| AMARE | Obs | 75 | 97 | 30 | 100 | 100 |
| | Exp | | | | 83 | 98 |
| BRSNW | Obs | 40 | 45 | 60 | 85 | 85 |
| | Exp | | | | 76 | 78 |
| ECHCG | Obs | 20 | 60 | 10 | 0 | 70 |
| | Exp | | | | 28 | 64 |
| EPHHL | Obs | 86 | 99 | 20 | 100 | 75 |
| | Exp | | | | 89 | 99 |
| IPOHE | Obs | 10 | 10 | 70 | 93 | 95 |
| | Exp | | | | 73 | 73 |
| POLCO | Obs | 53 | 58 | 48 | 100 | 100 |
| | Exp | | | | 75 | 78 |
| STEME | Obs | 70 | 70 | 60 | 95 | 100 |
| | Exp | | | | 88 | 88 |
| VIOTR | Obs | 8 | 13 | 58 | 73 | 88 |
| | Exp | | | | 61 | 63 |
| CHEAL | Obs | 90 | 98 | 100 | 100 | 93 |
| | Exp | | | | 100 | 100 |
| CIRAR | Obs | 50 | 60 | 100 | 100 | 100 |
| | Exp | | | | 100 | 100 |
| GLXMA | Obs | 95 | 100 | 70 | 100 | 100 |
| | Exp | | | | 99 | 100 |
| HELAN | Obs | 90 | 90 | 93 | 100 | 100 |
| | Exp | | | | 99 | 99 |
| BRSNN | Obs | 50 | 80 | 100 | 95 | 100 |
| | Exp | | | | 100 | 100 |
| DIGSA | Obs | 0 | 10 | 20 | 0 | 10 |
| | Exp | | | | 20 | 28 |
| KCHSC | Obs | 63 | 68 | 70 | 80 | 80 |
| | Exp | | | | 89 | 90 |
| SETFA | Obs | 30 | 63 | 0 | 5 | 65 |
| | Exp | | | | 30 | 63 |
| SORVU | Obs | 0 | 50 | 0 | 0 | 30 |
| | Exp | | | | 0 | 50 |
| ZEAMX | Obs | 0 | 0 | 0 | 0 | 0 |
| | Exp | | | | 0 | 0 |

g ai/ha = grams active ingredient per hectare
ABUTH = Abutilon theophrasti (velvetleaf)
AMARE = Amaranthus retroflexus (pigweed)
BRSNW = Brassica napus (winter rape)
ECHCG = Echinochloa crus-galli (barnyardgrass)
EPHHL = Euphorbia heterophylla (poinsettia)
IPOHE = Ipomoea hederacea (ivyleaf morningglory)
POLCO = Polygonum convolvulus (wild buckwheat)
STEME = Stellaria media (chickweed)
VIOTR = Viola tricolor (wild pansy)
CHEAL = Chenopodium album L. (common lambsquarters)
CIRAR = Cirsium arvense (thistle)
GLXMA = Glycine max (soybean)
HELAN = Helianthus annuus (sunflower)
BRSNN = Brassica napus (spring rape)
DIGSA = Digitaria sanguinalis (large crabgrass)
KCHSC = Kochia scoparia (kochia)
SETFA = Setaria faberi (giant foxtail)
SORVU = Sorghum vulgare (grain sorghum)
ZEAMX = Zea mays (maize)

Compound 1 (formulated as an EC) was combined with sulcotrione and the efficacy of the herbicidal composition on velvetleaf (Abutilon theophrasti, ABUTH), winter rape (Brassica napus, BRSNW), poinsettia (Euphorbia heterophylla, EPHHL), ivyleaf morningglory (Ipomoea hederacea, IPOHE), wild buckwheat (Polygonum convolvulus, POLCO), grain sorghum (Sorghum vulgare, SORVU), common chickweed (Stellaria media, STEME), pigweed (Amaranthus retrollexus, AMARE), common lambsquarters (Chenopodium album L., CHEAL), thistle (Cirsium arvense CIRAR), barnyardgrass (Echinochloa crus-galli, ECHCG), soybean (Glycine max, GLXMA), sunflower (Helianthus annuus, HELAN), pansy (Viola tricolor, VIOTR), spring rape (Brassica napus, BRSNN), kochia (Kochia scoparia, KCHSC), rice (Oryza sativa, ORYSA), giant foxtail (Setaria faberi, SETFA), winter wheat (Triticum aestivum, TRZAW), and maize (Zea mays, ZEAMX) was evaluated. The results are summarized in Table 3 and include data averaged from two trials.

TABLE 3
Effect (% visual injury) of compound
1 and sulcotrione on weeds/crops.

| | | Compound 1 (g ai/ha) | | | | |
|---|---|---|---|---|---|---|
| | | 5 | 10 | 0 | 5 | 10 |
| | | Sulcotrione (g ai/ha) | | | | |
| Application Rate | | 0 | 0 | 75 | 75 | 75 |
| ABUTH | Obs | 50 | 55 | 50 | 95 | 98 |
| | Exp | | | | 75 | 78 |
| BRSNW | Obs | 40 | 45 | 70 | 85 | 93 |
| | Exp | | | | 82 | 84 |
| EPHHL | Obs | 86 | 99 | 60 | 100 | 100 |
| | Exp | | | | 94 | 99 |
| IPOHE | Obs | 10 | 10 | 65 | 75 | 85 |
| | Exp | | | | 69 | 69 |
| POLCO | Obs | 53 | 58 | 48 | 83 | 99 |
| | Exp | | | | 75 | 78 |
| SORVU | Obs | 0 | 50 | 0 | 40 | 40 |
| | Exp | | | | 0 | 50 |
| STEME | Obs | 70 | 70 | 85 | 100 | 100 |
| | Exp | | | | 96 | 96 |
| AMARE | Obs | 75 | 97 | 40 | 85 | 100 |
| | Exp | | | | 85 | 98 |
| CHEAL | Obs | 90 | 98 | 100 | 100 | 100 |
| | Exp | | | | 100 | 100 |
| CIRAR | Obs | 50 | 60 | 70 | 85 | 93 |
| | Exp | | | | 85 | 88 |
| ECHCG | Obs | 20 | 60 | 40 | 70 | 75 |
| | Exp | | | | 52 | 76 |
| GLXMA | Obs | 95 | 100 | 65 | 100 | 100 |
| | Exp | | | | 98 | 100 |
| HELAN | Obs | 90 | 90 | 80 | 100 | 100 |
| | Exp | | | | 98 | 98 |
| VIOTR | Obs | 8 | 13 | 73 | 70 | 73 |
| | Exp | | | | 75 | 76 |
| BRSNN | Obs | 50 | 80 | 95 | 85 | 83 |
| | Exp | | | | 98 | 99 |
| KCHSC | Obs | 63 | 68 | 45 | 70 | 81 |
| | Exp | | | | 79 | 82 |
| ORYSA | Obs | 0 | 10 | 5 | 10 | 20 |
| | Exp | | | | 5 | 15 |
| SETFA | Obs | 30 | 63 | 0 | 10 | 30 |
| | Exp | | | | 30 | 63 |
| TRZAW | Obs | 0 | 0 | 0 | 0 | 0 |
| | Exp | | | | 0 | 0 |
| ZEAMX | Obs | 0 | 0 | 0 | 0 | 0 |
| | Exp | | | | 0 | 0 |

g ai/ha = grams active ingredient per hectare
ABUTH = Abutilon theophrasti (velvetleaf)
BRSNW = Brassica napus (winter rape)
EPHHL = Euphorbia heterophylla (poinsettia)
IPOHE = Ipomoea hederacea (ivyleaf morningglory)
POLCO = Polygonum convolvulus (wild buckwheat)
SORVU = Sorghum vulgare (grain sorghum)
STEME = Stellaria media (chickweed)
AMARE = Amaranthus retrollexus (pigweed)
CHEAL = Chenopodium album L. (common lambsquarters)
CIRAR = Cirsium arvense (thistle)
ECHCG = Echinochloa crus-galli (barnyardgrass)
GLXMA = Glycine max (soybean)
HELAN = Helianthus annuus (sunflower)
VIOTR = Viola tricolor (wild pansy)
BRSNN = Brassica napus (spring rape)
KCHSC = Kochia scoparia (kochia)
ORYSA = Oryza sativa (rice)
SETFA = Setaria faberi (giant foxtail)
TRZAW = Trificum aestivum (winter wheat)
ZEAMX = Zea mays (maize)

Compound 1 (formulated as an EC) was combined with benzobicyclon and the efficacy of the herbicidal composition on velvetleaf (Abutilon theophrasti, ABUTH), spring rape (Brassica napus, BRSNN), thistle (Cirsium arvense CIRAR), poinsettia (Euphorbia heterophylla, EPHHL), kochia (Kochia scoparia, KCHSC), wild buckwheat (Polygonum convolvulus, POLCO), giant foxtail (Setaria faberi, SETFA), wild pansy (Viola tricolor, VIOTR), and common lambsquarters (Chenopodium album L., CHEAL) was evaluated. The results are summarized in Table 4.

TABLE 4
Effect (% visual injury) of compound
1 and benzobicyclon on weeds/crops.

| | | Compound 1 (g ai/ha) | | | | |
|---|---|---|---|---|---|---|
| | | 5 | 10 | 0 | 5 | 10 |
| | | Benzobicyclon (g ai/ha) | | | | |
| Application Rate | | 0 | 0 | 50 | 50 | 50 |
| ABUTH | Obs | 50 | 50 | 25 | 65 | 70 |
| | Exp | | | | 63 | 63 |
| BRSNN | Obs | 50 | 80 | 0 | 60 | 95 |
| | Exp | | | | 50 | 80 |
| CIRAR | Obs | 50 | 60 | 20 | 70 | 75 |
| | Exp | | | | 60 | 68 |
| EPHHL | Obs | 75 | 100 | 5 | 100 | 100 |
| | Exp | | | | 76 | 100 |
| KCHSC | Obs | 65 | 75 | 10 | 70 | 87 |
| | Exp | | | | 69 | 78 |
| POLCO | Obs | 40 | 40 | 0 | 65 | 80 |
| | Exp | | | | 40 | 40 |
| SETFA | Obs | 50 | 75 | 0 | 60 | 75 |
| | Exp | | | | 50 | 75 |
| VIOTR | Obs | 10 | 15 | 10 | 40 | 50 |
| | Exp | | | | 19 | 24 |
| CHEAL | Obs | 90 | 95 | 100 | 100 | 100 |
| | Exp | | | | 100 | 100 |

g ai/ha = grams active ingredient per hectare
ABUTH = Abutilon theophrasti (velvetleaf)
BRSNN = Brassica napus (spring rape)
CIRAR = Cirsium arvense (thistle)
EPHHL = Euphorbia heterophylla (poinsettia)
KCHSC = Kochia scoparia (kochia)
POLCO = Polygonum convolvulus (wild buckwheat)
SETFA = Setaria faberi (giant foxtail)
VIOTR = Viola tricolor (wild pansy)
CHEAL = Chenopodium album L. (common lambsquarters)

Compound 1 (formulated as an EC) was combined with pyrazolynate and the efficacy of the herbicidal composition on poinsettia (Euphorbia heterophylla, EPHHL), wild buckwheat (Polygonum convolvulus, POLCO), common lambsquarters (Chenopodium album L., CHEAL), thistle (Cirsium arvense CIRAR), wild pansy (Viola tricolor, VIOTR), velvetleaf (Abutilon theophrasti, ABUTH), spring rape (Brassica napus, BRSNN), and kochia (Kochia scoparia, KCHSC) was evaluated. The results are summarized in Table 5.

TABLE 5
Effect (% visual injury) of compound
1 and pyrazolynate on weeds/crops.

| | | Compound 1 (g ai/ha) | | | | |
|---|---|---|---|---|---|---|
| | | 5 | 10 | 0 | 5 | 10 |
| | | Pyrazolynate (g ai/ha) | | | | |
| Application Rate | | 0 | 0 | 225 | 225 | 225 |
| EPHHL | Obs | 75 | 100 | 0 | 95 | 100 |
| | Exp | | | | 75 | 100 |
| POLCO | Obs | 40 | 40 | 0 | 10 | 60 |
| | Exp | | | | 40 | 40 |
| CHEAL | Obs | 90 | 95 | 10 | 70 | 90 |
| | Exp | | | | 91 | 96 |
| CIRAR | Obs | 50 | 60 | 0 | 50 | 25 |
| | Exp | | | | 50 | 60 |
| VIOTR | Obs | 10 | 15 | 0 | 10 | 10 |
| | Exp | | | | 10 | 15 |
| ABUTH | Obs | 50 | 50 | 0 | 20 | 30 |
| | Exp | | | | 50 | 50 |
| BRSNN | Obs | 50 | 80 | 0 | 25 | 20 |
| | Exp | | | | 50 | 80 |
| KCHSC | Obs | 65 | 75 | 0 | 30 | 60 |
| | Exp | | | | 65 | 75 |

g ai/ha = grams active ingredient per hectare
EPHHL = Euphorbia heterophylla (poinsettia)
POLCO = Polygonum convolvulus (wild buckwheat)
CHEAL = Chenopodium album L. (common lambsquarters)
CIRAR = Cirsium arvense (thistle)
VIOTR = Viola tricolor (wild pansy)
ABUTH = Abutilon theophrasti (velvetleaf)
BRSNN = Brassica napus (spring rape)
KCHSC = Kochia scoparia (kochia)

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including”, “containing”, and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

What is claimed is:

1. A herbicidal composition comprising a herbicidally effective amount of (a) a pyridine carboxylic acid herbicide or an agriculturally acceptable N-oxide, salt, or ester thereof and (b) a 4-hydroxyphenyl-pyruvate dioxygenase (HPPD) inhibitor or an agriculturally acceptable salt thereof,
wherein the pyridine carboxylic acid herbicide comprises a compound defined by Formula (I) 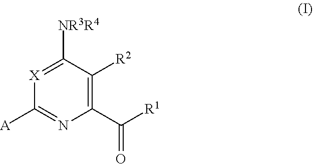
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1″}, wherein R^{1′} is hydrogen, C₁-C₈ alkyl, or C₇-C₁₀ arylalkyl, and R^{1″} and R^{1″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is one of groups A1 to A36 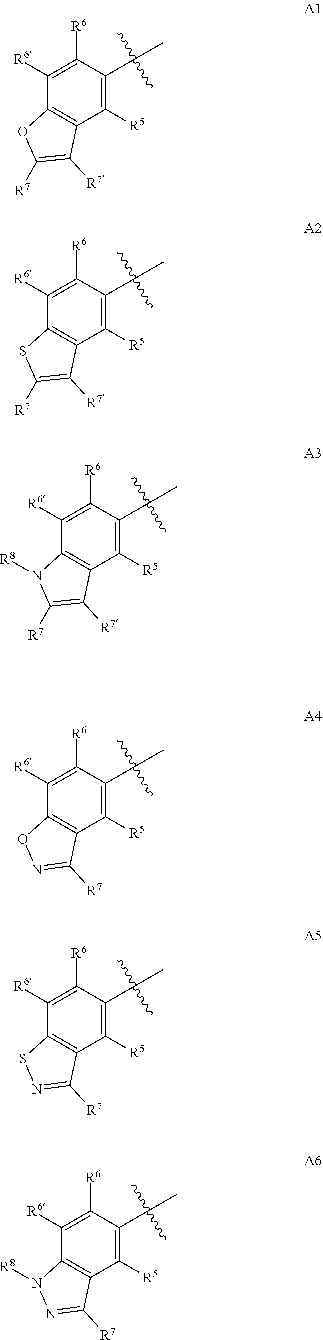 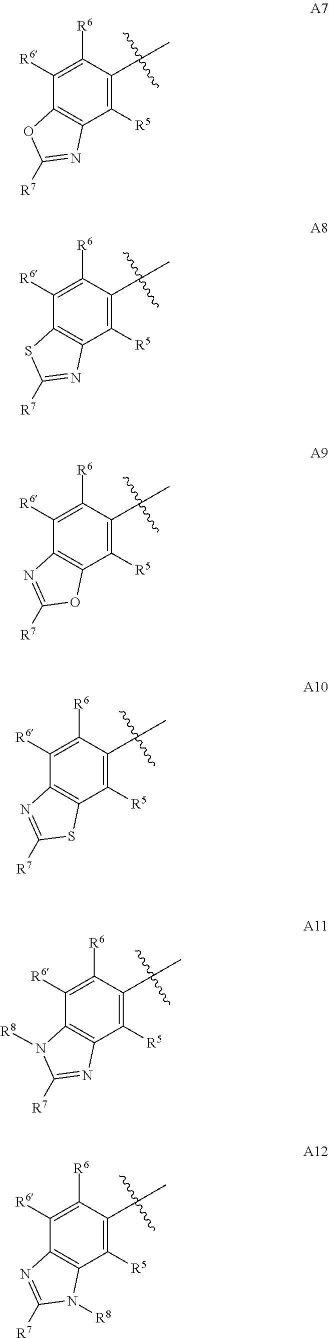 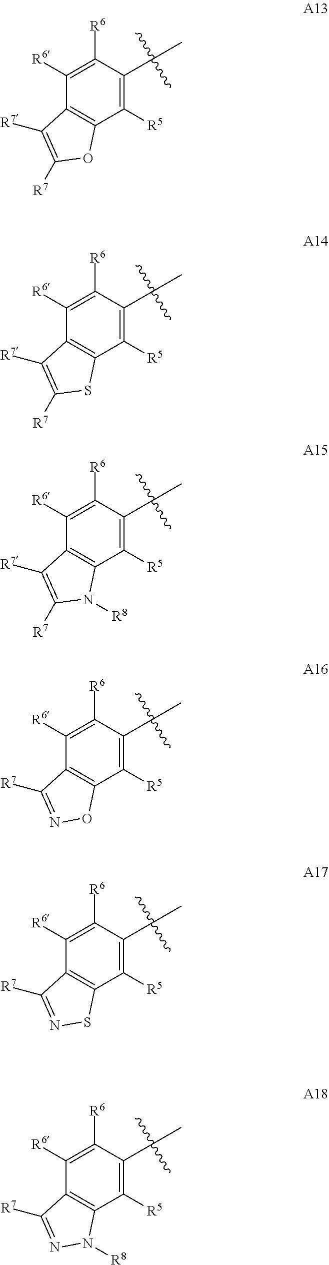 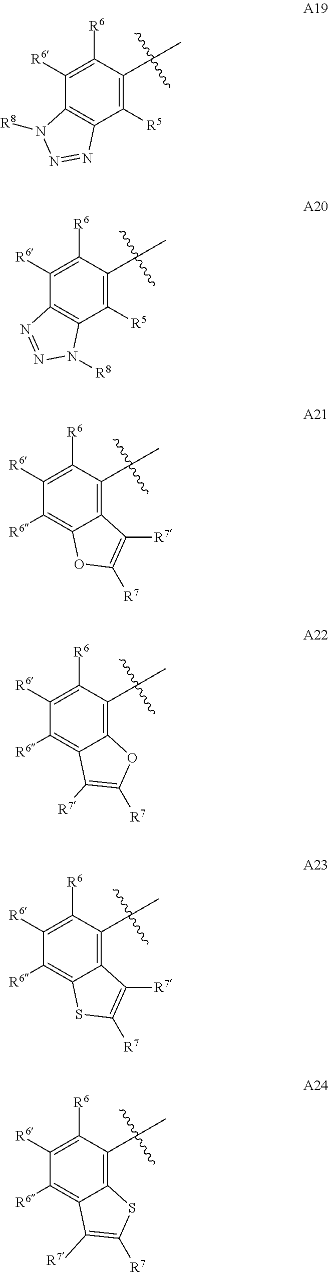 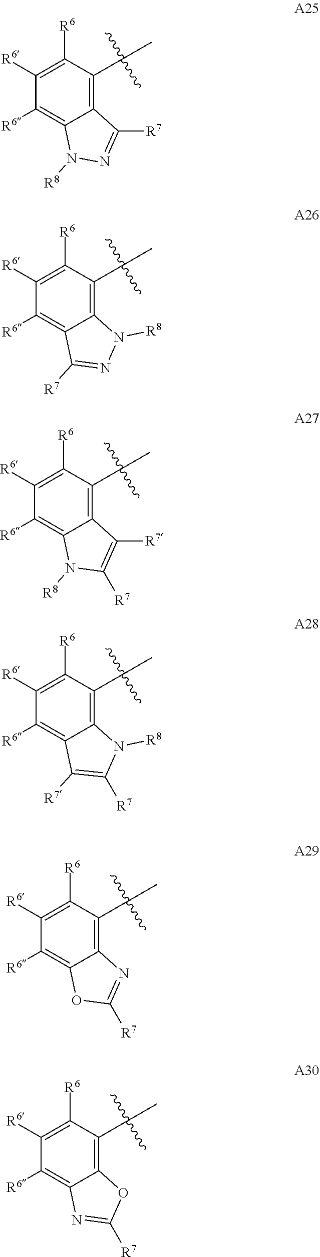 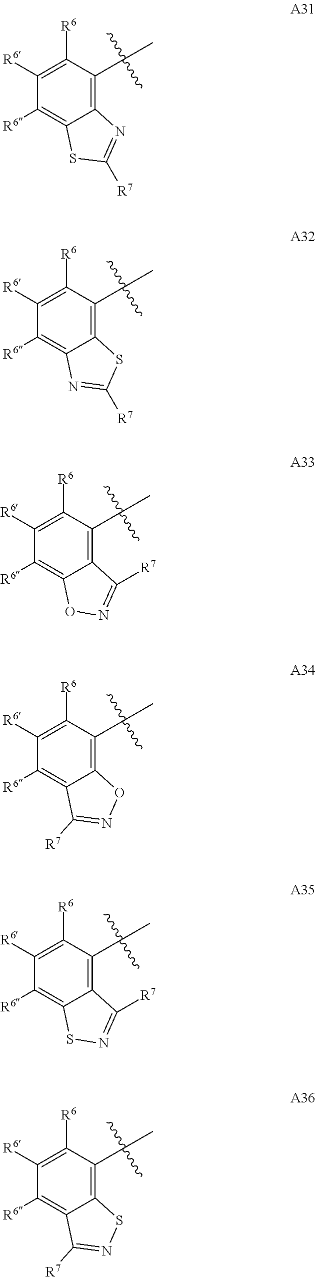
R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

2. The composition of claim 1, wherein the pyridine carboxylic acid herbicide comprises a compound defined by Formula (II) 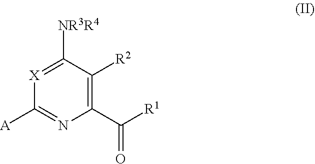
wherein
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;
R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

3. The composition of claim 2, wherein
R¹ is OR^{1′}, wherein R^{1′} is hydrogen, C₁-C₈ alkyl, or C₇-C₁₀ arylalkyl;
R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;
R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;
A is A1, A2, A3, A7, A8, A9, A10, A11, A12, A13, A14, A15, A21, A22, A23, A24, A27, A28, A29, A30, A31, or A32;
R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;
R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and
R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

4. The composition of claim 1, wherein the pyridine carboxylic acid herbicide comprises a compound defined by Formula (III): 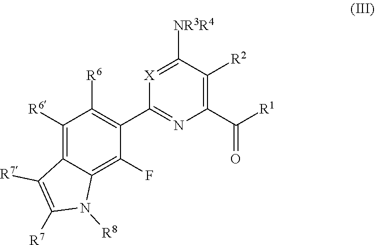
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

5. The composition of claim 1, wherein the pyridine carboxylic acid herbicide comprises one of the following:

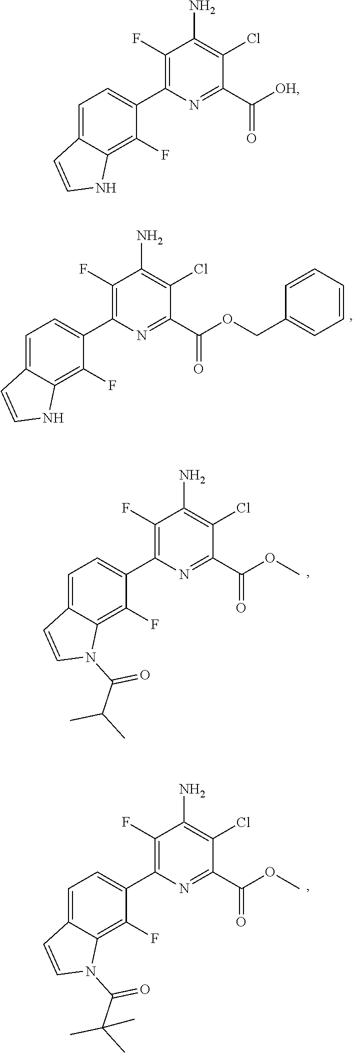 [SMILES: Nc1c(F)c(-c2ccc3cc[nH]c3c2F)nc(C(=O)O)c1Cl ; Nc1c(F)c(-c2ccc3cc[nH]c3c2F)nc(C(=O)OCc2ccccc2)c1Cl ; COC(=O)c1nc(-c2ccc3ccn(C(=O)C(C)C)c3c2F)c(F)c(N)c1Cl ; COC(=O)c1nc(-c2ccc3ccn(C(=O)C(C)(C)C)c3c2F)c(F)c(N)c1Cl]

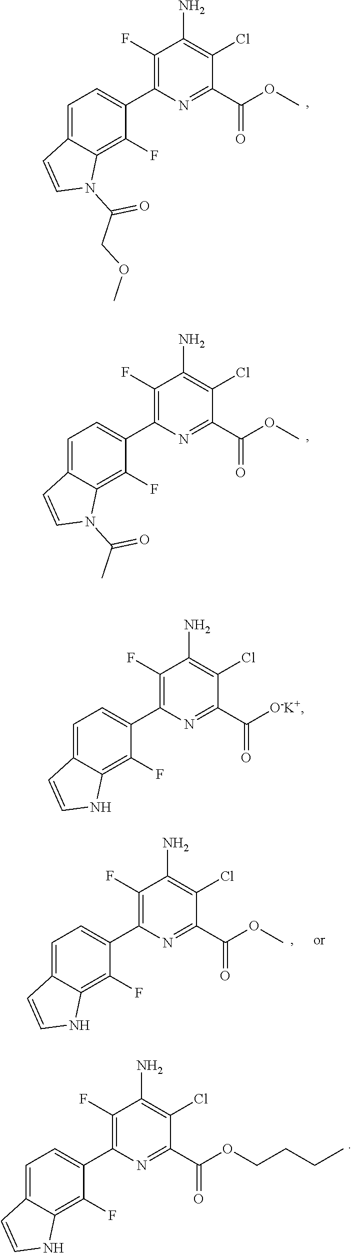

6. The composition of claim 1, wherein the pyridine carboxylic acid herbicide comprises

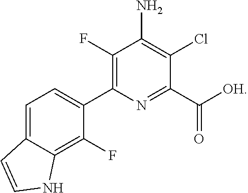 [SMILES: Nc1c(F)c(-c2ccc3cc[nH]c3c2F)nc(C(=O)O)c1Cl]

7. The composition of claim 1, wherein (b) is a 4-hydroxyphenyl-pyruvate dioxygenase (HPPD) inhibitor herbicide.

8. The composition of claim 7, wherein the 4-hydroxyphenyl-pyruvate dioxygenase (HPPD) inhibitor herbicide is selected from the group consisting of benzobicyclon, benzofenap, bicyclopyrone, fenquinotrione, isoxachlortole, isoxaflutole, mesotrione, pyrasulfotole, pyrazolynate, pyrazoxyfen, sulcotrione, tembotrione, tefuryltrione, topramezone, or an agriculturally acceptable salt thereof, and combinations thereof.

9. The composition of claim 8, wherein the weight ratio of (a) to (b) is within the range from about 1:8000 to about 1000:1.

10. The composition of claim 9, wherein the weight ratio of (a) to (b) is within the range from about 1:500 to about 60:1.

11. The composition of claim 10, wherein the weight ratio of (a) to (b) is within the range from about 1:30 to about 5:1.

12. The composition claim 1, further comprising an agriculturally acceptable adjuvant or carrier.

13. The composition of claim 1, further comprising an additional pesticide.

14. The composition of claim 1, wherein the active ingredients in the composition consist of (a) and (b).

15. The composition of claim 1, wherein the composition is provided as a herbicidal concentrate.

16. A method of controlling undesirable vegetation comprising applying to vegetation or an area adjacent the vegetation or applying to soil or water to control the emergence or growth of vegetation a herbicidally effective amount of:
(a) a pyridine carboxylic acid herbicide comprising a compound defined by Formula (I) 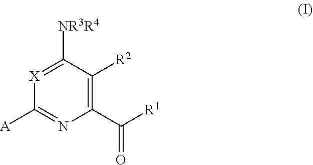
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is one of groups A1 to A36 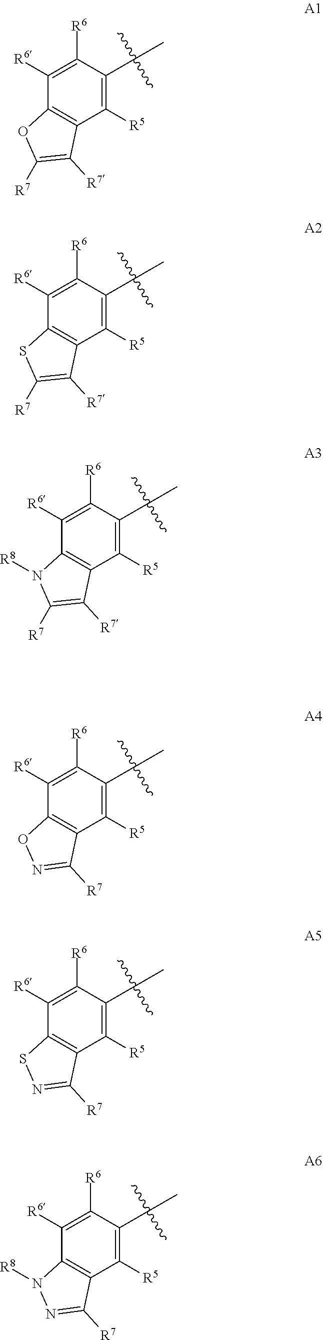 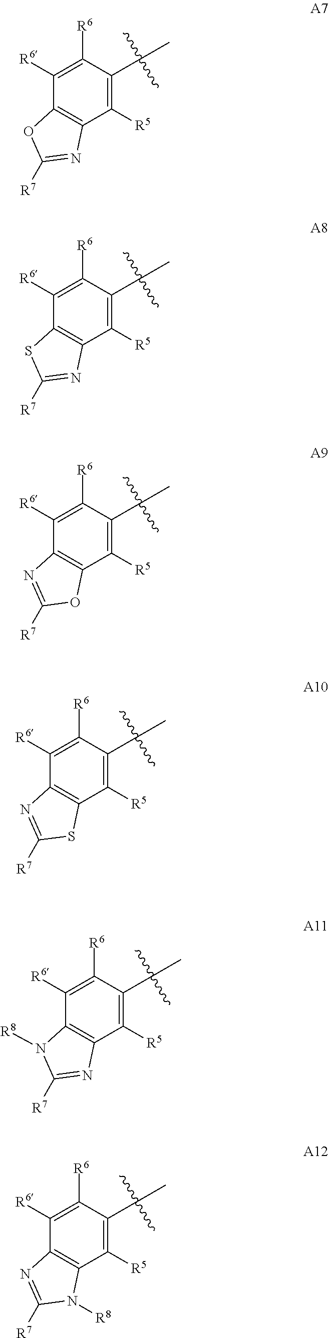 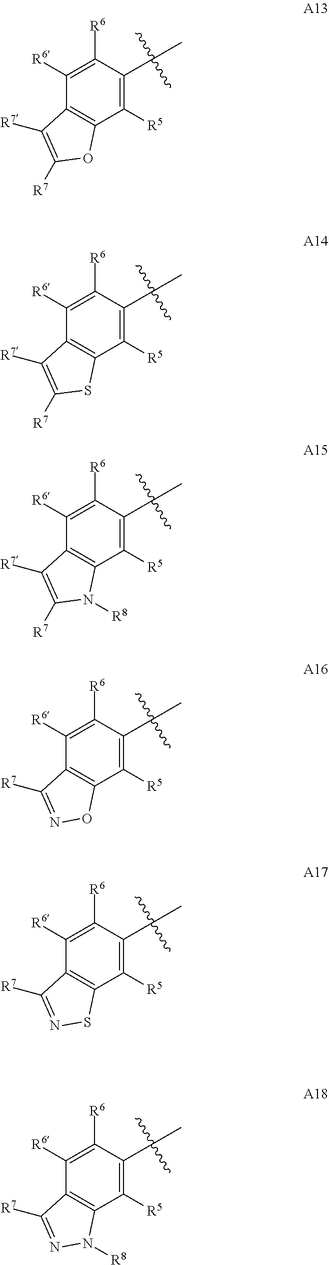 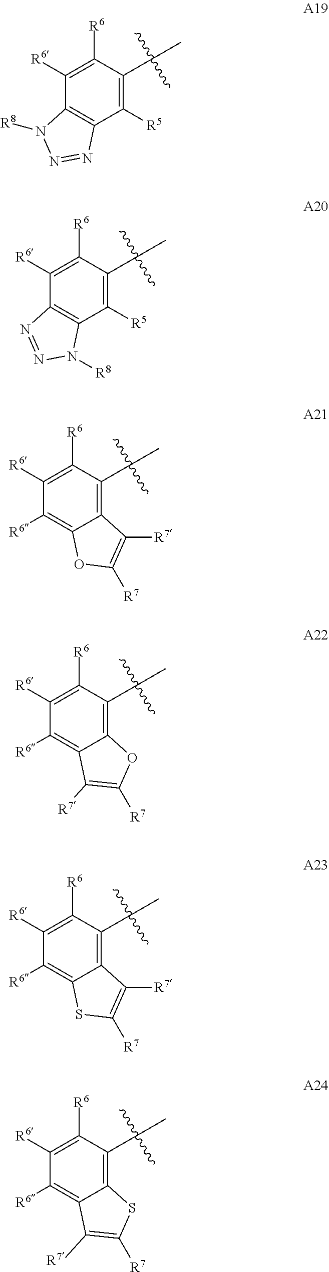 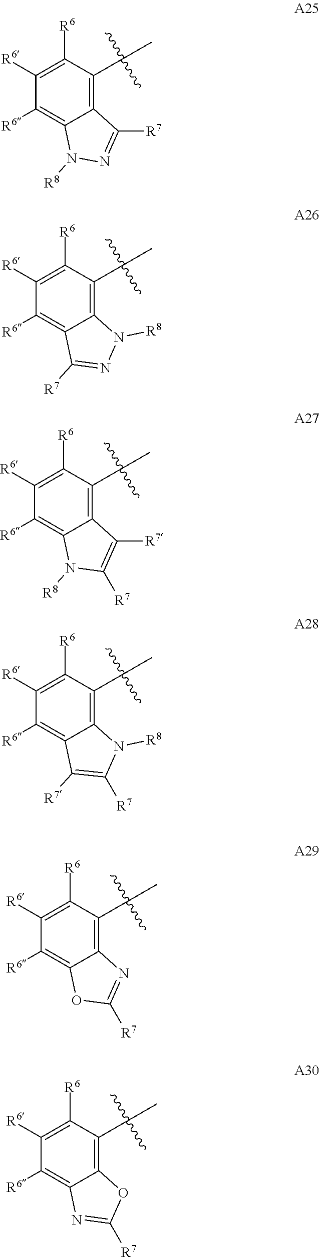 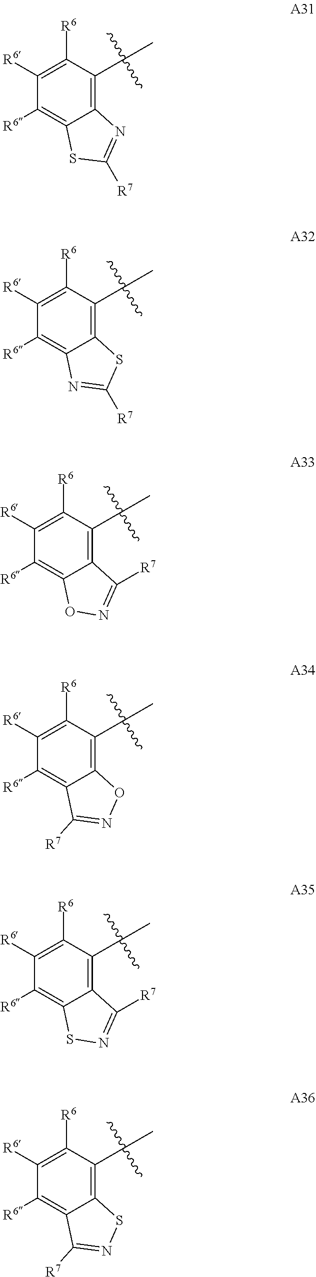
R⁵, if applicable to the A group, is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″}, if applicable to the A group, are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₁-C₄ haloalkylamino, or phenyl;
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof; and
(b) a 4-hydroxyphenyl-pyruvate dioxygenase (HPPD) inhibitor or an agriculturally acceptable salt thereof.

17. The method of claim 16, wherein the pyridine carboxylic acid herbicide comprises a compound defined by Formula (II) 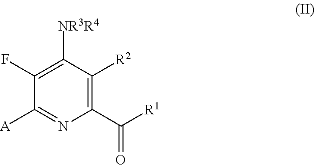
wherein
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
A is A1, A2, A3, A4, A5, A6, A7, A8, A9, A10, A11, A12, A13, A14, A15, A16, A17, A18, A19, A20, A21, A22, A23, A24, A25, A26, A27, A28, A29, A30, A31, A32, A33, A34, A35, or A36;
R⁵ is hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, OH, or CN;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

18. The method of claim 16, wherein
R¹ is OR^{1′}, wherein R^{1′} is hydrogen, C₁-C₈ alkyl, or C₇-C₁₀ arylalkyl;
R² is halogen, C₁-C₄ alkyl, C₁-C₄ haloalkyl, C₂-C₄-alkenyl, C₂-C₄ haloalkenyl, C₂-C₄ alkynyl, C₁-C₄-alkoxy, C₁-C₄ haloalkoxy, C₁-C₄ alkylthio, or C₁-C₄ haloalkylthio;
R³ and R⁴ are hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino;
A is A1, A2, A3, A7, A8, A9, A10, A11, A12, A13, A14, A15, A21, A22, A23, A24, A27, A28, A29, A30, A31, or A32;
R⁵ is hydrogen, halogen, C₁-C₄ alkyl, C₁-C₄ haloalkyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, or C₂-C₄ haloalkylamino;
R⁶, R^{6′}, and R^{6″} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, CN, or NO₂;
R⁷ and R^{7′} are independently hydrogen, halogen, C₁-C₄ alkyl, C₁-C₄ haloalkyl, C₁-C₃ alkoxy, C₁-C₃ haloalkoxy, C₁-C₃ alkylthio, cyclopropyl, amino or C₁-C₄ alkylamino; and
R⁸ is hydrogen, C₁-C₆ alkyl, C₁-C₄ haloalkyl, C₃-C₆ alkenyl, C₃-C₆ haloalkenyl, formyl, C₁-C₃ alkylcarbonyl, C₁-C₃ haloalkylcarbonyl, C₁-C₆ alkoxycarbonyl, or C₁-C₆ alkylcarbamyl.

19. The method of claim 16, wherein the pyridine carboxylic acid herbicide comprises a compound defined by Formula (III): 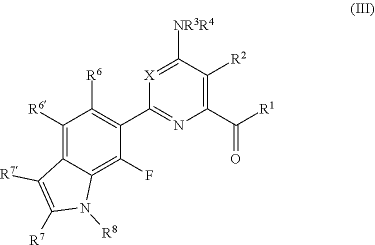
wherein
X is N or CY, wherein Y is hydrogen, halogen, C₁-C₃ alkyl, C₁-C₃ haloalkyl, C₁-C₃ alkoxy, C₁-C₃ haloalkoxy, C₁-C₃ alkylthio or C₁-C₃ haloalkylthio;
R¹ is OR^{1′} or NR^{1″}R^{1′″}, wherein R^{1′} is hydrogen, C₁-C₈ alkyl, or C₇-C₁₀ arylalkyl, and R^{1″} and R^{1′″} are independently hydrogen, C₁-C₁₂ alkyl, C₃-C₁₂ alkenyl, or C₃-C₁₂ alkynyl;
R² is halogen, C₁-C₄ alkyl, C₁-C₄ haloalkyl, C₂-C₄ alkenyl, C₂-C₄ haloalkenyl, C₂-C₄ alkynyl, C₁-C₄ alkoxy, C₁-C₄ haloalkoxy, C₁-C₄ alkylthio, C₁-C₄ haloalkylthio, amino, C₁-C₄ alkylamino, C₂-C₄ haloalkylamino, formyl, C₁-C₃ alkylcarbonyl, C₁-C₃ haloalkylcarbonyl, cyano, or a group of the formula —CR¹⁷═CR¹⁸—SiR¹⁹R²⁰R²¹, wherein R¹⁷ is hydrogen, F, or Cl; R¹⁸ is hydrogen, F, Cl, C₁-C₄ alkyl, or C₁-C₄ haloalkyl; and R¹⁹, R²⁰, and R²¹ are independently C₁-C₁₀ alkyl, C₃-C₆ cycloalkyl, phenyl, substituted phenyl, C₁-C₁₀ alkoxy, or OH;
R³ and R⁴ are independently hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, C₁-C₆ dialkylphosphonyl, or R³ and R⁴ taken together with N is a 5- or 6-membered saturated ring, or R³ and R⁴ taken together represent ═CR^{3′}(R^{4′}), wherein R^{3′} and R^{4′} are independently hydrogen, C₁-C₆ alkyl, C₃-C₆ alkenyl, C₃-C₆ alkynyl, C₁-C₆ alkoxy or C₁-C₆ alkylamino, or, R^{3′} and R^{4′} taken together with ═C represent a 5- or 6-membered saturated ring;
R⁶ and R^{6′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino or C₂-C₄ haloalkylamino, OH, CN, or NO₂;
R⁷ and R^{7′} are independently hydrogen, halogen, C₁-C₄ alkyl, C₁-C₄ haloalkyl, cyclopropyl, halocyclopropyl, C₂-C₄ alkenyl, C₂-C₄ haloalkenyl, C₂-C₄ alkynyl, C₁-C₃ alkoxy, C₁-C₃ haloalkoxy, C₁-C₃ alkylthio, C₁-C₃ haloalkylthio, amino, C₁-C₄ alkylamino, C₂-C₄ haloalkylamino, or phenyl; and
R⁸ is hydrogen, C₁-C₆ alkyl, C₁-C₆ haloalkyl, C₃-C₆ alkenyl, C₃-C₆ haloalkenyl, C₃-C₆ alkynyl, formyl, C₁-C₃ alkylcarbonyl, C₁-C₃ haloalkylcarbonyl, C₁-C₆ alkoxycarbonyl, C₁-C₆ alkylcarbamyl, C₁-C₆ alkylsulfonyl, C₁-C₆ trialkylsilyl, or phenyl;
or an agriculturally acceptable N-oxide or salt thereof.

20. The method of claim 1, wherein the pyridine carboxylic acid herbicide comprises one of the following:

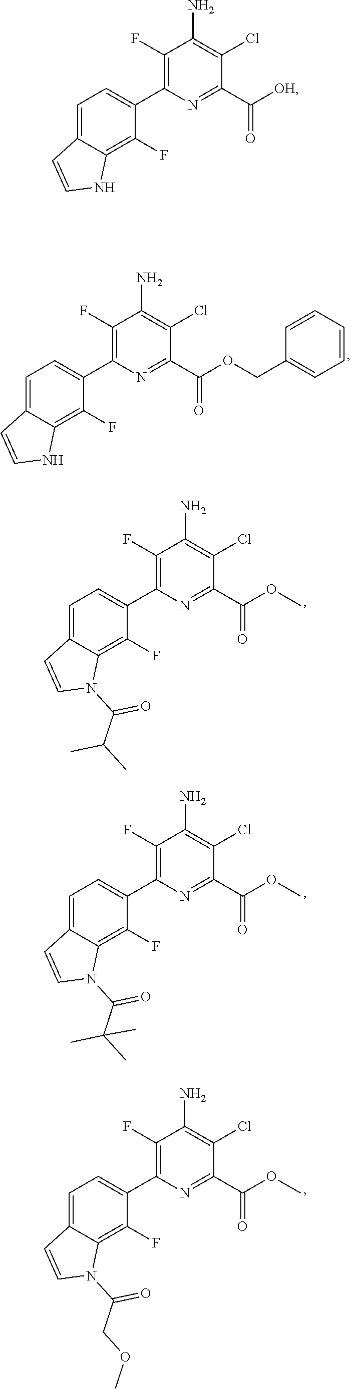 [SMILES: Nc1c(F)c(-c2ccc3cc[nH]c3c2F)nc(C(=O)O)c1Cl ; Nc1c(F)c(-c2ccc3cc[nH]c3c2F)nc(C(=O)OCc2ccccc2)c1Cl ; COC(=O)c1nc(-c2ccc3ccn(C(=O)C(C)C)c3c2F)c(F)c(N)c1Cl ; COC(=O)c1nc(-c2ccc3ccn(C(=O)C(C)(C)C)c3c2F)c(F)c(N)c1Cl ; COCC(=O)n1ccc2ccc(-c3nc(C(=O)OC)c(Cl)c(N)c3F)c(F)c21]

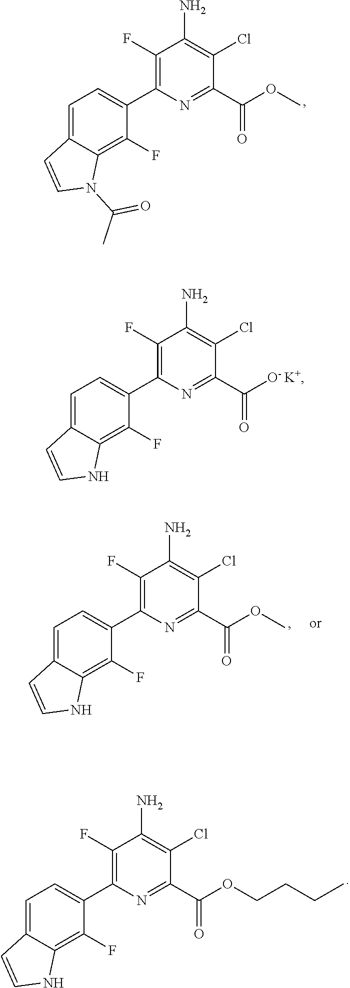

21. The method of claim 16, wherein the pyridine carboxylic acid herbicide comprises

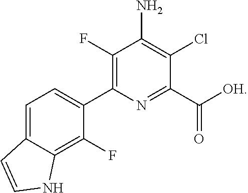 [SMILES: Nc1c(F)c(-c2ccc3cc[nH]c3c2F)nc(C(=O)O)c1Cl]

22. The method of claim 16, wherein (b) is a 4-hydroxyphenyl-pyruvate dioxygenase (HPPD) inhibitor herbicide.

23. The method of claim 22, wherein the 4-hydroxyphenyl-pyruvate dioxygenase (HPPD) inhibitor herbicide is selected from the group consisting of benzobicyclon, benzofenap, bicyclopyrone, fenquinotrione, isoxachlortole, isoxaflutole, mesotrione, pyrasulfotole, pyrazolynate, pyrazoxyfen, sulcotrione, tembotrione, tefuryltrione, topramezone, or an agriculturally acceptable salt thereof, and combinations thereof.

24. The method of claim 23, wherein the weight ratio of (a) to (b) is within the range from about 1:8000 to about 1000:1.

25. The method of claim 24, wherein the weight ratio of (a) to (b) is within the range from about 1:500 to about 60:1.

26. The method of claim 25, wherein the weight ratio of (a) to (b) is within the range from about 1:30 to about 5:1.

27. The method of claim 16, wherein (a) is applied in amount of from 0.5 g ae/ha to 300 g ae/ha.

28. The method of claim 16, wherein (a) is applied in amount of from 5 g ae/ha to 40 g ae/ha.

29. The method of claim 16, wherein (b) is applied in amount of from 1 g ai/ha to 4500 g ai/ha.

30. The method of claim 16, wherein (b) is applied in amount of from 1 g ai/ha to 1000 g ai/ha.

31. The method of claim 16, wherein (a) and (b) are applied simultaneously.

32. The method of claim 16, wherein (a) and (b) are applied post-emergence to the undesirable vegetation.

33. The method of claim 16, further comprising applying an agriculturally acceptable adjuvant or carrier.

34. The method of claim 16, further comprising applying an additional pesticide.

35. The method of claim 16, wherein the undesirable vegetation is controlled in a glyphosate-, glufosinate-, dicamba-, phenoxy auxin-, pyridyloxy auxin-, aryloxyphenoxypropionate-, acetyl CoA carboxylase (ACCase) inhibitor-, imidazolinone-, 4-hydroxyphenyl-pyruvate dioxygenase (HPPD) inhibitor-, protoporphyrinogen oxidase (PPO) inhibitor-, triazine-, or bromoxynil-tolerant crop.

36. The method of claim 35, wherein the tolerant crop possesses multiple or stacked traits conferring tolerance to multiple herbicides or multiple modes of action

37. The method of claim 16, wherein the undesirable vegetation includes a broadleaf weed and/or a grass weed.

38. The method of claim 16, wherein the undesirable vegetation comprises a herbicide resistant or tolerant weed.

39. The method of claim 38, wherein the resistant or tolerant weed is a biotype with resistance or tolerance to multiple herbicides, multiple chemical classes, or multiple herbicide modes-of-action.

40. The method of claim 38, wherein the resistant or tolerant weed is a biotype resistant or tolerant to photosystem II inhibitors, acetyl CoA carboxylase (ACCase) inhibitors, synthetic auxins, photosystem I inhibitors, 5-enolpyruvylshikimate-3-phosphate (EPSP) synthase inhibitors, microtubule assembly inhibitors, lipid synthesis inhibitors, protoporphyrinogen oxidase (PPO) inhibitors, carotenoid biosynthesis inhibitors, very long chain fatty acid (VLCFA) inhibitors, phytoene desaturase (PDS) inhibitors, glutamine synthetase inhibitors, 4-hydroxyphenyl-pyruvate-dioxygenase (HPPD) inhibitors, mitosis inhibitors, cellulose biosynthesis inhibitors, herbicides with multiple modes-of-action, quinclorac, arylaminopropionic acids, difenzoquat, endothall, or organoarsenicals.

41. The method of claim 16, wherein the undesirable vegetation includes velvetleaf, pigweed, wild oat, winter rape, lambsquarters, thistle, barnyardgrass, poinsettia, soybean, sunflower, ivyleaf morningglory, kochia, wild buckwheat, giant foxtail, sorghum, common chickweed, wild pansy, or a combination thereof.

42. The method of claim 16, wherein the active ingredients applied to the vegetation or an area adjacent the vegetation or applied to soil or water to control the emergence or growth of vegetation consist of (a) and (b).

43. The composition of claim 8, wherein the wherein the 4-hydroxyphenyl-pyruvate dioxygenase (HPPD) inhibitor herbicide is pyransulfotole.

44. The composition of claim 8, wherein the wherein the 4-hydroxyphenyl-pyruvate dioxygenase (HPPD) inhibitor herbicide is pyrazolynate.

45. The composition of claim 8, wherein the wherein the 4-hydroxyphenyl-pyruvate dioxygenase (HPPD) inhibitor herbicide is sulcotrione.

46. The composition of claim 8, wherein the wherein the 4-hydroxyphenyl-pyruvate dioxygenase (HPPD) inhibitor herbicide is tembotrione.

47. The composition of claim 8, wherein the wherein the 4-hydroxyphenyl-pyruvate dioxygenase (HPPD) inhibitor herbicide is isoxaflutole.

48. The composition of claim 8, wherein the wherein the 4-hydroxyphenyl-pyruvate dioxygenase (HPPD) inhibitor herbicide is mesotrione.

49. The composition of claim 43, further comprising bromoxynil, wherein the ratio of bromoxynil to pyransulfotole is between about 10:1 to about 1:10.

50. The composition of claim 49, wherein the ratio of bromoxynil to pyransulfotole is between about 7:1 to about 1:1.

51. The composition of claim 50, wherein the ratio of bromoxynil to pyransulfotole is between about 6:1 to about 5:1.
